(19) United States
(12) Patent Application Publication
(10) Pub. No.: US 2022/0389743 A1
(43) Pub. Date: Dec. 8, 2022

(54) POWER DOOR LINKAGE SYSTEM FOR B-PILLARLESS DOOR SYSTEM FOR MOTOR VEHICLES

(71) Applicants: MAGNA BOCO GMBH, WUPPERTAL (DE); MAGNA CLOSURES INC., NEWMARKET (CA)

(72) Inventors: Jörg Thomas KLEIN, Leverkusen (DE); Roman CETNAR, Newmarket (CA); John DISTEFANO, Newmarket (CA); Dorin ILEA, Vaughan (CA); Bogdan Maglaviceanu, Pickering (CA)

(21) Appl. No.: 17/749,821

(22) Filed: May 20, 2022

Related U.S. Application Data
(60) Provisional application No. 63/320,154, filed on Mar. 15, 2022.
(60) Provisional application No. 63/217,220, filed on Jun. 30, 2021.
(60) Provisional application No. 63/196,138, filed on Jun. 2, 2021.

(51) Int. Cl. E05D 15/10; E05F 15/40

(52) U.S. Cl. CPC E05D 15/101; E05F 15/40; E05D 2015/1026; E05Y 2201/686; E05Y 2400/54; E05Y 2900/531

(57) ABSTRACT

A door linkage system for guiding a door of a motor vehicle between an open position and a closed position relative to a vehicle body includes at least one linkage pivotally connected between the door and the vehicle body to move a rear portion of the door away from the vehicle body substantially in a cross vehicle direction to a partially open position while a front portion of the door concurrently moves substantially in a longitudinal vehicle direction of the vehicle, and then, move the front portion and the rear portion of the door concurrently in substantially the longitudinal vehicle direction of the vehicle to the open position.

### CROSS-REFERENCE TO RELATED APPLICATIONS

This application claims the benefit of U.S. Provisional Application Ser. No. 63/320,154, filed Mar. 15, 2022, of U.S. Provisional Application Ser. No. 63/217,220, filed Jun. 30, 2021, and of U.S. Provisional Application Ser. No. 63/196,138, filed Jun. 2, 2021, which are all incorporated herein by way of reference in their entirety.

### FIELD

The present disclosure relates generally to closure member systems for motor vehicles and, more particularly, to a dual door pillar-less door system having a power linkage system for translating a door between open and closed positions relative to a vehicle body.

### BACKGROUND

This section provides background information related to the present disclosure which is not necessarily prior art.

A typical motor vehicle is equipped with at least one pair of doors to provide access to a passenger compartment. Specifically, most vehicles include driver-side and passenger-side swing doors that are pivotably supported from the vehicle body to move between closed and open positions. These doors are each equipped with a latch assembly having a latch mechanism operable in a latched mode to hold the door in its closed position and in an unlatched mode to permit pivotal movement of the door to its open position.

In some vehicles, such as minivans and pick-up trucks with extended cabs, for example, the vehicle body is formed with an enlarged door opening without a structural B-pillar. Such “pillar-less or pillarless” dual-door closure systems typically include a front swing door pivotably hinged along or adjacent its front edge to a front vertical structural portion (i.e., the A-pillar) and/or to a horizontal structural portion of the vehicle body adjacent the A-pillar of the door opening and a rear swing door pivotably hinged along or adjacent its rear edge to a rear vertical structural portion (i.e., the C-pillar) and/or to a horizontal structural portion of the vehicle body adjacent the C-pillar of the door opening.

In such “pillarless” dual-door closure systems, challenges can arise while opening the doors, particularly the rear swing door, given the need to have sufficient room to pivot the door outwardly away from the vehicle body. In some cases, the rear door can be support by a linkage assembly having opposite ends of each link fixed for pivotal movement about an axis in a four-bar link arrangement. However, though the door having a four-bar link arrangement does not pivot outwardly from the vehicle body as in the case of a swing door, it still swings outwardly from the vehicle body in a cross-vehicle direction along a constant radius arc a distance substantially equal to a length of the links extending between fixed pivot axes of the separate links, with the fixed pivot axes being fixed relative to the door and the vehicle body.

While current pillarless door assemblies are well suited to meet regulatory requirements and provide enhanced operational convenience, there remains a need to develop alternative linkage systems which address and overcome limitations and drawbacks associated with known pivoting or four-bar link arrangements for dual door pillar-less door systems as well as to provide increased convenience and enhanced operational capabilities, such that the door remains unobtrusive in a cross-vehicle direction during movement and upon reaching the open position, that facilitates ease of assembly, that is efficient in operation, while at the same time being compact, robust, durable, lightweight and economical in manufacture, assembly, and in use.

### SUMMARY

This section provides a general summary of the present disclosure and is not intended to be considered a comprehensive and exhaustive listing of its full scope or all aspects, objectives and features.

It is an object of the present disclosure to provide a linkage system for use in a B-pillarless dual-door closure system of a motor vehicle that addresses at least those issues discussed above with regard to pivoting and four-bar link arrangements of known B-pillarless dual-door closure systems.

It is another object of the present disclosure to provide a linkage system for use in a B-pillarless dual-door closure system of a motor vehicle that minimizes the cross-vehicle distance a door extends outwardly from a vehicle body of a motor vehicle as the door is moving between open and closed positions.

It is another object of the present disclosure to optimize the path along which a rear edge and a front edge of a door move relative a vehicle body of a motor vehicle as the door is moving between open and closed positions to minimize the cross-vehicle distance the door extends outwardly from the vehicle body.

It is another object of the present disclosure to arrange the linkage system to cause the rear edge of the door to move substantially in the cross-vehicle direction while the front edge of the door is moving substantially in a longitudinal direction, transverse to the cross-vehicle direction, of the motor vehicle as the door is moving between open and closed positions to minimize the cross-vehicle distance the door extends outwardly from the vehicle body.

It is another object of the present disclosure to arrange the linkage system to cause the front edge of the door to move substantially in the lengthwise-vehicle direction while the front edge of the door is proximate to the fully closed position.

It is another object of the present disclosure to arrange the linkage system to cause the rear edge of the door to move substantially in the cross-vehicle direction while the front edge of the door is moving substantially in a longitudinal direction, transverse to the cross-vehicle direction, of the motor vehicle as the door is initially moving from the closed position toward the open position, and then to cause the front edge and the rear edge to move substantially along a coplanar path to minimize the cross-vehicle distance the door extends outwardly from the vehicle body.

In accordance with these and other objects, a door linkage system for guiding a door of a motor vehicle between an open position and a closed position relative to a vehicle body is provided. The door linkage system includes at least one linkage connecting the door to the vehicle body. The at least one linkage is configured to extend outwardly from and retract inwardly into the vehicle body as the door moves between a closed position and an open position.

In accordance with another aspect, the at least one linkage includes a first and a second link. The first link has a first link proximal end coupled to the vehicle body and a first link distal end coupled to the door. The second link has a second link proximal end coupled to the vehicle body and a second link distal end coupled to the door. At least one of the first link proximal end and the second link proximal end is configured to move along a curved path, thereby facilitating desired guidance of forward and rearward portions of the door along a low-profile path, extending a minimal cross-vehicle distance outwardly from the vehicle body, as the door moves between the closed and open positions.

In accordance with another aspect, both the first link proximal end is configured to move along a first curved path and the second link proximal end is configured to move along a second curved path.

In accordance with another aspect, at least one of the first curved path and the second curved path can be provided having a non-constant radius of curvature in order to provide an optimal path of motion of the door, extending a minimal cross-vehicle distance outwardly from the vehicle body, as it moves between the closed and open positions.

In accordance with another aspect, each of the first curved path and the second curved path can be provided having a non-constant radius of curvature.

In accordance with another aspect, the first curved path and the second curved path can be provided having a geometrically different shape from one another in order to provide an optimal path of motion of the door, extending a minimal cross-vehicle distance outwardly from the vehicle body, as it moves between the closed and open positions.

In accordance with another aspect, the first curved path is configured to move a rearward portion of the door in a substantially cross-vehicle direction of the motor vehicle while the second curved path is configured to concurrently move a forward portion of the door in a substantially longitudinal vehicle direction of the motor vehicle to provide an optimal path of motion of the door, extending a minimal cross-vehicle distance outwardly from the vehicle body, as it moves between the closed and open positions.

In accordance with another aspect, the first curved path and the second curved path can be provided being substantially annular.

In accordance with another aspect, a motor is configured to drive a drive member to directly drive one of the first link proximal end along the first curved path and the second link proximal end along the second curved path.

In accordance with another aspect, a first guide member is fixed to the vehicle body and a second guide member is fixed to the vehicle body. The first link is configured to pivot about the first guide member while the first link proximal end moves along the first curved path and the second link is configured to pivot about the second guide member while the second link proximal end moves along the second curved path.

In accordance with another aspect, the first guide member can be provided as a fixed first pin and the second guide member can be provided as a fixed second pin, and wherein the first link can be provided having a first elongate slot extending between the first link proximal end and the first link distal end and the second link can be provided having a second elongate slot extending between the second link proximal end and the second link distal end. The first pin is disposed in the first elongate slot for sliding movement therein to facilitate controlling pivotal movement of the first link and the second pin is disposed in the second elongate slot for sliding movement therein to facilitate controlling pivotal movement of the second link.

In accordance with another aspect, the drive member is disposed in one of the first elongate slot and the second elongate slot to directly drive the one of the first link proximal end along the first curved path and the second link proximal end along the second curved path, wherein the other of the first link proximal end and the second link proximal end is indirectly driven along the respective first and second curved path.

In accordance with another aspect, the motor can be configured to rotate the drive member in a first direction to drive the one of the first link proximal end along a first portion of the first curved path or the second link proximal end along a first portion of the second curved path, and to rotate the drive member in a second direction to drive the one of the first link proximal end along a second portion of the first curved path or the second link proximal end along a second portion of the second curved path.

In accordance with another aspect, the first link distal end and the second link distal end can be fixed to remain spaced from one another over a fixed distance from one another as the door moves between the open and closed positions.

In accordance with another aspect, a distance extending between the first link proximal end and the second link proximal end can vary as the door moves between the open and closed positions to facilitate providing an optimal path of motion of the door, extending a minimal cross-vehicle distance outwardly from the vehicle body, as it moves between the closed and open positions.

In accordance with another aspect, the first link proximal end can be provided having a first roller configured to roll along the first curved path and the second link proximal end can be provided having a second roller configured to roll along the second curved path in order to minimize friction within the door linkage system as the door moves between the closed and open positions.

In accordance with another aspect, the first curved path can be defined by a first recessed channel configured for receipt of the first roller therein and the second curved path can be defined by a second recessed channel configured for receipt of the second roller therein.

In accordance with another aspect, a door linkage system for guiding a door of a motor vehicle between an open position and a closed position relative to a vehicle body includes at least one linkage pivotally connected between the door and the vehicle body to move a rear portion of the door away from the vehicle body substantially in a cross vehicle direction such that a front portion of the door can move substantially in a longitudinal vehicle direction of the vehicle, and then, move the front portion and the rear portion of the door in substantially the longitudinal vehicle direction of the vehicle, thereby optimizing a path of motion of the door, extending a minimal cross-vehicle distance outwardly from the vehicle body, as it moves between the closed and open positions.

In accordance with another aspect, a door linkage system for guiding a door of a motor vehicle between an open position and a closed position relative to a vehicle body includes at least one linkage pivotally connected between the door and the vehicle body using two pivots spaced apart from one another, wherein a distance between the two pivots changes as the door moves between the open and closed positions, thereby allowing a path of motion of the door, extending in a cross-vehicle distance outwardly from the vehicle body, to be optimized and minimized as the door moves between the closed and open positions.

In accordance with another aspect, a method of opening a rear door of a motor vehicle includes: providing a linkage connecting the rear door to a vehicle body of motor vehicle; driving the linkage to cause a rearward portion of the rear door to move away from the vehicle body in a cross-vehicle direction; driving the linkage to cause a forward portion of the rear door to move in a substantially rearward lengthwise vehicle direction; continuing to drive the linkage to cause the rearward portion of the rear door to move inward in the cross-vehicle direction toward the vehicle body and concurrently in a rearward lengthwise vehicle direction; and driving the linkage to cause the forward portion of the rear door to move outward in the cross-vehicle direction and concurrently in a rearward lengthwise vehicle direction.

In accordance with another aspect, the method can further include providing the linkage including a first link and a second link.

In accordance with another aspect, a door linkage system for guiding a door of a motor vehicle between an open position and a closed position relative to a vehicle body includes a multi bar linkage connecting the door to the vehicle body. The multi bar linkage is configured to move a forward portion of the door from the closed position initially in a substantially lengthwise direction along the motor vehicle and a rearward portion of the door initially substantially in a cross-vehicle direction away from the vehicle body, and then during an intermediate stage of movement, move the forward portion in the cross-vehicle direction away from the vehicle body and in the lengthwise direction and move the rearward portion substantially in the lengthwise direction toward a fully open position.

In accordance with another aspect, the door linkage system can provide a final stage of movement of the door to the fully open position by moving at least one of the forward portion and the rearward portion in the cross-vehicle direction toward the vehicle body.

In accordance with another aspect, the multi bar linkage can include a first link and a second link, wherein the first link is larger than the second link, and wherein the first link is attached to the door proximate the center of gravity of the door.

In accordance with another aspect, the first link is generally L-shaped and the second link is generally straight.

In accordance with another aspect, a secondary link couples the second link to the door.

In accordance with another aspect, a cinch lever is coupled to the second link, wherein the cinch lever is configured for cinching engagement with a striker fixed to a vehicle body of the motor vehicle.

In accordance with another aspect, an actuator assembly is coupled to the first link to the drive first link between a closed position corresponding to the closed position of the door and an open position corresponding to the open position of the door.

In accordance with another aspect, the actuator assembly includes a geartrain to provide a torque multiplication and speed reduction.

In accordance with another aspect, the geartrain includes a sun gear, a ring gear and a plurality of planetary gears meshed with the sun gear and the ring gear.

In accordance with another aspect, the plurality of planetary gears are supported by a carrier for conjoint rotation about an axis with one another, and further including an output arm attached to the carrier and the first link.

In accordance with another aspect, an obstacle detection system can be configured to prevent the door from contacting an obstacle while moving between the closed and open positions.

In accordance with another aspect, the obstacle detection system is configured to straighten the wheel prior to moving the door between the open and closed positions.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a perspective view of a motor vehicle equipped with a B-pillarless dual-door closure system;

FIG. 2 is a side elevation view of a portion of the motor vehicle shown in FIG. 1 with the doors of the dual-door B-pillarless closure system located in a closed position;

FIG. 3 is a side isometric view of a portion of the motor vehicle shown in FIG. 1 with a rear door of the B-pillarless dual-door closure system located in an open position;

FIG. 4 is an isometric view of a closure latch assembly for use with at least one of the doors of the B-pillarless dual-door closure system and which is configured to provide anti-chucking and cinching functions in accordance with the present disclosure;

FIG. 4A is a side elevation view of the closure latch assembly of FIG. 4 shown with a ratchet of the B-pillarless closure latch assembly in a secondary striker capture position;

FIG. 4B is an opposite side elevation view of FIG. 4A;

FIG. 5 is a view similar to FIG. 4 showing the ratchet in the secondary striker capture position, a cinch lever in an unactuated position, a cancellation lever in a disengaged position, and an anti-chuck lever in a disengaged position;

FIG. 5A is side elevation view of a portion of FIG. 5 showing the cinch lever initiating engagement with the ratchet;

FIG. 6 is a view similar to FIG. 5 showing the ratchet in an intermediate position between the secondary striker capture position and the striker over-travel position, the cinch lever in an intermediate position between the unactuated position and an actuated position, the cancellation lever in the disengaged position, and the anti-chuck lever in the disengaged position;

FIG. 6A is a side elevation view of FIG. 6 showing the ratchet being rotated by the cinch lever and the pawl being rotated by the ratchet;

FIG. 7 is a view similar to FIG. 6 showing the ratchet in an intermediate position between the secondary striker capture position and the striker over-travel position, the cinch lever in an intermediate position between the unactuated position and an actuated position, the cancellation lever in an engaged position, and the anti-chuck lever in the disengaged position;

FIG. 7A is a side elevation view of FIG. 7 showing the ratchet being rotated by the cinch lever and the pawl being rotated by the ratchet;

FIG. 8 is a view similar to FIG. 7 showing the ratchet in the striker over-travel position, the cinch lever in the actuated position, the cancellation lever in the engaged position shown blocking the anti-chuck lever and maintaining the anti-chuck lever in the disengaged position;

FIG. 8A is a side elevation view of FIG. 8 showing the ratchet rotated by the cinch lever to the striker over-travel position and the cancellation lever engaged with and blocking the anti-chuck lever in the disengaged position;

FIG. 9 is a view similar to FIG. 8 showing the ratchet returned to a primary striker capture position via a bias imparted by a ratchet spring, the cinch lever returned to the unactuated position via a bias imparted by a cinch lever spring, the cancellation lever returned to the disengaged position via a bias imparted by a cancellation lever spring, and the anti-chuck lever in the disengaged position just prior to being returned to an engaged position via a bias imparted by an anti-chuck lever spring;

FIG. 10 is a view similar to FIG. 9 showing the ratchet in the primary striker capture position, the cinch lever in the unactuated position, the cancellation lever in the disengaged position, and the anti-chuck lever returned to an engaged position via the anti-chuck lever spring to inhibit the ratchet from moving toward the striker over-travel position;

FIG. 10A is a side elevation view of FIG. 10 showing the anti-chuck lever engaging a stop lug segment of the ratchet to inhibit the ratchet from moving toward the striker over-travel position;

FIG. 11 is a schematic plan view of the dual-door B-pillarless closure system shown in a closed position;

FIG. 12 is an enlarged schematic perspective view of first and second tracks of the dual-door B-pillarless closure system along which proximal ends of first and second links of a linkage traverse during a door opening and closing event;

FIG. 13 is a perspective view of a link of the linkage of the dual-door B-pillarless closure system;

FIG. 14 is an enlarged perspective view of a rotary actuator configured in driving engagement with a link of the linkage of the dual-door B-pillarless closure system;

FIG. 15 is a schematic plan view of showing the rotary actuator configured in driving engagement in a slot of a link of the linkage of the dual-door B-pillarless closure system;

FIG. 16 is a view similar to FIG. 15 illustrating a roller of the link being driven along one of the first and second tracks of the dual-door B-pillarless closure system;

FIG. 17 is a flow diagram illustrating a controller in operable communication with various features of the dual-door B-pillarless closure system;

FIG. 18 is a flow diagram illustrating a method of opening a door of a motor vehicle having a dual-door B-pillarless arrangement in accordance with the disclosure;

FIG. 19 is a view similar to FIG. 11 schematically illustrating a power actuator configured in drivable engagement with a link of the of the linkage of the dual-door B-pillarless closure system;

FIGS. 20-23 illustrate an initial stage and movement of the door from a closed position toward an open position via actuation of the dual-door B-pillarless closure system, with a rearward portion of the door being moved substantially in an outward cross-vehicle direction with a front portion of the door being moved substantially in a rearward lengthwise vehicle direction;

FIGS. 24-25 illustrate an intermediate stage and movement of the door toward the open position, with the rearward portion of the door being moved in an inward cross-vehicle direction and rearward lengthwise vehicle direction with the front portion of the door being moved gradually in an outward cross-vehicle direction and rearward lengthwise vehicle direction;

FIGS. 26-28 illustrate a final stage and movement of the door to the open position, with the rearward portion of the door being moved substantially in the rearward lengthwise vehicle direction and with the front portion of the door being moved substantially in the rearward lengthwise vehicle direction, while the door is maintained in a close, clearance relation with a vehicle body of the motor vehicle;

FIG. 29 is a view similar to FIG. 23 illustrating first and second tracks of a dual-door B-pillarless closure system along which proximal ends of first and second links of a linkage traverse during a door opening and closing event in accordance with another aspect of the disclosure;

FIG. 30 is a schematic top plan view of a motor vehicle illustrating a path of motion of doors of a dual-door B-pillarless closure system of the motor vehicle in accordance with another aspect of the disclosure;

FIG. 31 illustrates, in solid, one of the doors of FIG. 30 while in a closed position, and in phantom, in an open position;

FIG. 32 illustrates, in solid, the door of FIG. 31 during an initial stage of movement from the closed position toward the open position via actuation of the dual-door B-pillarless closure system, with a rearward portion of the door being moved substantially in an outward cross-vehicle direction with a front portion of the door being moved substantially in a rearward lengthwise vehicle direction;

FIGS. 33-35 illustrate, in solid, continued movement of the door, from the initial stage of FIG. 32, during an intermediate stage of movement of the door toward the open position;

FIG. 36 illustrates, in solid, the door moved to the open position, and in phantom, a path of the door during initial and intermediate stages of movement;

FIG. 37A illustrates a dual-door B-pillarless closure system in accordance with another aspect of the disclosure, with each of a plurality of actuators of the system being contained in a vehicle body of the motor vehicle, wherein a linkage of the dual-door B-pillarless closure system is similar as illustrated in FIGS. 31-36;

FIG. 37B illustrates a dual-door B-pillarless closure system in accordance with another aspect of the disclosure, with each of a plurality of actuators of the system being contained in a door of the motor vehicle, wherein a linkage of the dual-door B-pillarless closure system is similar as illustrated in FIGS. 31-36;

FIG. 38 illustrates a dual-door B-pillarless closure system of the motor vehicle of FIG. 30 in accordance with another aspect of the disclosure, with one of the doors shown, in solid, while in a closed position and, in phantom, while in an open position;

FIG. 39 illustrates, in solid, the door of FIG. 38 during an intermediate stage of movement from the closed position toward the open position via actuation of the dual-door B-pillarless closure system;

FIG. 39A is an enlarge fragmentary view of FIG. 39 showing a portion of the door and an actuator assembly of the dual-door B-pillarless closure system;

FIG. 40 illustrates the door of FIG. 38 moved to the open position;

FIG. 41 illustrates an initial stage of the actuator assembly moving the door from the open position toward the closed position;

FIG. 42 illustrates an intermediate stage of the actuator assembly moving the door, shown in solid, from the open position, shown in phantom, toward the closed position;

FIG. 43 illustrates a final stage of the actuator assembly moving the door from the open position, shown in phantom, to the closed position, shown in solid;

FIG. 44A illustrates a schematic side view of the vehicle of FIG. 33 showing latch assembly arrangements in accordance with one aspect of the disclosure;

FIG. 44B is a view similar to FIG. 44A showing latch assembly arrangements in accordance with another aspect of the disclosure;

FIG. 45A illustrates a schematic top view of a door and vehicle body of the vehicle of FIG. 33 showing striker and latch assembly arrangements in accordance with one aspect of the disclosure;

FIG. 45B is a view similar to FIG. 45A showing striker and latch assembly arrangements in accordance with another aspect of the disclosure;

FIG. 46 is a schematic side view of a motor vehicle illustrating a dual-door B-pillarless closure system of the motor vehicle in accordance with another aspect of the disclosure;

FIG. 46A is schematic top plan view illustrating a door and linkage of the dual-door B-pillarless closure system of FIG. 46;

FIG. 47 is an enlarged view of FIG. 46A illustrating the door while in a closed position and the associated arrangement of the linkage;

FIG. 48 illustrates the door of FIG. 47 during an initial stage of movement from the closed position toward an open position via actuation of the dual-door B-pillarless closure system, with a rearward portion and forward portion of the door being moved substantially in an outward cross-vehicle direction;

FIGS. 49-55 illustrate the door of FIG. 47 during an intermediate stage of movement from the initial stage toward the open position via continued actuation of the dual-door B-pillarless closure system, with a rearward and forward portion of the door being moved substantially in a rearward lengthwise vehicle direction;

FIG. 56 illustrates the door of FIG. 47 moved to the open position;

FIG. 57 is a schematic top view of a motor vehicle illustrating a dual-door B-pillarless closure system of the motor vehicle in accordance with another aspect of the disclosure, with a rear door of the motor vehicle having been moved during an initial stage of movement from a closed position toward an open position by a linkage of the dual-door B-pillarless closure system;

FIG. 58 is an enlarged view of the rear door of the motor vehicle of FIG. 57 while in the closed position;

FIG. 58A is an enlarged view of a door-to-door latch and striker of the rear door of FIG. 58;

FIG. 59 illustrates the rear door of FIG. 58 during an initial stage of movement from the closed position toward the open position via actuation of the dual-door B-pillarless closure system, with a rearward portion of the rear door being moved substantially in an outward cross-vehicle direction with a front portion of the rear door being moved substantially in a rearward lengthwise vehicle direction;

FIG. 59A is an enlarged view of the door-to-door latch and striker of the rear door of FIG. 59;

FIGS. 60-63 illustrate the rear door of FIG. 59 during an intermediate stage of movement from the initial stage toward the open position via continued actuation of the dual-door B-pillarless closure system;

FIG. 64 illustrates the rear door of FIG. 59 moved to the open position;

FIG. 65A illustrates a schematic side view of the motor vehicle of FIG. 57 showing latch assembly arrangements in accordance with one aspect of the disclosure;

FIG. 65B is a view similar to FIG. 44A showing latch assembly arrangements in accordance with another aspect of the disclosure;

FIG. 66 illustrates various latch and striker aspects of the doors of the motor vehicle of FIG. 57;

FIGS. 67A and 67B illustrate links of a linkage of a dual-door B-pillarless closure system in accordance with another aspect of the disclosure;

FIGS. 68A-68C illustrate a link of a linkage of a dual-door B-pillarless closure system in accordance with another aspect of the disclosure;

FIG. 69 is a perspective view illustrating a door and linkage of a dual-door B-pillarless closure system in accordance with another aspect of the disclosure;

FIG. 70 illustrates the door of FIG. 69 during an initial stage of movement from a closed position toward the open position via actuation of the dual-door B-pillarless closure system;

FIGS. 71-74 illustrate continued movement of the door, from the initial stage of FIG. 70, during an intermediate stage of movement of the door toward the open position;

FIG. 75 illustrates the door moved to the open position;

FIG. 76 illustrates a path along which a linkage(s) of the door may traverse during an opening and closing event of the door;

FIG. 76A is a top view illustrating a door and linkage of a dual-door B-pillarless closure system in accordance with another aspect of the disclosure;

FIG. 77 is a view similar to FIG. 31 of a dual-door B-pillarless closure system of the motor vehicle in accordance with another aspect of the disclosure illustrating, in solid, one of the doors of FIG. 30 while in a closed position, and in phantom, in an open position;

FIG. 78 illustrates, in solid, the door of FIG. 77 during an initial stage of movement under the power of a first motor from the closed position toward the open position via actuation of the dual-door B-pillarless closure system, with a front portion and rearward portion of the door being moved in a rearward lengthwise vehicle direction and outward cross-vehicle direction;

FIG. 78A shows one possible path of motion of the door in accordance with an illustrative example;

FIG. 79 illustrates, in solid, continued movement of the door under the power of a first motor, from the initial stage of FIG. 78, during an intermediate stage of movement of the door toward the open position;

FIG. 80 illustrates, in solid, continued movement of the door under the power of a first motor, from position of FIG. 79, to a maximum outward cross-vehicle position of the door from a vehicle body, whereat a second motor initiates actuation, with a maximum outward cross-vehicle position of the door shown in phantom contrasting a one-piece hinge embodiment;

FIGS. 81-84 illustrate continued movement of the door under the power of the first and second motors from position of FIG. 80 toward the open position;

FIGS. 85 and 86 illustrate continued movement of the door under the power of the second motor from position of FIG. 84 to the open position;

FIG. 87 is a view similar to FIG. 77 of a dual-door B-pillarless closure system of the motor vehicle in accordance with another aspect of the disclosure illustrating, in solid, one of the doors of FIG. 30 while in a closed position, and in phantom, in an open position;

FIG. 88 illustrates, in solid, continued movement of the door under the power of a first motor, from position of FIG. 87, to a maximum outward cross-vehicle position of the door from a vehicle body;

FIG. 89 illustrates, in solid, continued movement of the door under the power of a second motor toward the open position;

FIGS. 90 and 91 illustrate continued movement of the door under the power of the second motor from position of FIG. 89 to the open position;

FIG. 92 is a view similar to FIG. 88 of a dual-door B-pillarless closure system of the motor vehicle in accordance with another aspect of the disclosure illustrating, in solid, one of the doors of FIG. 30 while in a maximum outward cross-vehicle position of the door from a vehicle body;

FIG. 93 is a schematic side view of a motor vehicle illustrating a dual-door B-pillarless closure system of the motor vehicle in accordance with another aspect of the disclosure;

FIGS. 93A and 93B are schematic top plan views illustrating a door and linkage of the dual-door B-pillarless closure system of FIG. 93;

FIG. 94 illustrates the door of FIGS. 93A-93B during an intermediate stage of movement from the initial stage toward the open position via actuation of the dual-door B-pillarless closure system, with a rearward and forward portion of the door being moved substantially in a rearward lengthwise vehicle direction;

FIG. 95A is a view similar to FIG. 77 of a dual-door B-pillarless closure system of the motor vehicle in accordance with another aspect of the disclosure;

FIG. 95B is a view of operation of the dual-door B-pillarless closure system of the motor vehicle of FIG. 95A illustrating another possible path of motion of the door in accordance with another aspect of the disclosure;

FIG. 96 is a schematic top plan view of a motor vehicle illustrating movement of a door of a dual-door B-pillarless closure system of the motor vehicle having a linkage system in accordance with another aspect of the disclosure;

FIG. 97 is a perspective view of the linkage system of FIG. 96 shown in a position corresponding to a door closed position;

FIG. 98 is a view similar to FIG. 97 with the linkage system shown in a position corresponding to an initial stage of opening the door from the closed position or a final stage of closing the door from an open position;

FIG. 98A is a view similar to FIG. 98 looking from a different perspective;

FIG. 99 is a view similar to FIG. 98 with the linkage system shown in an intermediate position corresponding to the door being located between the open and closed positions;

FIG. 100 is a view similar to FIG. 99 with the linkage system shown in a fully deployed, open position corresponding to the door being located in the open;

FIGS. 101A and 101B are front and rear perspective views, respectively, of an actuator of the linkage system of FIG. 96;

FIG. 101C is a side perspective view of an actuator of the linkage system of FIG. 96 constructed in accordance with another aspect of the disclosure;

FIG. 101D is a side perspective view of a female splined receptacle of a link of the linkage system of FIG. 96 configured for receipt of a splined male output shaft of the actuator of FIG. 101C;

FIG. 101E is a side perspective view of another illustrative actuator of the linkage system of FIG. 96;

FIG. 101F is a side perspective view of the actuator of FIG. 101D, with an outer housing removed illustrating a geartrain assembly;

FIG. 102 is a front side perspective view of the actuator shown with a cover removed to show an internal geartrain assembly thereof;

FIG. 103 is a view similar to FIG. 102 with a plurality of gears removed from the geartrain solely to more clearly illustrate a motor output gear in driving engagement with a drive gear of the geartrain assembly, with a sun gear shown fixed for conjoint rotation with the drive gear;

FIG. 104 is a rear perspective view of the actuator shown with the cover and the drive gear/sun gear removed to more clearly illustrate a ring gear and a carrier supporting a plurality of planetary gears configured in meshed engagement with the ring gear, with the planetary gears being configured for rotation about the ring gear to rotatably drive the carrier in response to rotation of the motor output gear;

FIG. 105 is a front perspective view of FIG. 4 showing a plurality of attachment openings in the carrier, to which an output arm is attached for conjoint rotation with the carrier;

FIG. 106 is a perspective view of a linkage system including a cinch mechanism in accordance with another aspect of the disclosure;

FIG. 107 is a fragmentary side view of the linkage system of FIG. 106 illustrating a cinch lever of the cinch mechanism configured for cinching engagement with a striker fixed the motor vehicle;

FIG. 108 is a perspective view illustrating the cinch lever in cinched engagement with the striker;

FIG. 109 is a fragmentary perspective view of a linkage assembly constructed in accordance with another aspect of the disclosure illustrating a cinch pin (cinch striker) of the linkage system configured for cinching engagement with a cinch slot in a frame member of the motor vehicle;

FIG. 109A to FIG. 109C illustrates a sequence of decoupling a first linkage from a third linkage;

FIG. 110 is a fragmentary perspective view of a cinch mechanism of a linkage assembly constructed in accordance with another aspect of the disclosure illustrating a cinch roller of the cinch mechanism configured for cinching engagement with a cinch slot in a frame member of the motor vehicle;

FIG. 111 is a fragmentary perspective view of a cinch mechanism of a linkage assembly constructed in accordance with another aspect of the disclosure illustrating a plurality of cinch rollers of the cinch mechanism configured for cinching engagement with a cinch slot in a frame member of the motor vehicle;

FIGS. 112A-112D illustrate fragmentary perspective views of non-limiting embodiments of an opening assist mechanism of a linkage assembly constructed in accordance with another aspect of the disclosure illustrating a biasing member of the linkage assembly configured for biased engagement with a link of the linkage assembly to facilitate movement of the linkage assembly, and door fixed thereto, from a closed position toward an open position;

FIG. 113 is a schematic overhead plan view of a motor vehicle having a dual-door B-pillarless closure system with a linkage system including an obstacle detection system to prevent inadvertent contact of a closure panel with an obstacle, shown a motor vehicle wheel (in solid and phantom) in accordance with another aspect of the disclosure;

FIG. 114 is a view similar to FIG. 113 showing the closure panel in an open position with the wheel in a turned position, thereby presenting an obstacle to the full movement of the closure panel to a closed position, with the obstacle detection system detecting the wheel in the turned position to avoid movement of the closure panel into contact with the wheel;

FIG. 115 is a view similar to FIG. 114 illustrating the closure panel moved to a partially closed (partially open) position and stopped prior to contacting the wheel via communication of the obstacle detection system with an actuator of the linkage system;

FIG. 116 is a flow diagram illustrating a control system of the obstacle detection system of FIG. 115 in accordance with a non-limiting aspect of the disclosure;

FIG. 117 is flow diagram illustrating a method of opening a door and preventing a collision between the door and an obstacle while being opened in accordance with an aspect of the disclosure;

FIG. 117A is flow diagram illustrating a method of opening a door and preventing a collision between the door and an obstacle while being opened in accordance with another aspect of the disclosure; and

FIG. 118 is flow diagram illustrating a method of opening a door and preventing a collision between the door and an obstacle while being opened in accordance with yet another aspect of the disclosure.

### DETAILED DESCRIPTION OF EXAMPLE EMBODIMENTS

Example embodiments of a door linkage system for a B-pillarless dual-door arrangement of a motor vehicle to facilitate maintaining the B-pillarless dual-door arrangement in a closed position in sealed engagement with a vehicle body of the motor vehicle and to facilitate smooth opening of a door with minimal movement of the door outwardly in a cross-vehicle direction away from a vehicle body of the motor vehicle will now be more fully described with reference to the accompanying drawings. These example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

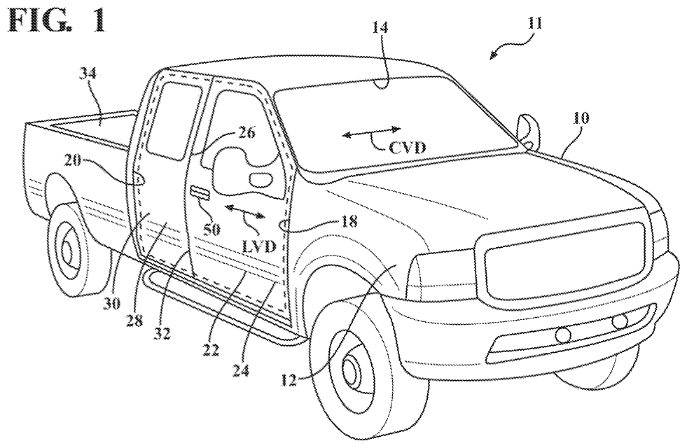

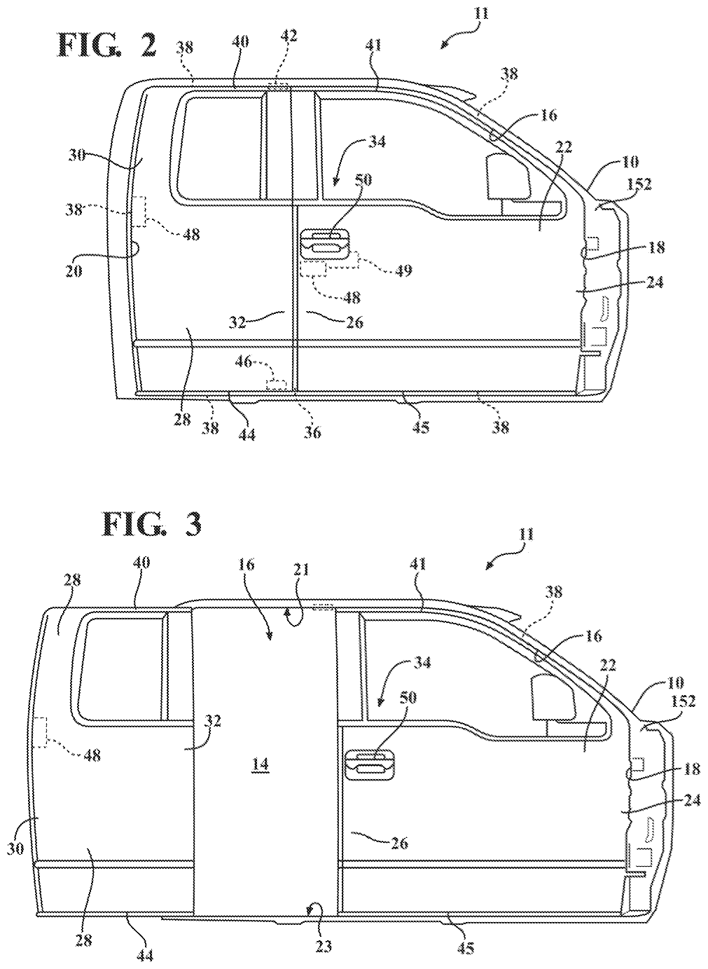

Referring initially to FIGS. 1-2A, a motor vehicle 11 is shown configured as a pickup truck, by way of example and without limitation, including a vehicle body 10 having an exterior 12 and an interior 14 defining a passenger compartment. Motor vehicle 11 may also be provided as a car, such as a sedan, a sports car, or a sports utility vehicle type as non-limiting examples. Motor vehicle 11 may also be provided as a gas powered motor vehicle, or an electric type motor vehicle. Motor vehicle 11 may also be provided as an autonomous self-driving motor vehicle. Connecting exterior 12 and interior 14 of vehicle body 10 is a continuous or “pillar-less” side opening 16 (FIG. 2A) defining a first or front terminal end 18 and a second or rear terminal end 20, with there being no vertically extending pillar, commonly referred to as a “B-pillar”, extending from a horizontal upper body surface 21 to a horizontal lower body surface 23 of the vehicle body 10 between the front and rear terminal ends 18, 20. Accordingly, opening 16 is “B-pillar-less.” Example embodiments of a door linkage system are illustrated herein for a B-pillarless dual-door arrangement of a motor vehicle, but may be adapted for use with a motor vehicle having a B-pillar. Providing a first moveable closure panel, also referred to as closure member, for a front portion of opening 16 is a first or front door 22 having a forward portion 24 pivotably and/or translatably connected or coupled via front hinges and/or link members (not shown), wherein front hinges or link members are connected to an “A-pillar” and/or one or both of upper body surface 21 and lower body surface 23 of vehicle body 10 adjacent to front terminal end 18 of opening 16. In embodiments described herein, the door linkage system may be connected at least in part or wholly connected at the lower horizontally extending door structure between the A and C pillars referred to as the rocker panel or sill, and to the upper horizontally extending door structure between the A and C pillars referred to as the lintel. Front door 22 has a rearward portion 26 generally opposite its pivotal and/or translatable connection to vehicle body 10. Providing a second moveable closure panel or closure member for a rear portion of opening 16 is a second or rear door 28. Rear door 28 has a rearward portion 30 which is pivotably and/or translatably connected via rear hinges and/or link members (not shown), wherein rear hinges and/or link members are connected to a “C-pillar” and/or one or both of upper body surface 21 and lower body surface 23 of vehicle body 10 adjacent to rear terminal end 20 of opening 16 and has a forward portion 32 generally opposite to its pivotal connection. When front door 22 and rear door 28 are closed together, the extreme end of rearward portion 26 of front door 22 can be operably latched to and/or directly latched to the extreme end of forward portion 32 of rear door 28, wherein rearward portion 26 and forward portion 32 can be configured in overlapped relation with one another, if desired. Accordingly, front door 22 and rear door 28 together define a B-pillar-less, dual-door motor vehicle closure arrangement, also referred to as motor vehicle closure system 34.

Rear door 28 is schematically shown having an upper or top edge 40 and a lower or bottom edge 44 and front door 22 is schematically shown having an upper or top edge 41 and a lower or bottom edge 45. When closed, front door 22 and rear door 28 have a releasable, operable latched and/or otherwise fixed connection with one another and with vehicle body 10 to provide a reliable closure of front door 22 and rear door 28 with vehicle body 10, with a reliable seal being formed by at least one or more seal members, such as a door-to-door seal member D2D seal member 36 and/or a door-to-body D2B seal member 38. At least one or more (plurality) upper (first) and/or lower (second) door-to-body D2B latch assembly 42, 46, which can be cinchable, and/or side (third) door-to-body D2B closure latch assembly 48, which can be cinchable, can be incorporated with front and/or rear door 22, 28 to facilitate maintaining front and rear doors 22, 28 in their releasable, locked and sealed closed positions. Closure latch assembly 48, is illustratively shown as a rear latching arrangement A latch actuation mechanism 49 can be associated with a front door handle 50. The latch actuation mechanism 49 may be manually-operated and/or power-operated to facilitate the release of a corresponding latch assembly, such as third closure latch assembly 48, by way of example and without limitation.

Those skilled in the art will recognize that the particular location of first, second and third closure latch assemblies 42, 46, 48, if incorporated, shown schematically in FIG. 2A, is merely intended to illustrate an exemplary dual-door latching arrangement and is not intended to limit the present disclosure, as it will be recognized that other arrangements are possible and considered to be within the scope of the present disclosure. It is to be recognized that the type of latch release mechanism employed can be varied in accordance with the inventive concepts associated with cinching aspects of the present disclosure and those skilled in the art will appreciate that any known power and/or manual latch release mechanism, including those having a cinch mechanism, can be associated with each of the closure latch assemblies. Dual-door systems may also include sliding door systems, tailgate systems, access hatch systems, or other ingress/egress systems.

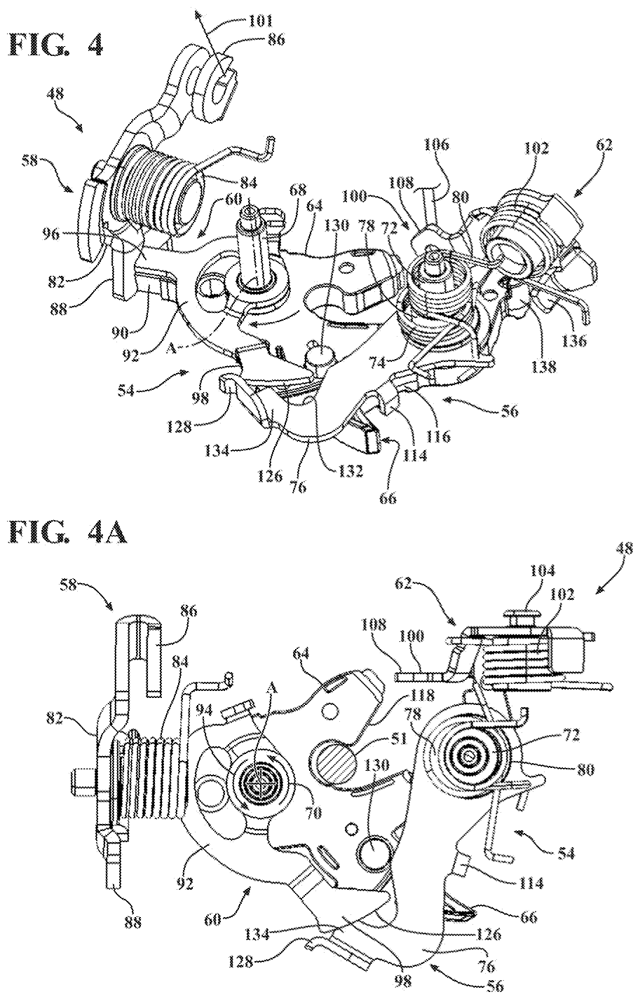

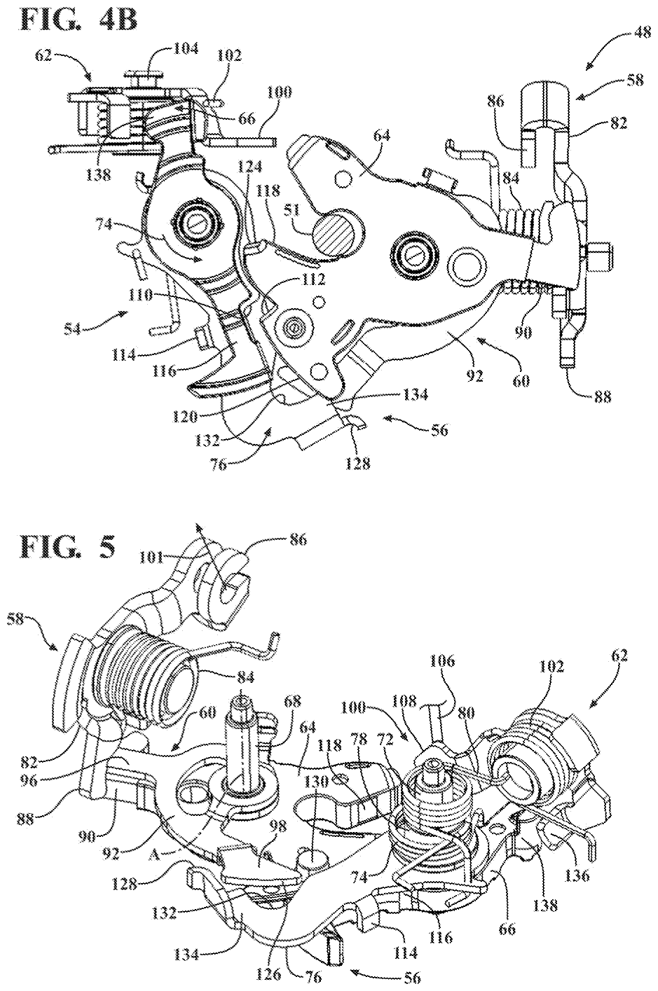

Referring now to FIGS. 4-4B, various components of a non-limiting embodiment of a closure latch assembly in accordance with an aspect of the disclosure will be described to clearly indicate integration of a cinching feature/mechanism, into a latch mechanism to render the latch mechanism “cinchable” for the purpose of eliminating door slop (play), rattle noise, commonly referred to as “chucking” noise, between front door 22 and rear door 28, while allowing front and/or rear doors 22, 28 to be cinched and sealed with vehicle body 10 from an at least partially open position to a fully closed position via the cinching feature. It is to be understood that the closure latch assembly hereinafter described can be used with rear door 28 and/or front door 22 in any one or more of the upper, lower and/or intermediate latch assembly positions.

FIG. 4 illustrates an example of third cinchable closure latch assembly 48, which can be mounted to a portion of front and/or rear door 22, 28. Closure latch assembly 48 is operable to releasably latch to a striker (not shown), such as can be fixed to an associated region of front and/or rear door 22, 28 or vehicle body 10, by way of example and without limitation, such as the rearward portion 30 of rear door 28.

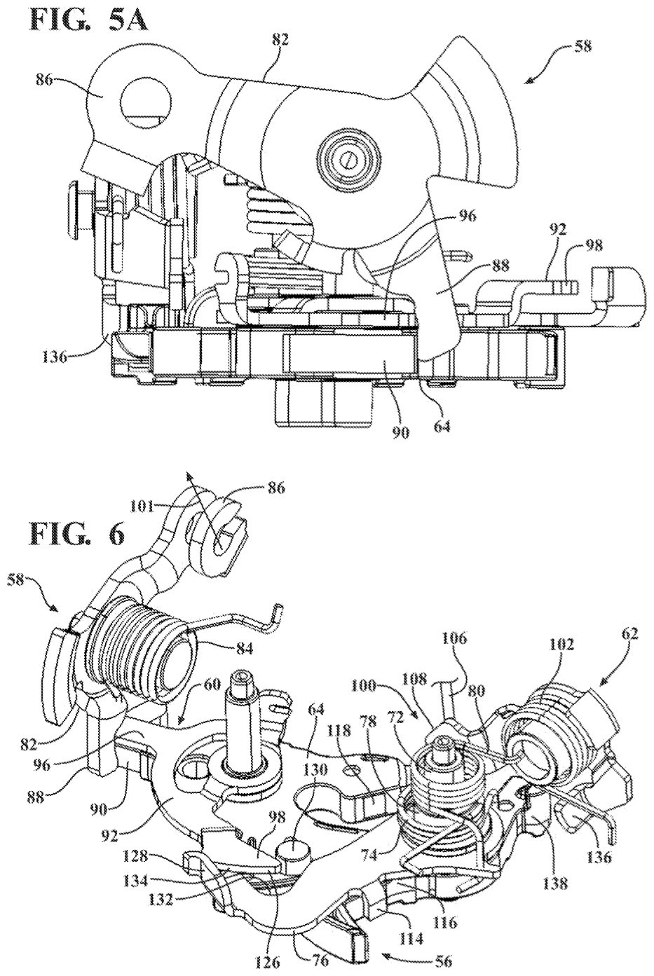

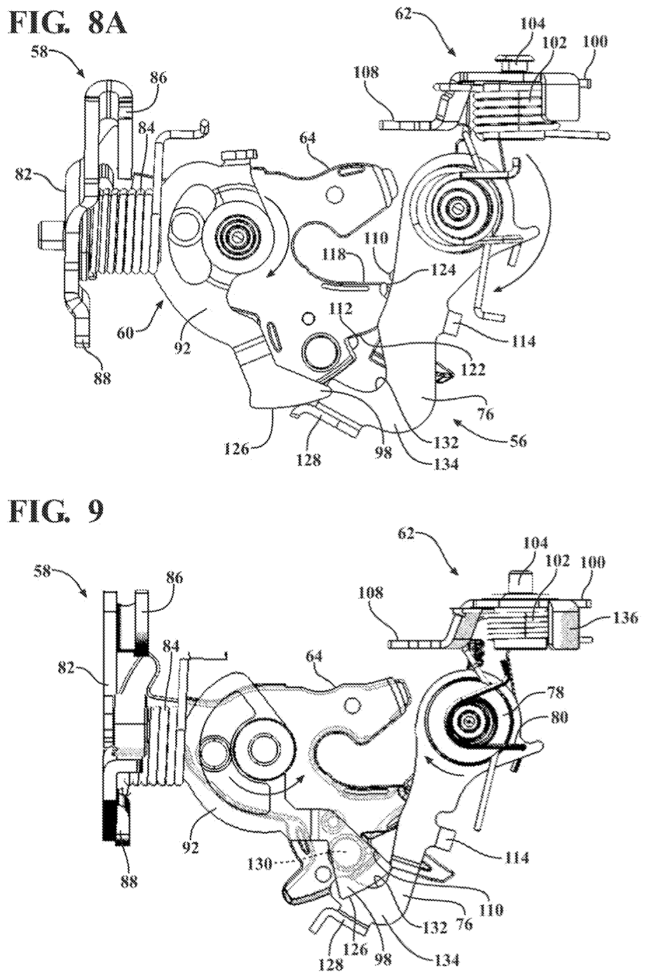

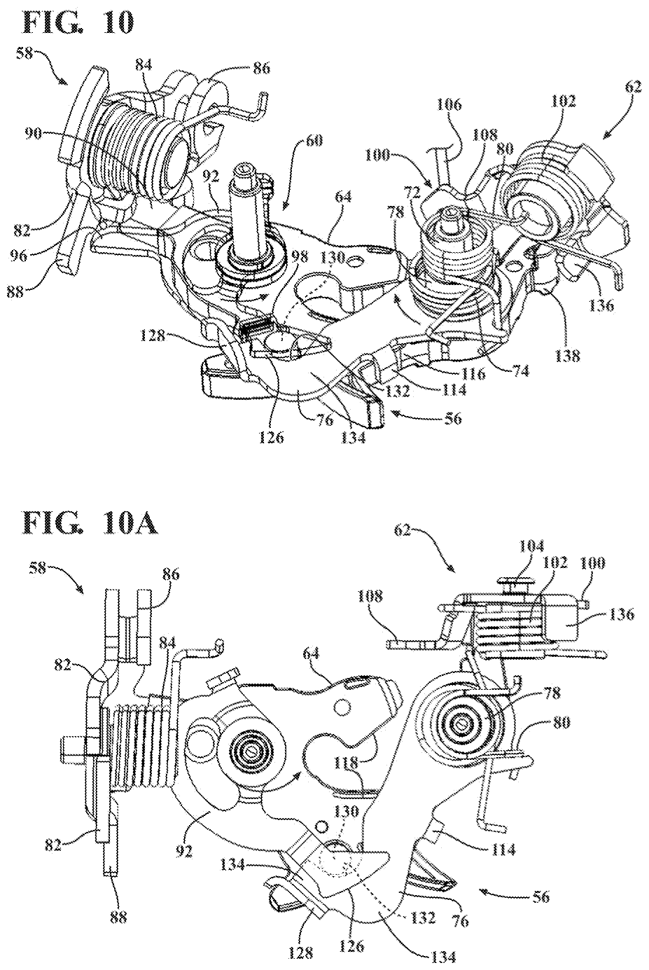

Closure latch assembly 48 includes a latch mechanism 54, an anti-chucking mechanism 56, a cinch mechanism 58, an anti-chucking cancellation mechanism 60, and a latch release mechanism 62. Latch mechanism 54 includes a ratchet 64 and a pawl 66. Ratchet 64 is pivotably supported on a frame plate via a ratchet rivet 68 for rotation about an axis A between a striker release position, a secondary striker capture position (FIGS. 4, 4A, 5, 5A), a primary striker capture position (FIGS. 9, 10, 10A), and a striker over-travel position (FIGS. 8, 8A). Ratchet 64 is normally biased toward its striker release position via a ratchet spring shown schematically at 70 (FIG. 4A). Pawl 66 is pivotably supported on frame plate via a pawl rivet 72 for movement relative to ratchet 64 between a ratchet holding position and a ratchet releasing position. Pawl 66 is normally biased toward its ratchet holding position via a pawl spring 74.

Anti-chucking mechanism 56 generally includes an anti-chuck lever 76, an anti-chuck washer 78, and an anti-chuck lever spring 80. Anti-chuck lever 76 is pivotably supported, such as via pawl rivet 72 also supporting pawl 66 for pivotal movement, by way of example and without limitation, for pivoting movement between a released position, also referred to as disengaged position, and an engaged position. Anti-chuck lever spring 80 is operable to normally bias anti-chuck lever 76 toward its engaged position.

Cinch mechanism 58 generally includes a cinch lever 82 and a cinch lever spring 84. Cinch lever 82 has an actuator arm 86 configured for operable communication with an actuation member, such as via a cable or rod, wherein actuation member can be mechanically, electromechanically and/or electronically actuatable, for example by an actuator 101 having an electric motor. Cinch lever 82 also has a drive arm 88 configured for selective driving engagement with a ratchet cinch arm, also referred to as driven member, ear or cog 90, of ratchet 64. Cinch lever spring 84 is operable to normally bias cinch lever 82 clockwise (as viewed in FIG. 4) toward an unactuated position.

Anti-chucking cancellation mechanism 60 generally includes an anti-chucking cancellation lever, referred to hereafter as cancellation lever 92, and a cancellation lever spring shown schematically at 94 (FIG. 4A). Cancellation lever 92 is pivotably supported, such as on ratchet rivet 68, for movement between a disengaged position, also referred to as rest position, and an engaged position, also referred to as holding position. Cancellation lever 92 has an actuator arm, also referred to as driven arm 96, configured for selective engagement with drive arm 88 of cinch lever 82 and a blocking arm 98 configured for selective engagement with anti-chucking lever 76. Cancellation lever spring 94 is operable to normally bias cancellation lever 92 counterclockwise (as viewed in FIG. 4) toward the disengaged position.

Latch release mechanism 62 is shown to generally include a release lever 100 and a release lever spring 102. Release lever 100 is pivotably mounted on a release lever rivet 104 for movement between a non-actuated position and an actuated position. Release lever spring 102 is configured to normally bias release lever 100 toward its non-actuated position. Release cable 106 is adapted to be interconnected between a first lug segment 108 of release lever 100 and door handle 50 so as to permit release lever 100 to move from its non-actuated position to its actuated position in response to actuation of door handle 50.

Referring now to FIGS. 5-8A, a series of sequential views are provided to illustrate a cinching operation of closure latch assembly 48. In particular, FIGS. 5 and 5A show closure latch assembly 48 in a partially opened and partially closed state, anti-chucking mechanism 56 in a released, disengaged position, cinch lever 82 in a pre-travel state, whereat actuation of a cinch actuator (not shown) is initiated to start to pivot cinch lever 82, cancellation lever 92 is in the rest or disengaged position, and latch release mechanism 62 in a non-actuated state. Specifically, ratchet 64 is shown in its secondary striker capture position (striker mounted to rear door 28 is not shown), pawl 66 is shown (FIG. 4B) held in its secondary locked position via engagement of a pawl latch lug 110 with a secondary latch shoulder 112 formed on ratchet 64, anti-chuck lever 76 is shown held in its released position via engagement of a generally L or hook-shaped lever lug segment 114 formed on anti-chuck lever 76 with a first elongated leg portion 116 of pawl 66. The aforementioned states/positions are caused via movement of front door 22 from its open position toward its closed position, whereupon striker (not shown) is caused to enter a fishmouth segment of a latch housing frame plate (not shown) and engage a guide channel 118 formed in ratchet 64, thereby forcibly pivoting ratchet 64 in a closing (i.e., counterclockwise as viewed in FIG. 4B) direction from its striker release position toward its primary striker capture position in opposition to the biasing of ratchet spring 70. Such action causes pawl latch lug 110 to continue to ride along a first ratchet cam surface 120 on ratchet 64 so as to continue to hold pawl 66 in its ratchet releasing position. As noted, when pawl 66 is held in its ratchet releasing position, anti-chuck lever 76 is retained and held in its released position via engagement of lever lug segment 114 with elongated leg portion 116 of pawl 66.

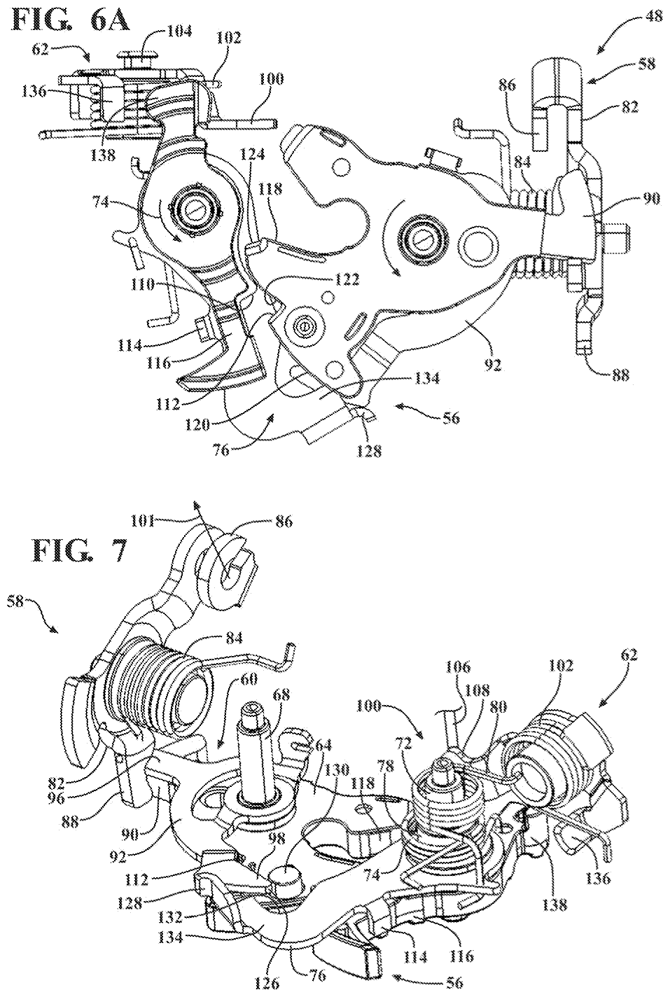

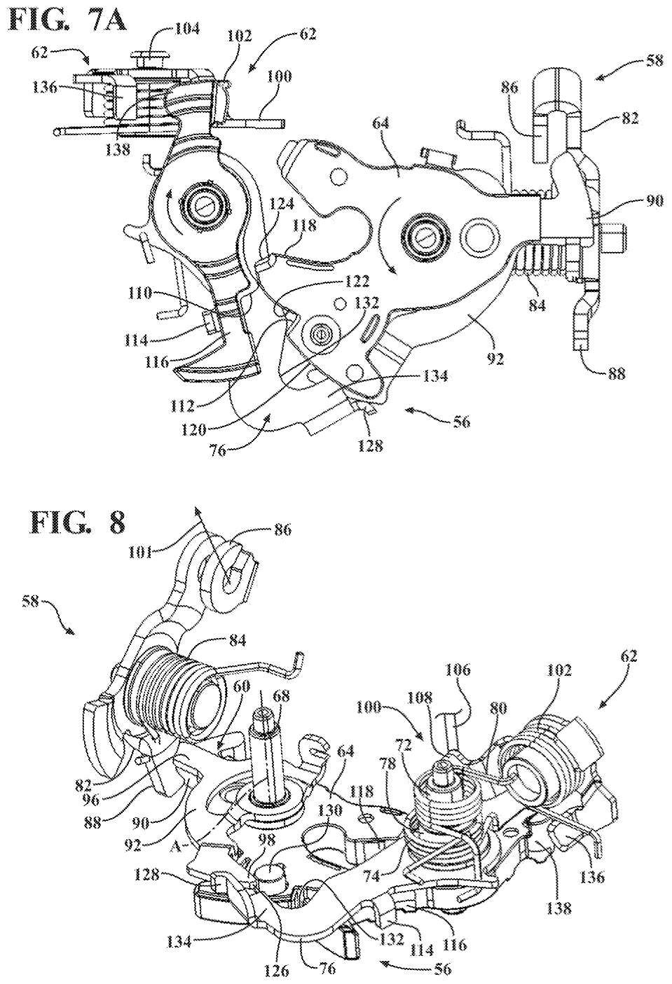

Referring next to FIG. 6, continued actuation and rotation of the cinch lever 82 causes continued rotation of ratchet 64 in the closing direction from the secondary striker capture position toward the over-travel position, whereupon pawl latch lug 110 rides along a second ratchet cam surface 122 formed on ratchet 64, whereat drive arm 88 of cinch lever 82 initiates engagement with actuator arm 96 of cancellation lever 92 (shown in rest, disengaged position in FIG. 6). Then, as cinch lever 82 continues to rotate, drive arm 88 pushes actuator arm 96 and pivots cancellation lever 92 against the bias of cancellation lever spring 94 to a holding or engaged position, also referred to as the blocking position (FIG. 7). In the blocking position, an abutment portion, also referred to as stop surface 126, of blocking arm 98 of cancellation lever 92 is brought into position to confront a projection 128 of anti-chuck lever 76 (projection 128 is shown extending laterally outwardly from a generally planar surface of anti-chuck lever 76) to obstruct movement of anti-chuck lever 76 under the bias of anti-chuck lever spring 80. As such, anti-chuck lever 76 is temporarily restrained against movement to its engaged position. As a result, as shown in FIG. 8, ratchet 64 moves past its primary striker capture position into its striker over-travel position, such as due to front door 22 being moved to its fully closed (i.e., a “hard slam”) position. This rotation of ratchet 64 to its striker over-travel position permits pawl spring 74 to forcibly move pawl 66 into its ratchet holding position relative to ratchet 64. However, such over-travel of ratchet 64 does not result in completed latching engagement between pawl latch lug 110 and a primary latch shoulder 124. FIG. 9 illustrates subsequent slight rotation of ratchet 64 in a releasing (i.e. counterclockwise) direction caused by ratchet spring 70 which, in turn, causes pawl latch lug 110 to engage primary latch shoulder 124 of ratchet 64, thereby causing pawl 66, while in its primary ratchet holding position, to hold ratchet 64 in its primary striker capture position. In this position, latch mechanism 54 is operating in its latched mode.

Thereafter, as shown in FIG. 10, cancellation lever 92 is caused to move back to its rest, disengaged position under the bias of cancellation lever spring 94, thereby allowing anti-chuck lever spring 80 to forcibly pivot anti-chuck lever 76 in the engaging direction until a raised stop feature, also referred to as anti-chucking pin, stop lug segment or simply stop lug 130, on ratchet 64 is retained in engagement against an anti-chuck latch shoulder 132 formed in generally hook-shaped end segment 134 of anti-chuck lever 76. This biased, confronting engagement between stop lug 130 and anti-chuck latch shoulder 132 establishes an engagement interface between ratchet 64 and anti-chuck lever 76. Thus, anti-chuck lever 76 is now located in its engaged position such that anti-chucking mechanism 56 is operating in its engaged mode, whereat ratchet 64 is prevented from pivoting from its primary striker capture position toward its striker over-travel position, thereby preventing the generation of chucking noise. To subsequently shift closure latch assembly 48 from its latched mode into its unlatched mode, release cable 106 pulls on release lever 100 for causing release lever 100 to move from its non-actuated position into its actuated position. Such pivotal movement of release lever 100 causes in a tab segment 136 on release lever 100 to engage a second leg portion 138 of pawl 66, wherein second leg portion 138 is located on an opposite side of pawl rivet 72 from first leg portion 116, for causing pawl 66 to forcibly move from its ratchet holding position into its ratchet releasing position, thereby permitting ratchet 64 to rotate from its primary striker capture position (FIG. 10A) back to its striker release position. As is understood, a power actuator, such as an electric motor and gearset, could be used to pivot release lever 100 from its non-actuated position into its actuated position to provide a power latch release feature. As pawl 66 rotates toward its ratchet releasing position, a drive surface of first elongate leg portion 116 engages lever lug segment 114 of anti-chuck lever 76 to pivot anti-chuck lever 76 to its released position. Anti-chuck lever 76 remains positioned in its released position as long as ratchet 64 remains in positions other than its primary striker capture position, due to engagement of lever lug segment 114 with elongate leg portion 116 of pawl 66, thereby allowing cancellation lever 92 to pivot to its engaged position, as discussed above, while a cinching operation is being performed to move ratchet 64 to its over-travel position while closing front door 22.

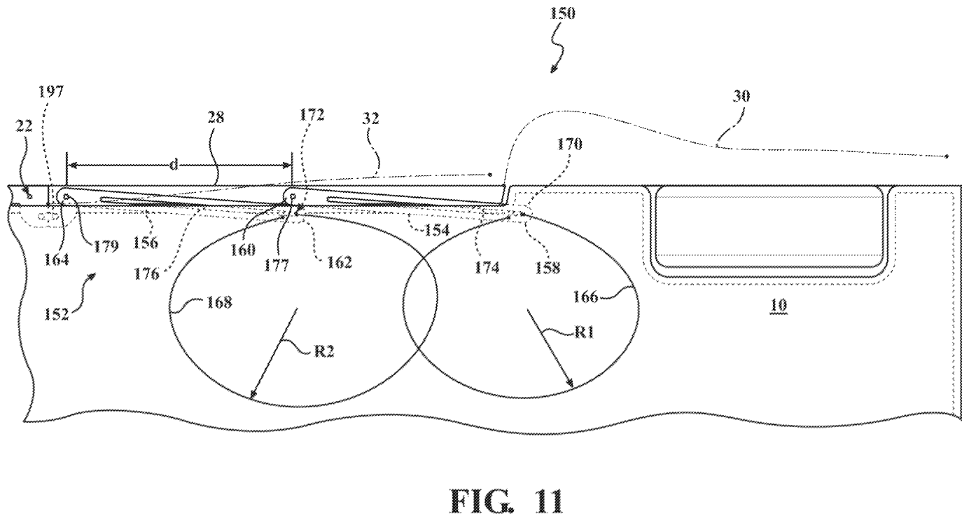

Rear door 28 is configured for powered movement such that the motion is minimally in a cross-vehicle direction (CVD) and substantially (meaning that the vast majority, but less than all) translational in a longitudinal vehicle direction (LVD: along a path extending lengthwise from the front to the back of the vehicle)(FIG. 1). To provide the direction of motion, as shown in FIG. 11, a door linkage system 150 for guiding rear door 28 of motor vehicle 11 between the open position and the closed position relative to a vehicle body 12 is provided. The door linkage system 150 provides for a guided control of the door to maintain the door closer to the vehicle body as compared to pivoting or swinging type doors in a path having an arc of travel, allowing the vehicle to be stationed closer to adjacent objects, such as an adjacently parked car, which could interfere with the door as it is swung to the door open position in an arc of travel. The door linkage system 150 includes a multi bar linkage having at least one linkage 152 connecting the rear door 28 to the vehicle body 10. The linkage 152 is configured to extend outwardly from (in a cross-vehicle direction) and retract inwardly into (in a cross-vehicle direction) the vehicle body 10 as the rear door 28 moves between a closed position and an open position. By extending outwardly, the rearward portion 30 of rear door 28 is able to move in a clearance relation with adjacent surfaces of vehicle body 10 as the rear door 28 moves from the closed position toward the open position, and by extending inwardly, the distance the rear door 28 extends outwardly in the cross-vehicle direction CVD is kept to a minimum, thereby resulting in a low profile (minimum cross-vehicle directional movement) of rear door 28 relative to vehicle body 10 during movement of the rear door 28 between the closed and open positions.

The linkage 152 of door linkage system 150, in a non-limiting embodiment, includes an elongate first bar, also referred to as first link 154, and an elongate second bar, also referred to as second link 156. The first link 154 has a first link proximal end 158 coupled to the vehicle body 10 and a first link distal end 160 coupled to the rear door 28. The second link 156 has a second link proximal end 162 coupled to the vehicle body 10 and a second link distal end 164 coupled to the rear door 28. At least one of the first link proximal end 158 and the second link proximal end 162 are configured to move along a curved path, and by way of example, both the first link proximal end 158 and the second link proximal end 162 are illustrated as being configured to move along respective first and second non-straight, curved paths 166, 168, wherein curved paths 166, 168 are shown as being generally annular (ring-shaped).

The first and second non-straight, curved paths 166, 168, although being non-straight, curved paths, can have linearly straight sections, though including non-straight, arcuate (curved) sections. Accordingly, from beginning to end of each first and second path 166, 168, the first and second path 166, 168 is not a linearly straight line, thereby resulting in the mostly translational, with minimal cross-vehicle movement of door 28 while moving from the closed position to the open position, and while returning from the open position to the closed position.

In accordance with an aspect of the disclosure, the first and second non-straight, curved paths 166, 168 can be formed as being substantially annular paths (meaning nearly entirely, but possibly not forming a circumferentially continuous ring) or entirely as annular paths. The annular first and second paths 166, 168 can be formed as having geometrically different shapes from one another, or the same shapes as one another, as desired, to facilitate guiding the rear door 28 over the desired, low profile path. For example, the first and second paths 166, 168 can be provided having different lengths (sizes and travel distance from start to end) and/or geometric shapes, such that the first path 166 can be formed having a first geometric shape and/or sections having a first radius of curvature, while the second path 168 can be formed having a second geometric shape and/or sections having a second radius of curvature, wherein the first geometric shape can be different from the second geometric shape and/or the first radius of curvature can be different from the second radius of curvature over corresponding regions of movement of first and second links 154, 156. Accordingly, as first link proximal end 158 is moving a first region of first path 166, and second link proximal end 162 is concurrently moving a second region of second path 168, the corresponding movements can be different as a result of the first and second regions having different geometries from one another. It is to be recognized that if both the first and second geometric shapes are the same, the respective lengths can be different as a result of having different radii of curvature. Further, the lineal distance (length) of the first and second paths 166, 168 can be the same, though the first and second geometric shapes can be different.

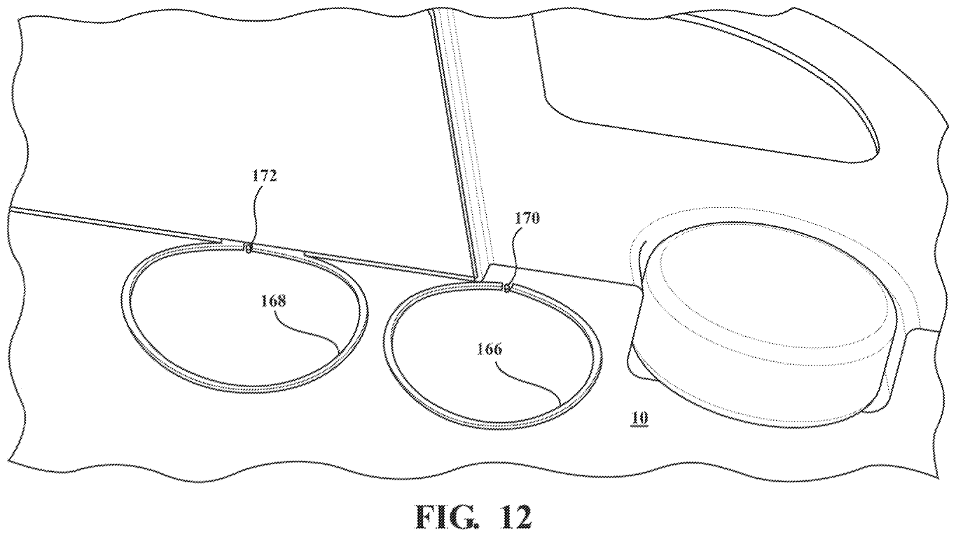

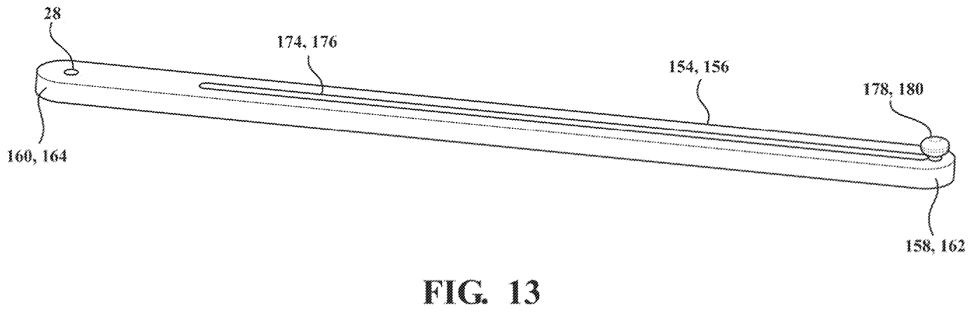

As shown in FIGS. 11 and 12, at least one of the first and second paths 166, 168 can be provided having one or more regions of a non-constant radius of curvature, wherein the entirety of at least one of the first and second paths 166, 168 can have a non-constant radius of curvature, if desired. In a presently preferred embodiment, both the first and second paths 166, 168 are shown having respective non-constant radii of curvature R1, R2. Further, geometric shapes of the first and second paths 166, 168 are different from one another, and thus, as the first link 154 and second link 156 are driven about their respective first and second paths 166, 168, the spacial orientation of the first link 154 relative to the second link 156 changes, thereby facilitating the desired motion of rearward portion 30 and forward portion 32 of rear door 28 as door 28 is moved from the closed position to the open position, and then back from the open position to the closed position. The desired motion is provided via the first curved path 166 being configured to move the rearward portion 30 of the rear door 28 in a substantially cross-vehicle direction, or “CVD”, also referred to as the Y-direction, of motor vehicle 11 while the second curved path 168 is configured to concurrently move the forward portion 32 of the rear door 28 in a substantially longitudinal vehicle direction LVD of motor vehicle 11. Accordingly, during an initial opening and closing portion of the movement of door 28, the rearward portion 30 of the rear door 28 moves substantially in the cross-vehicle direction CVD, while at the same time, the forward portion 32 of the rear door 28 moves substantially in the longitudinal vehicle direction LVD.

To facilitate guiding the rear door 28 along a precise, predetermined path, a first guide member 170 can be fixed to the vehicle body 10 and a second guide member 172 can be fixed to the vehicle body 10, with the first link 154 being configured to pivot about the first guide member 170 while the first link proximal end 158 moves along the first curved path 166, and with the second link 156 being configured to pivot about the second guide member 172 while the second link proximal end 162 moves along the second curved path 168. The first and second guide members 170, 172 can be provided as fixed male or female members for pivotal receipt of corresponding male or female members, and are shown as male members, such as first and second pins 170, 172 fixed to vehicle body 10. First and second pins 170, 172 are configured to protrude in fixed relation from vehicle body 10 for sliding receipt within respective female sections, such as first and second elongate tracks, also referred to as slots 174, 176, formed in first link 154 and second link 156, respectively. First elongate slot 174 extends between first link proximal end 158 and first link distal end 160, shown as extending from immediately adjacent first link proximal end 158 toward first link distal end 160. Second elongate slot 176 extends between second link proximal end 162 and second link distal end 164, shown as extending from immediately adjacent second link proximal end 162 toward second link distal end 164.

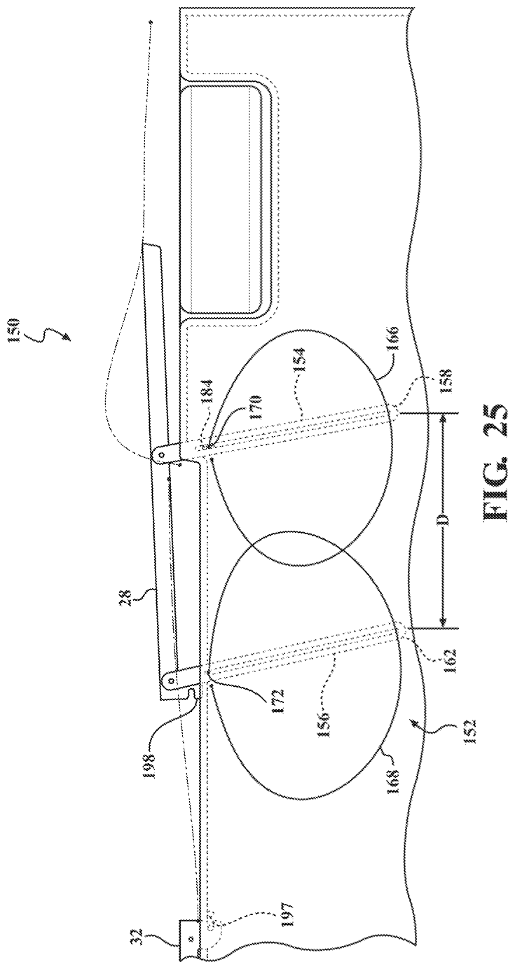

First link distal end 160 and second link distal end 164 are fixed via a pivot connection for pivotal movement relative to the rear door 28. In an example embodiment, the pivot connection of first link distal end 160 and second link distal end 164 can be provided via first and second pins 177, 179 pivotably fixed to rear door 28 and with first and second links 154, 156 for pivotal movement of first and second links 154, 156 about an axis of first and second pins 177, 179. As such, with first and second link distal ends 160, 164 being fixed to rear door 28 for pivotal movement therewith, first link distal end 160 and second link distal end 164 remain spaced from one another over a fixed distance (d)(FIG. 11) as the rear door 28 moves between the open and closed positions. This is unlike first link proximal end 158 and second link proximal end 162, which, as discussed above, move generally toward one another and away from one another as the rear door 28 moves between the closed and open positions due to the differently shaped and/or sized first and second paths 166, 168, as discussed above. Accordingly, a distance (D)(FIG. 25) extending between the first link proximal end 158 and the second link proximal end 162 varies (increases and decreases), at least during portion of movement as the rear door 28 moves between the open and closed positions.

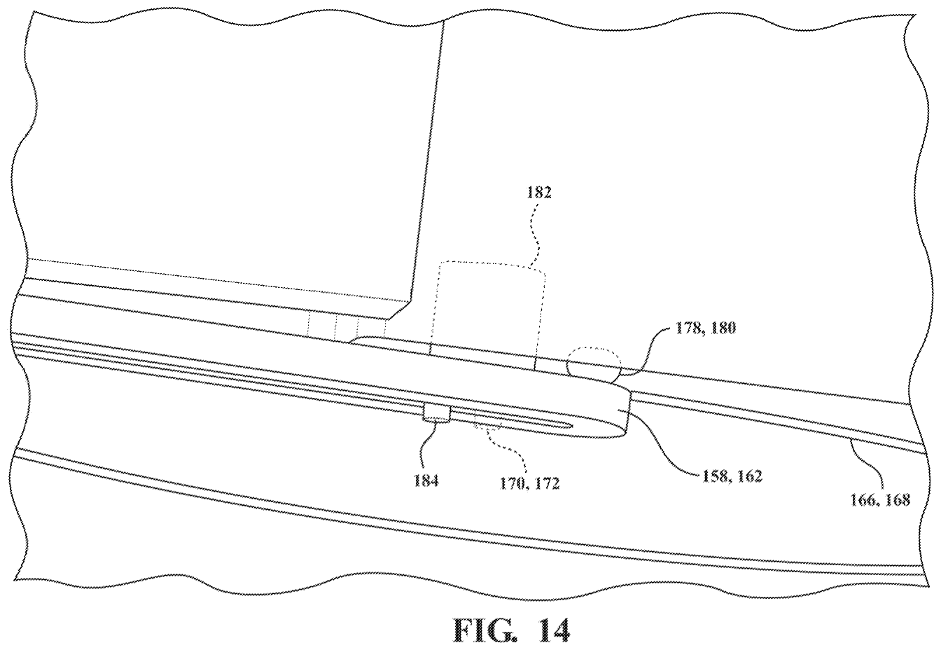

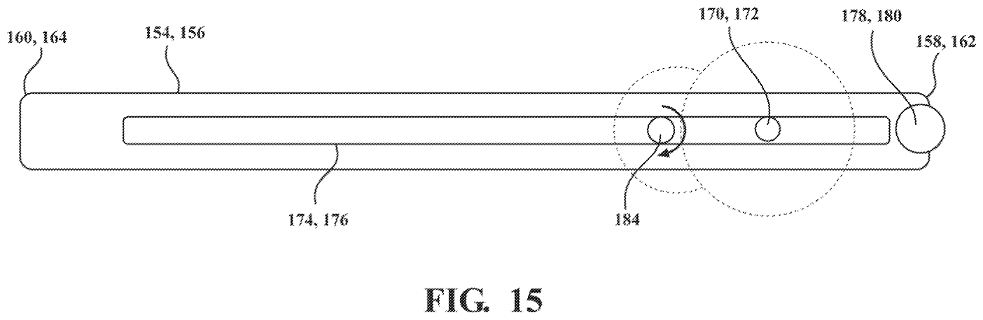

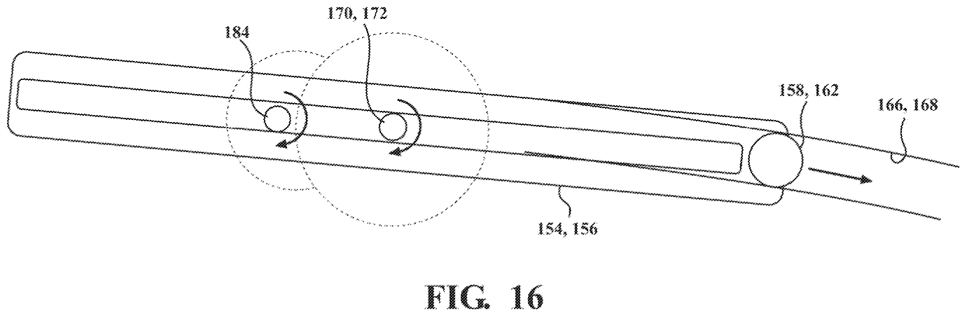

To facilitate smooth, low friction, precision guided movement of first and second link proximal ends 158, 162, as best shown in FIGS. 14-16, the first link proximal end 158 can have a first guide roller, referred to hereafter as first roller 178, fixed thereto for rolling receipt and engagement along first curved path 166 and second link proximal end 162 can have a second guide roller, referred to hereafter as second roller 180, fixed thereto for rolling receipt and engagement along second curved path 168. First curved path 166 can be defined by a first recessed channel in a member of vehicle body 10 configured for receipt of first roller 178 therein for rolling movement therealong and the second curved path 168 can be defined by a second recessed channel in a member of vehicle body 10 configured for receipt of second roller 180 therein for rolling movement therealong. Accordingly, first and second rollers 178, 180 follow first recessed channel 166 and second recessed channel 168, respectively, to facilitate controlling the smooth, low friction pivotal movement of linkage 152. The first recessed channel 166 and the second recessed channel 168 can be formed on an underside or in an internal pocket adjacent the underside of motor vehicle 11. Regardless of location, the first recessed channel 166 and the second recessed channel 168 can be shielded from debris and contamination.

An actuator, such as an electric motor, referred to hereafter as motor 182 (FIG. 14), is configured to drive a drive member 184, such as a driven wheel or gear, also referred to as pinion gear, with the drive member 184 being configured to directly drive one of the first link proximal end 158 along the first curved path 166 or the second link proximal end 162 along the second curved path 168, with the other of the first link proximal end 158 or second link proximal end 162 being indirectly driven along the first or second curved path 166, 168. Accordingly, only one of the first or second link 154, 156 needs to be directly driven by the single motor 182, while the other of the first or second link 154, 156 is indirectly driven without need to be directly driving by a secondary motor. The single motor 182 is operable to move door 28 from the closed position to the open position via rotating drive member 184 in a first direction, and then to move door 28 from the open position to the closed position via rotating drive member 184 in a second direction opposite the first direction. Drive member 184 is disposed in one of the first or second elongate slots 174, 176 to directly drive the associated one of the first link proximal end 158 along the first curved path 166 or the second link proximal end 162 along the second curved path 168. The other of the first link proximal end 158 or the second link proximal end 162 not directly driven by drive member 184 is indirectly driven along the associated first or second elongate slots 174, 176 by drive member 184 via a four bar link chain reaction.

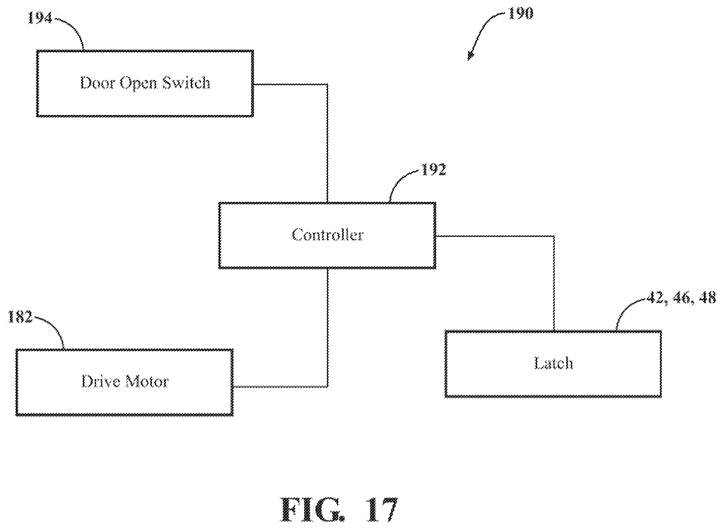

In FIG. 17, a flow diagram of an actuation system 190 for actuating motor 182 is shown. Actuation system 190 includes a controller 192 configured in operable communication with: latch assembly 42, 46, 48; a door open switch 194; and motor 182. As controller 192 receives a signal from door open switch 194, controller 192 signals latch assembly 42, 46, 48 to move from a latched state to an unlatched state and signals motor 182 to become actuated to move drive member 184 in the first or second direction to move door 28 in a corresponding first or second direction between its closed and open positions.

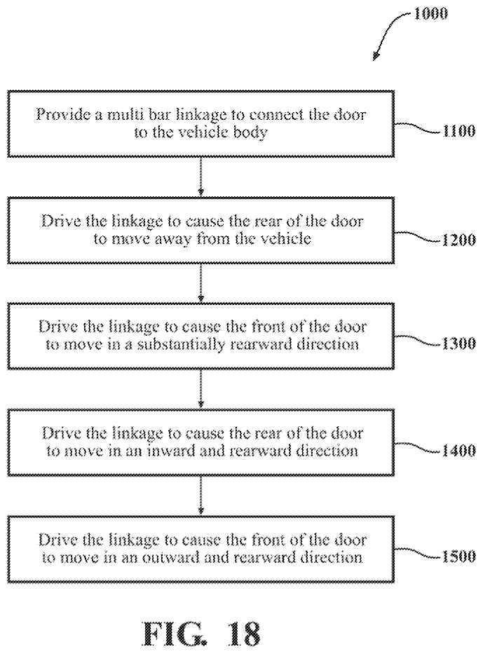

In FIG. 18, a method 1000 of opening a rear door 28 of a motor vehicle 11 is shown. The method 1000 includes a step 1100 of providing a linkage 152 having a multiple links, also referred to as a multi-bar linkage, including a first link 154 and a second link 156, with the linkage 152 connecting the rear door 28 to a vehicle body 10 of motor vehicle 11. The method further includes a step 1200 of driving the linkage 152 to cause a rearward portion (rear) 30 of the rear door 28 to move away from the vehicle body 10 in a cross-vehicle direction CVD and, concurrently with step 1200, a step 1300 of driving the linkage 152 to cause a forward portion (front) 32 of the rear door 28 to move in a substantially rearward, lengthwise vehicle direction LVD (LVD is transverse to CVD, and LVD may also be referred to as the X-direction). Then, after steps 1200 and 1300, a step 1400 of continuing to drive the linkage 152 to cause the rearward portion 30 of the rear door 28 to move inward in the cross-vehicle direction CVD toward the vehicle body 10 and concurrently in the rearward, lengthwise vehicle direction LVD. Further, a step 1500 includes driving the linkage 152 to cause the forward portion 32 of the rear door 28 to move outward in the cross-vehicle direction CVD and concurrently in a rearward lengthwise vehicle direction LVD until door 28 reaches the open position. It is to be recognized that the aforementioned steps can then be reversed to move door 28 from the open position to the closed position.

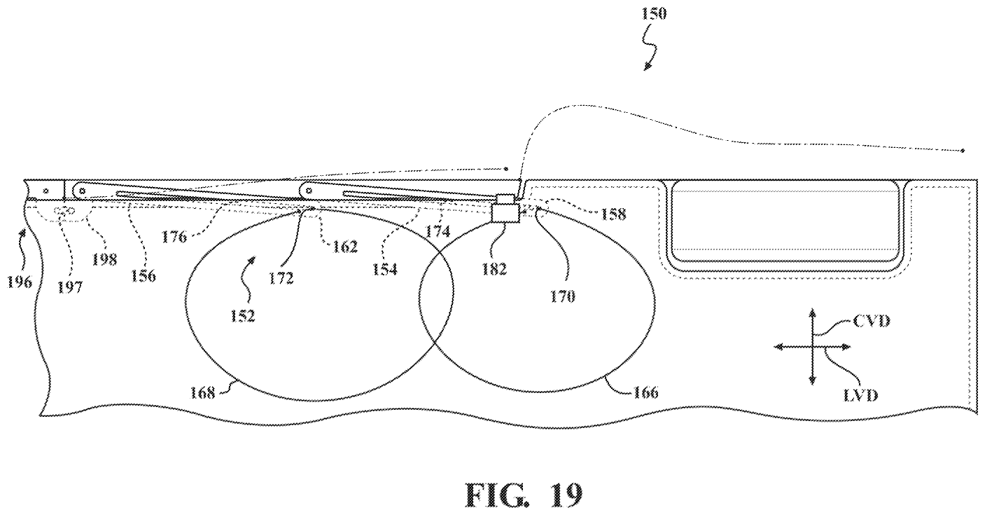

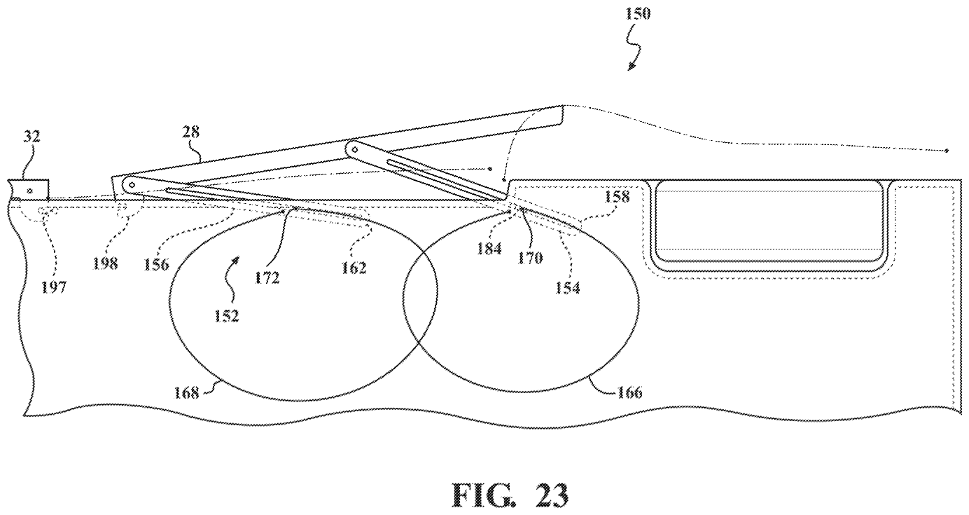

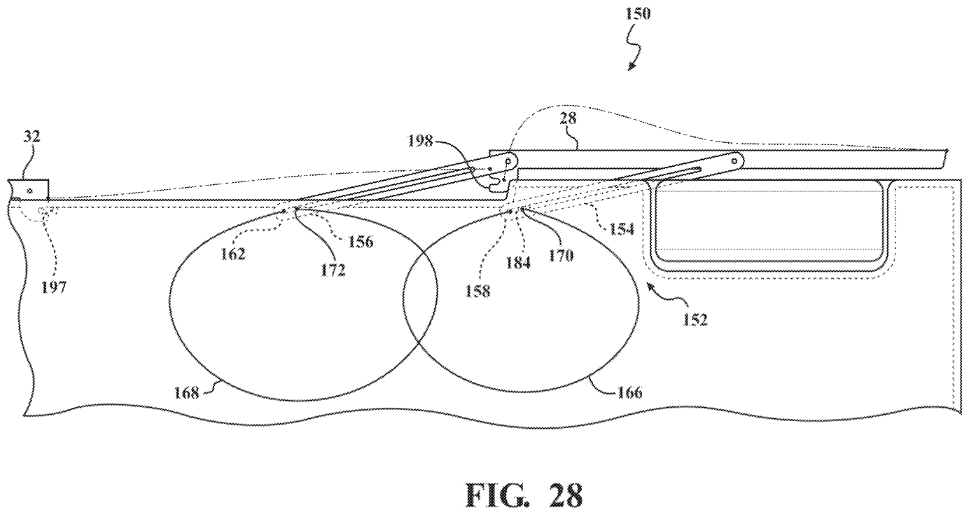

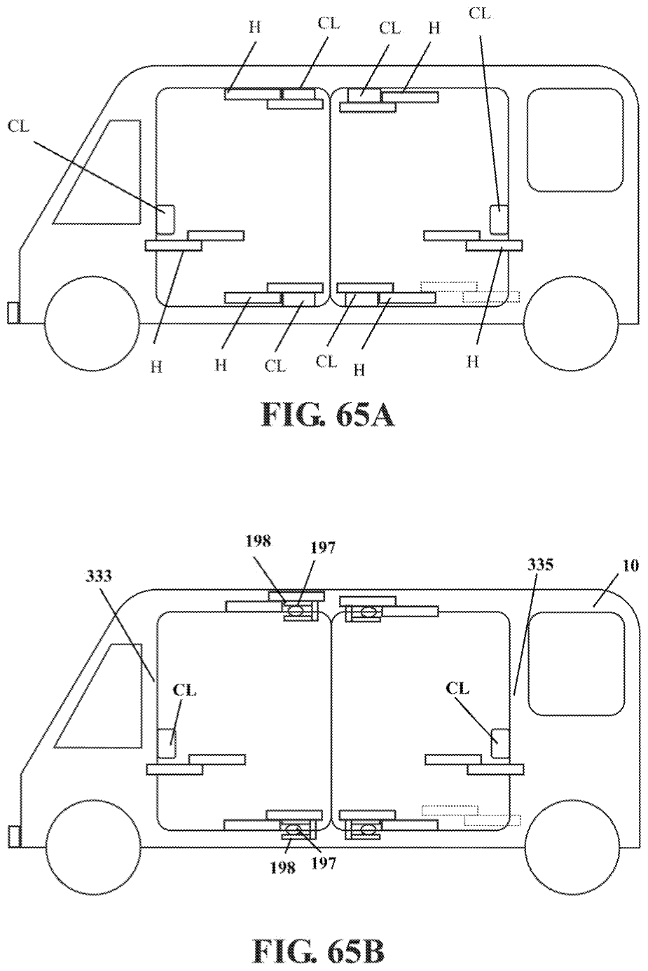

FIGS. 19-28 illustrate a door opening sequence, wherein rear door 28 is moved from the closed position (FIG. 19) to the open position (FIG. 28). In FIG. 19, latch assembly 42, 46, 48 is in the latched state, wherein latch assembly 42, 46, 48 can be located at the rearward portion 30 of rear door 28, by way of example and without limitation. To facilitate locating and releasably locking the forward portion 32 of rear door 28 relative to vehicle body 10, a front latching arrangement, illustratively shown as a pinned connection via a pin and catch assembly 196, can be provided. Front latching arrangement is shown for releasably securing the front (forward portion 32) of the door 28 to the vehicle body 10. Front latching arrangement 196 can be configured for releasably securing the front of the door 28 to rearward portion 26 of front door 22. Pin and catch assembly 196 can include a pin 197 fixed to one of rear door 28 and the vehicle body 10, shown as the vehicle body 10, and a receptacle, also referred to as catch 198, fixed to the other of the rear door 28 and the vehicle body 10, shown as the rear door 28. Pin 197 is sized and located for close fitting receipt within a pocket, also referred to as recess or cavity, of catch 198 to prevent relative movement of rear door 28 in the cross-vehicle direction CVD when received therein. Pin 197 may include a flared distal end for preventing the pin from being retracted through the catch, for example though a slot of the catch during a crash condition of the vehicle. A pin 197 and catch 198 configuration may also be provided at an opposite upper portion of the door and upper frame portion of the vehicle, such as shown in FIG. 65B. Such pin 197 and catch 198 configurations may provide for correction in any sag in the door during their engagement to ensure the seal 36 is properly established when the door is in the fully closed position. Motion of the door substantially in an X-direction after moving away from its fully closed position or during its final motions towards the fully closed position may provide engagement of the pin 197 with the catch 198. For example the catch 198 may be provided with a slot that hinders extraction of the pin 197 in a Y-direction when the door is in the fully closed position, the pin 197 having been moved further into the slot during the substantially X-direction motion. Slot may be angled so as to provide a y-directional component for moving the door closed towards the body during a final stage of door closing operation, thereby providing a cinching without the need for a powered latch configuration. As shown in FIG. 65B, the upper and lower pin 197 and catch 198 configurations may provide for latching of the front of the door to the vehicle body, while a rear latch, such as a cinching latch (CL) may provide for a latching and optionally a latching and cinching function of the door to a A-pillar 333 or C-pillar 335 of the vehicle body 10.

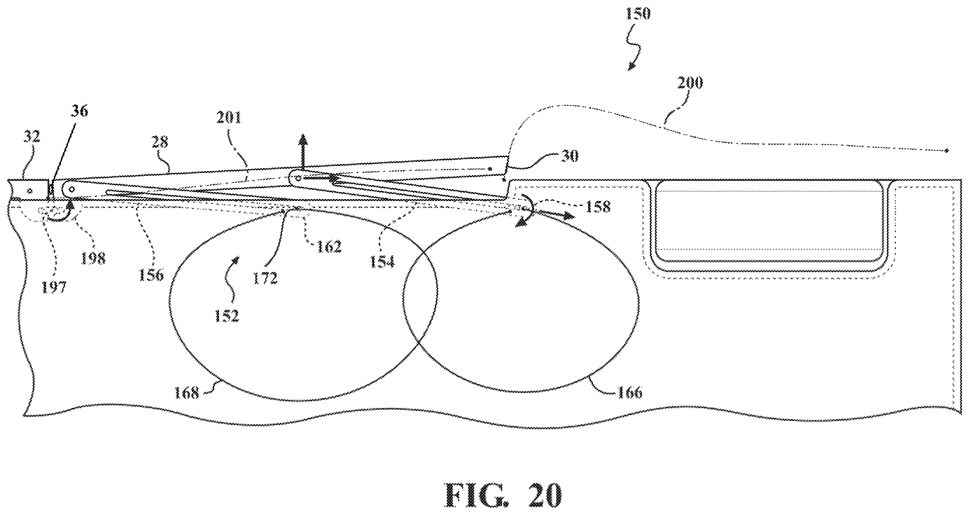

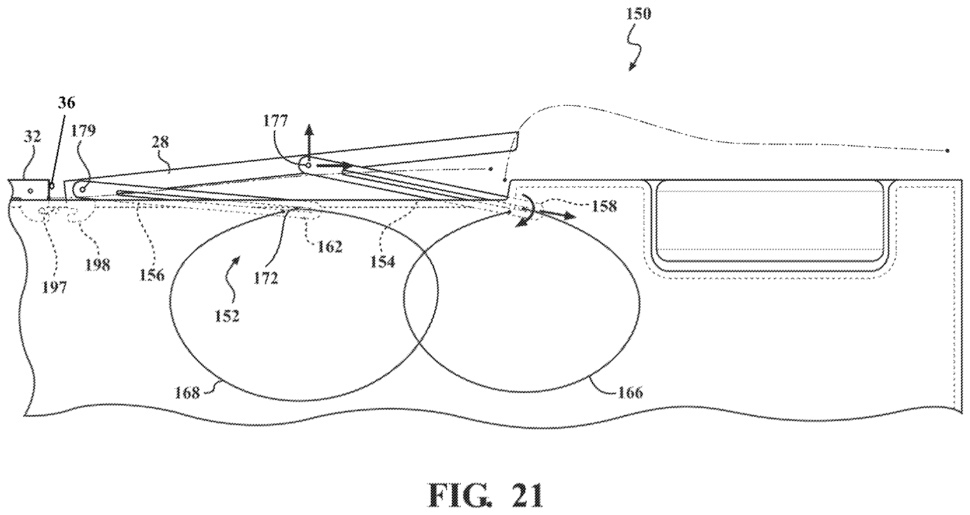

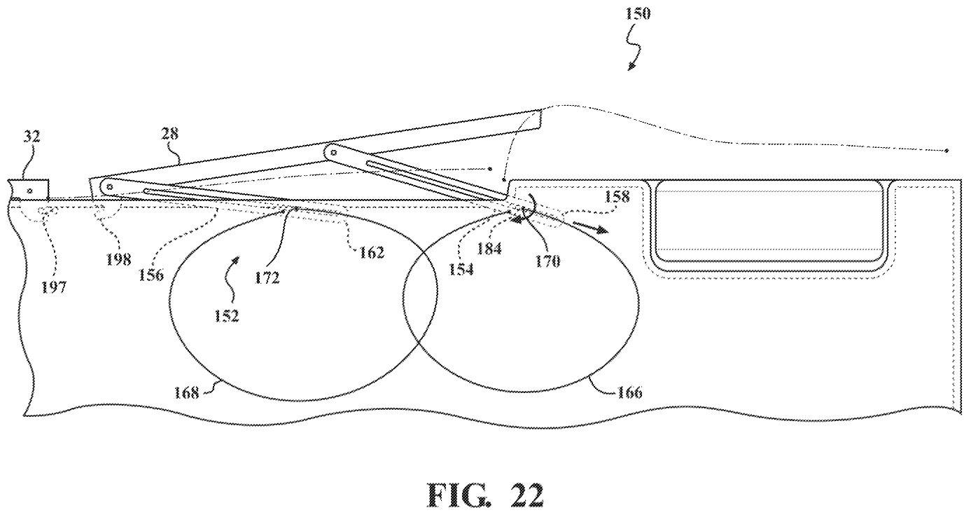

In FIG. 20, a door open command is sent to controller 192, such as from door open switch 194, which can originate from an interior/exterior door handle, interior/exterior button, key fob, or the like. Controller 192 then signals latch assembly 48 to move to the unlatched state and while also signaling motor 182 to become actuated (energized/powered). Motor 182, being actuated, rotates drive member 184 in a first direction to directly drive first link proximal end 158 of first link 154 to follow first curved path 166. With first link 154 being directly driven, second link distal end 164 is indirectly driven via being pulled via the pinned connection to rear door 28, whereupon second link proximal end 162 is caused to traverse along second curved path 168. It is to be recognized that as first and second links 154, 156 are driven, each is caused to pivot about axes of respective fixed first guide member 170 and fixed second guide member 172. The full path of movement of rearward portion 30 of rear door 28 from the closed position to the open position is shown at first path, also referred to as rear path 200 of FIG. 20, and the full path of movement of forward portion 32 of rear door 28 from the closed position to the open position is shown at second path, also referred to as front path 201 of FIG. 20. As shown, rear path 200 and front path 201 have different contours as needed to provide the movement desired to minimize cross-vehicle movement of door 28 as door 28 moves between the closed and open positions in clearance relation with vehicle body 10. The initial movement of rear door 28 from the closed position to toward the open position is shown in FIGS. 20-23, wherein the rearward portion 30 of rear door 28 is initially caused to move substantially (mostly) in the cross-vehicle direction CVD, away from vehicle body 10, along rear path 200 and the forward portion 32 of rear door 28 is concurrently and initially caused to move substantially (mostly) in the lengthwise vehicle direction LVD toward a rear of vehicle 11 along front path 201, though the forward portion 32 is caused to move slightly (relative to the movement of rearward portion 30) in the cross-vehicle direction CVD, away from vehicle body 10. It is to be understood that the movement of rearward portion 30 of rear door 28 along rear path 200 and forward portion 32 of rear door 28 along front path 201 is determined by respective movement of first link proximal end 158 along first curved path 166 and pivoting of first link 154 about first guide member 170, and second link proximal end 162 along second curved path 168 and pivoting of second link 156 about second guide member 172. Accordingly, the precise path along which rearward and forward portions 30, 32 traverse can be precisely controlled via the size and shape of first and second curved paths 166, 168 in combination with the positioning of first and second guide members 170, 172. Links 154, 156 are shown to swing within the vehicle body 10. Accordingly, links 154, 156 are illustratively shown to swing inwardly towards the center of the vehicle 11 when moving between positions shown in FIG. 22 to FIG. 25, and thereby minimizing the movement of door 28 outwardly from vehicle body 10. First and second links 154, 156 are shown as configured to be driven position differently from one another while the door 28 is moving during an initial stage of opening in a cross-vehicle direction towards the opened position as seen in FIG. 20, which may also correspond to a final closing stage of the door 28 substantially in a cross-vehicle direction towards the closed position. As shown in FIG. 20, to provide an initial outward “pop out” of the rear of the door 28 while, the first, frontal link 154 may be rotated about its axis of rotation at a slower rate of rotation compared to the second, rear link 156, to cause the front of the door to be driven having a greater rearwards X direction motion component compared an outwards Y direction motion component. As shown in FIG. 20 and FIG. 21, the front of the door 28 has a controlled motion substantially in an X-direction during an initial opening phase (or final closing) stage of the door 28. Motion of the door substantially in an X-direction after moving away from its fully closed position or during its final motions towards the fully closed position may provide an engagement and/or disengagement of the door 28 against the seal 36 that is also in the X-direction which would tend to cause expansion of the seal 36 against the door 32, as opposed to an engagement of the door 28 causing the seal 36 to be disengaged from the door 32, for example due to a Y-direction engagement. As shown in FIG. 21 the slower rate of rotation of first, frontal link 154, compared to second, rear link 156 can be shown by an angle change or distance change between a first longitudinal axis AA of the first, frontal link 154, and a second longitudinal axis BB of the second, rear link 156. For example, the angle between the intersection 199 as seen in FIG. 21 of the first longitudinal axis AA and second longitudinal axis BB may change as the door is opened (or closed). Thus the first, frontal link 154, and to second, rear link 156 may adopt non-parallel and changing orientations from one another during door motion to control the motion of the front portion of the door 28 differently than the motion of the rear portion of the door 28.

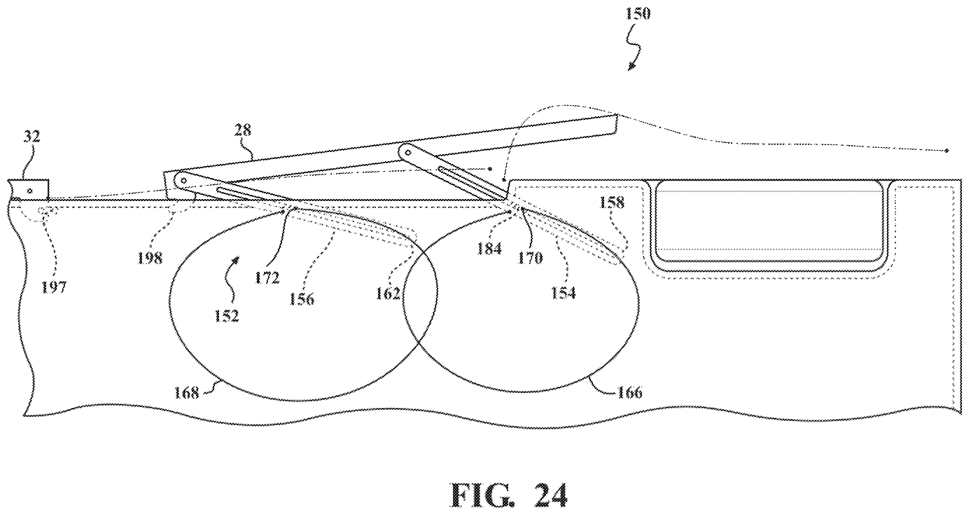

Continued movement of rear door 28, after the initial movement in the outward cross-vehicle direction CVD, and toward the open position, is shown in FIGS. 24-25, wherein the rearward portion 30 of rear door 28 is caused to move substantially (mostly) in an inward cross-vehicle direction CVD, toward vehicle body 10, along rear path 200 and the forward portion 32 of rear door 28 is concurrently caused to move substantially (mostly) in the lengthwise vehicle direction LVD toward a rear of vehicle 11 along front path 201, though the forward portion 32 is caused to continue to move slightly and gradually in the outward cross-vehicle direction CVD, away from vehicle body 10 only to an extent needed to avoid contact with vehicle body 10. With the rearward portion 30 moving back toward the vehicle body 10, in the inward cross-vehicle direction CVD, and the forward portion 32 continuing to move slightly in the outward cross-vehicle direction CVD outwardly from the vehicle body 10, the rear door 28 is approaching a generally parallel relation with a side of vehicle body 10 in close, minimum clearance relation therefrom. As can be seen in FIG. 24, the first and second links 154, 156 are skewed in non-parallel relation relative to one another, while in FIG. 25, the first and second links 154, 156 are generally parallel with one another, with both approaching a transverse relation with vehicle body 10. The change in spacial relation from one another from being skewed to being generally parallel results from the shapes of the first and second curved paths 166, 168 being different from one another. As the rearward portion 30 of door 28 is drawn in the inward cross-vehicle direction into closer relation with vehicle body 10, a shortened pivot axis of the second link 156 with the vehicle body 10 causes the forward portion 32 of door 28 to move in an outward cross-vehicle direction as second link 156 is pivoted about second guide member 172 by a large curvature region of second curved path 168. As such, door 28 is brought into a closer approximation of parallel relation with vehicle body 10. Further, in FIG. 25, drive member 184 has reached an end of first slot 174 of first link 154, and thus, as motor 182 continues rotating drive member 184 in the first direction, drive member 184 causes direct rotation of first link 154 and indirect rotation of second link 156 until first and second links 154, 156 are oriented in generally transverse relation with vehicle body 10.

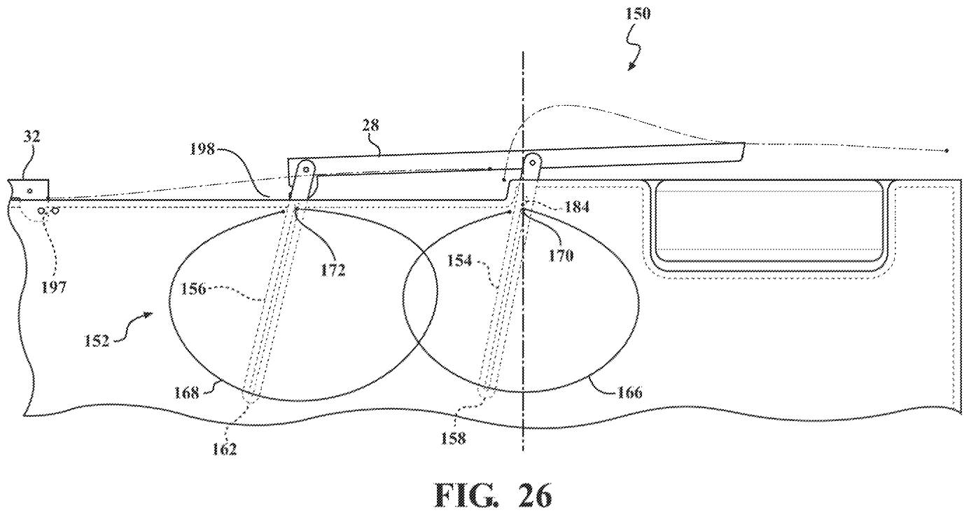

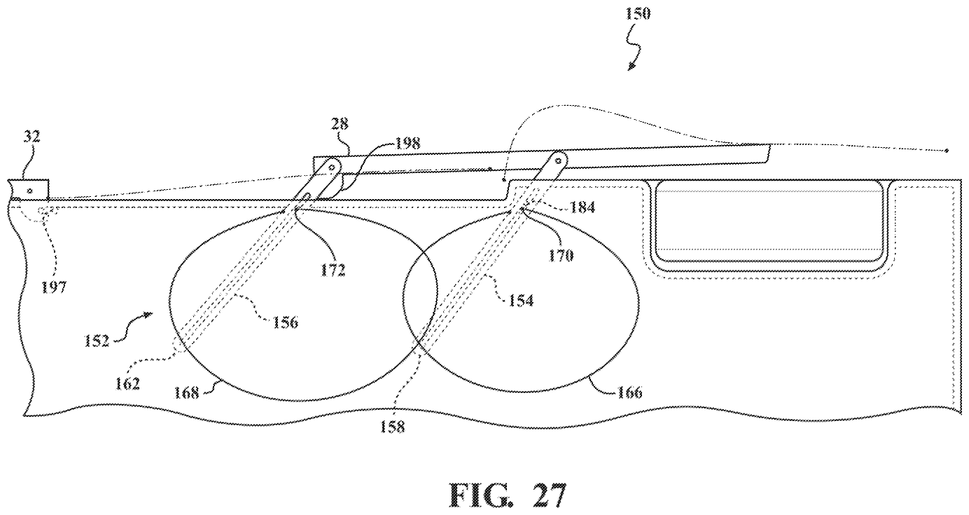

Upon being oriented in generally transverse relation with vehicle body, as indicated by an inflection line (IL), a sensor signals controller 192 to reverse the direction of rotation of motor 182 in a second direction, thereby causing drive member 184 to rotate in second direction (FIG. 26). As drive member 184 rotates in second direction, rather than linkage 152 pulling door 28, linkage 152 begins to push door 20 toward the fully open positon, with first and second links 154, 156 continuing to drive the rear door 28 rearwards toward the open position. As shown in FIG. 27, continued rotation of drive member 184 in the second direction causes forward portion 32 of rear door 28 to continue to move slightly outward from vehicle body 10 in the cross-vehicle direction CVD to avoid hitting vehicle body 10 and substantially (mostly) rearwardly in the lengthwise vehicle direction LVD via second link 156 pivoting and extending in guided relation via second roller 180 being guided in second path 168, while rear portion 30 is driven substantially (mostly) rearwardly in the lengthwise vehicle direction LVD and slightly inwardly toward the vehicle body 10 in the cross-vehicle direction CVD until rear door 28 reaches the open position (FIG. 28). When reaching the open position, the drive member 184 can be detected by sensor as having reached an end of first slot 174, whereupon sensor can signal controller 192 to de-energize motor 182.

Accordingly, as discussed above, motor 182 rotates the drive member 184 in a first direction to drive the one of the first link proximal end 158 along a first portion of the first curved path 166 until the first link 154 becomes oriented in generally transverse relation with vehicle body 10 (FIGS. 20-25), and then motor 182 reverses its rotational direction and rotates drive member 184 in a second direction to drive first link proximal end 158 along a second portion of first curved path 166 until rear door 28 reaches its fully open position (FIGS. 26-28).

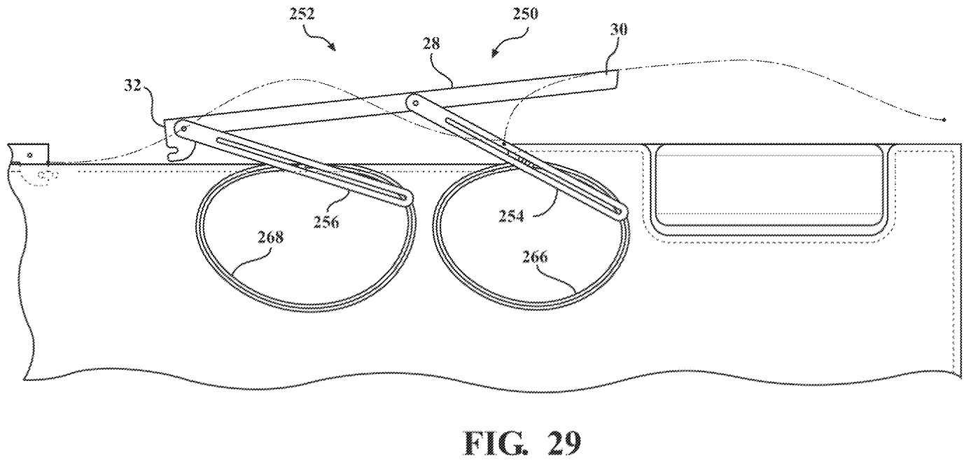

In FIG. 29, an example embodiment of another non-limiting configuration of a door linkage system 250 for guiding rear door 28 of motor vehicle 11 between the open position and the closed position relative to vehicle body 12 is illustrated. Door linkage system 250 has a multi bar linkage 252 and pre-defined first and second curved paths 266, 268 configured to provide the direction of motion desired for rear door 28 while moving from the closed position to the open position, and then back to the closed position. In this embodiment, the first curved path 266, along which a proximal end of a first link 254 traverses, as discussed above for first link proximal end 158, is shown having a smaller circumference and/or maximum diameter relative to the second curved path 268, along which a proximal end of a second link 256 traverses, as discussed above for second link proximal end 162, thereby resulting in movement of the front portion 32 of rear door 28 in both an outwardly cross-vehicle direction CVD (also referred to as positive [+]CVD) and an inwardly cross-vehicle direction CVD (also referred to as negative [−]CVD). It is to be understood that FIG. 29 illustrates merely one of any number of alternate paths the rearward and forward portions 30, 32 of rear door 28 can be designed to follow, and that the desired path of the rearward and forward portions 30, 32 can be finely tuned to follow any path desired by customizing the shapes and/or relative sizes of the first and second curved paths.

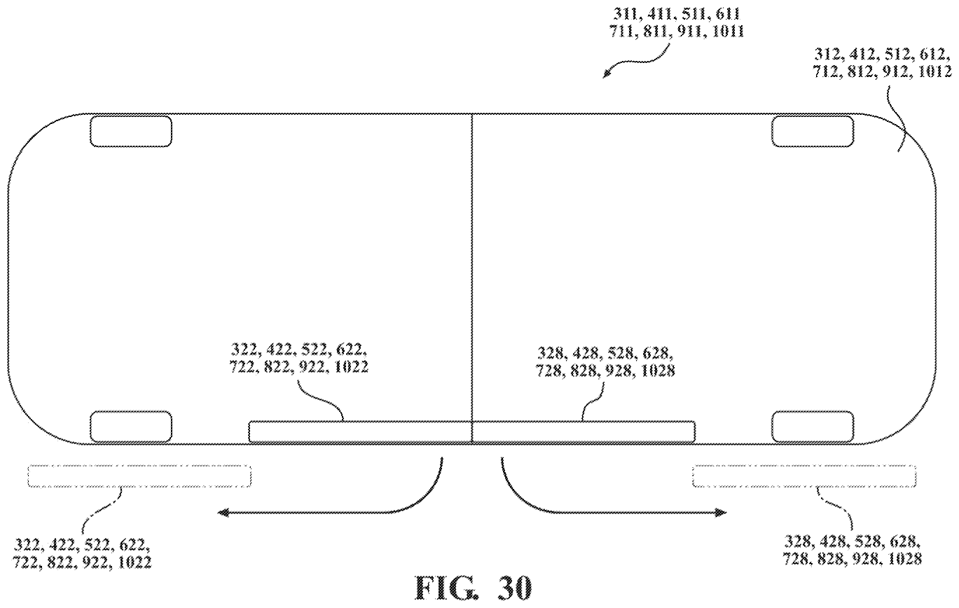

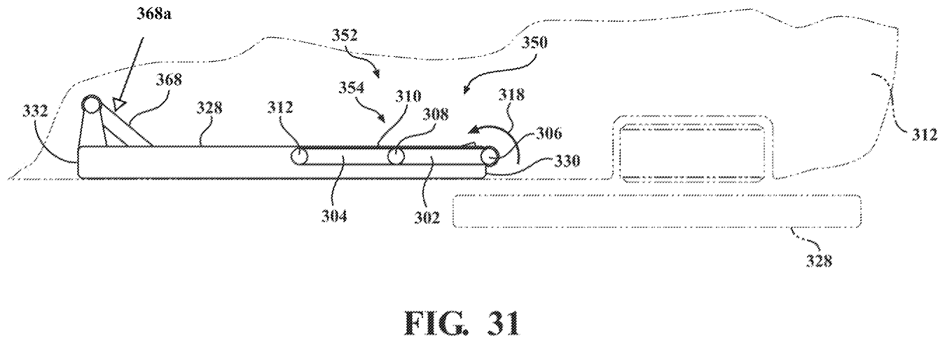

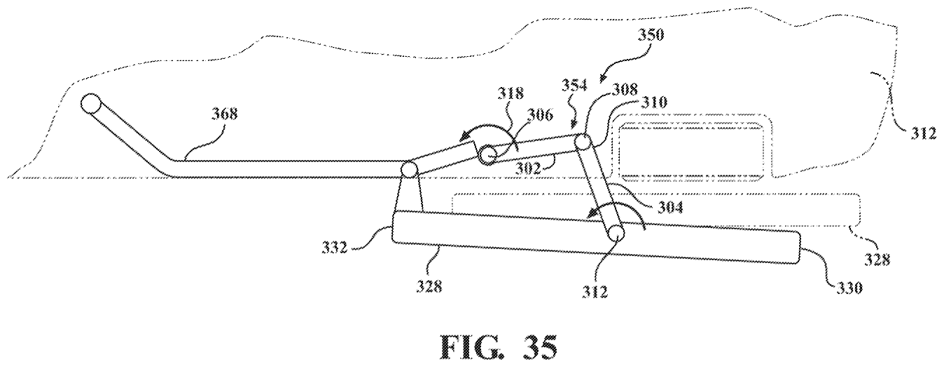

In FIGS. 31-36, an example embodiment of another configuration of a door linkage system 350 for guiding a front and/or rear door 322, 328 (FIG. 30) of motor vehicle 311 between a closed position and an open position relative to vehicle body 312 is illustrated, wherein the same reference numerals as used above, offset by a factor of 300, are used to identify like features.

Door linkage system 350 includes a multi bar linkage 352 including a first link assembly, also referred to as first link 354 pivotably connecting front and/or rear door 322, 328 to vehicle body 312. First link 354 includes a first hinge arm, also referred to as first arm 302, and a second hinge arm, also referred to as second arm 304. First arm 302 has first proximal end 306 pivotably connected to vehicle body 312, and a first distal end 308 pivotably connected to second arm 304. Second arm 304 has a second proximal end 310 pivotably connected to first distal end 308 of first arm 302 and a second distal end 312′ pivotably connected to front and/or rear door 322, 328, shown as rear door 328. To facilitate movement of rear door 328 between the open and closed positions, a first motor 314 is disposed in the vehicle body 312 for operable driving communication with first arm 302, and a second motor 316 is disposed in the rear door 328 for operable driving communication with second arm 304.

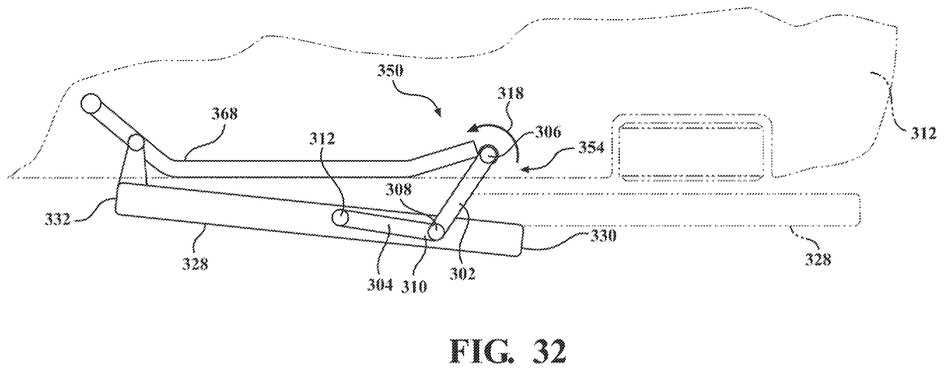

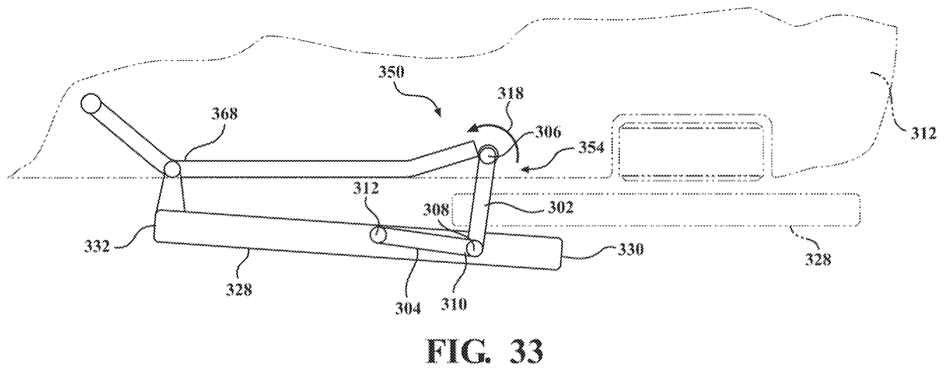

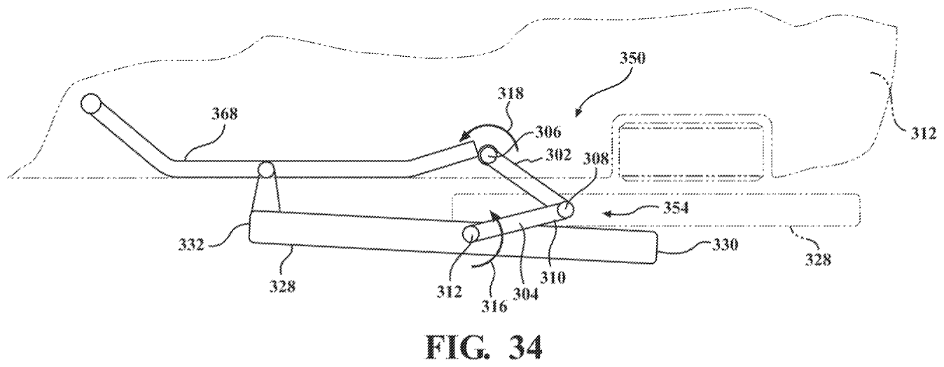

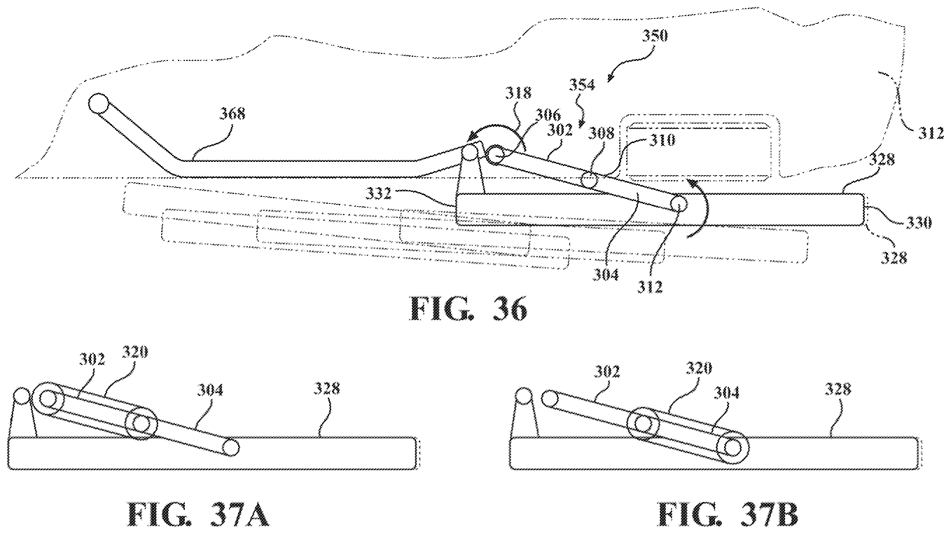

In operation, when desired to move rear door 328 (it is to be recognized that the same applies to any closure panel, including front door 322, if desired) from the closed position to the open position, first motor 314 is energized, such as via any operable signal device, including a key fob, activation button, door handle, or otherwise, thereby causing first motor 314 to drive first arm 302 in an opening direction 318, shown as being counterclockwise (CCW) in FIGS. 31-35. As first motor 314 operably drives first arm 302, wherein the operable driving can be via a direct or indirect driving communication between a drive gear connected to an output shaft of first motor 314 and a driven surface or member fixed to first arm 302, by way of example and without limitation, first arm 302 is caused to rotate CCW about a pivot axis adjacent first proximal end 306 of first arm 302. With first arm 302 being rotatably driven CCW, first distal end 308 of first arm 302, pivotably connected to second proximal end 310 of second arm 304, pulls second arm 304 rearwardly toward a rear end of motor vehicle 311. During this initial stage of opening movement of rear door 328, a rearward portion 330 of rear door 328 is caused to move substantially outwardly from vehicle body 312 in a cross-vehicle direction, while a forward portion 332 of rear door 328 is caused to move substantially rearwardly along a lengthwise direction of motor vehicle 311. The movement of forward portion 332 of rear door 328 can be precisely guided by a track or path 368 in vehicle body 312, with a follower fixed to forward portion 332 of rear door 328, such as a guide pin and/or roller 380, being guided for low friction movement in or by path 368 (FIGS. 32-36). The front portion of track 368, referred to as 368a, may be configured to control the door motion so as to move initially substantially (mostly) in the lengthwise vehicle direction LVD toward a rear of vehicle 11 along front path 201. For example the slope of the track 368a may have an X-direction component greater than a Y-direction component such that the motion of front of the door is initially in a substantially X-direction. First motor 314 continues driving first arm 302 and rear door 328 until rear door 328 reaches a position of generally maximum outward cross-vehicle spaced relation from vehicle body 312 (FIG. 33), whereat first arm 302 and second arm 304 are perpendicular or substantially perpendicular to one another and first proximal end 306 of first arm 302 is at an end of travel within path 368. Then, second motor 316 is actuated (energized, such as can be controlled by a control unit of motor vehicle 311), with first motor 314 remaining energized, to begin driving second arm 304 in a counterclockwise direction (CCW) (FIGS. 34-36). As second arm 304 is driven CCW, first proximal end 306 of first arm 302 remains at an end of travel within path 368 due to continued energization of first motor 314, by way of example and without limitation. Accordingly, a push force on first distal end 308 of first arm 302 by second proximal end 310 of second arm 304 is generated, thus, causing second arm 304 to push rear door 328 toward the open position. Upon continued opening movement, second arm 304 becomes substantially aligned in collinear relation with first arm 302, whereat rear door 328 reaches its fully open position and first and second motors 314, 316 are de-energized (FIG. 36). Of course, it is to be recognized that to move the rear door 328 to the closed positon, the process can simply be reversed, as will be understood by one possessing ordinary skill in the art upon viewing the disclosure herein. Thus the motion of the front portion of the door 28 may be controlled differently than the motion of the rear portion of the door 28, to provide for example a substantially X-direction motion of the front of the door 28 during the initial state of opening, or final stage of closing.

In FIGS. 37A and 37B, alternate embodiments to the embodiment of FIGS. 31-36 are shown, wherein the first and second motors 314, 316 can be configured and positioned differently, as desired. In FIG. 37A, both first and second motors 314, 316 are shown located in vehicle body 312, whereupon power from the first and second motors 314, 316 can be transferred via belt(s) and/or chain(s) 320 to second arm 304, by way of example and without limitation. In FIG. 37B, both first and second motors 314, 316 are shown located in rear door 328, whereupon power from the first and second motors 314, 316 can be transferred via belt(s) and/or chain(s) 320 to first arm 302, by way of example and without limitation.

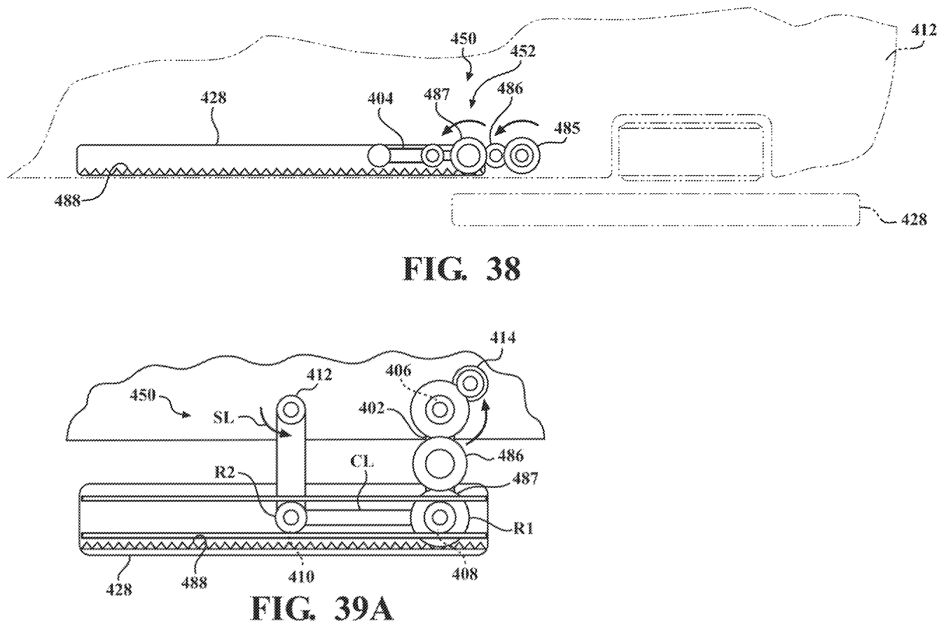

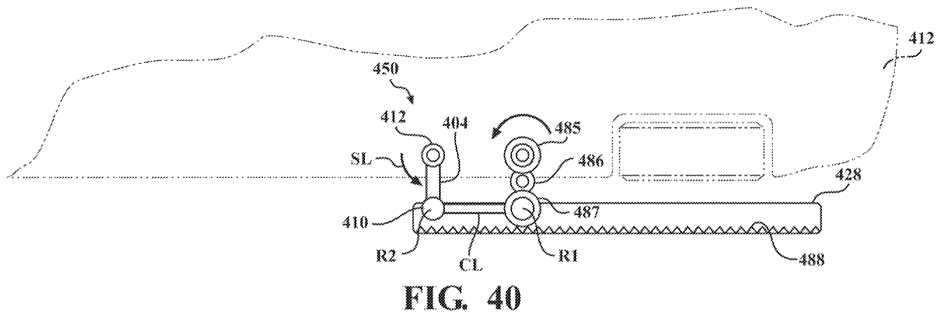

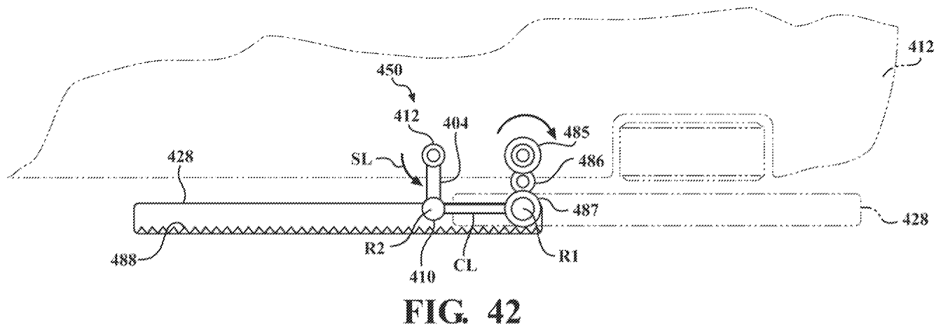

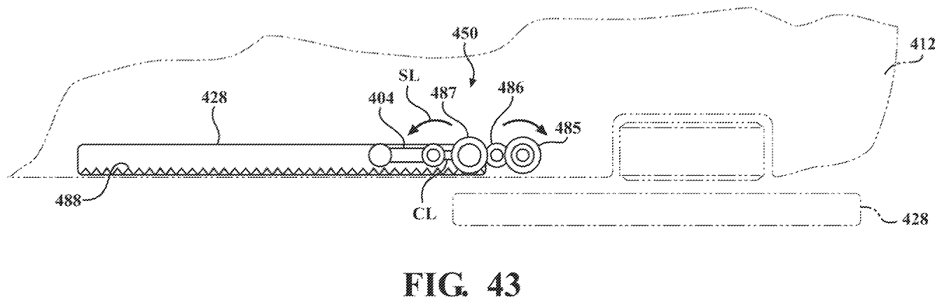

In FIGS. 38-43, an example embodiment of another configuration of a door linkage system 450 for guiding a front and/or rear door 422, 428 (FIG. 30) of motor vehicle 411 between an open position and a closed position relative to vehicle body 412 is illustrated, wherein the same reference numerals as used above, offset by a factor of 400, are used to identify like features.

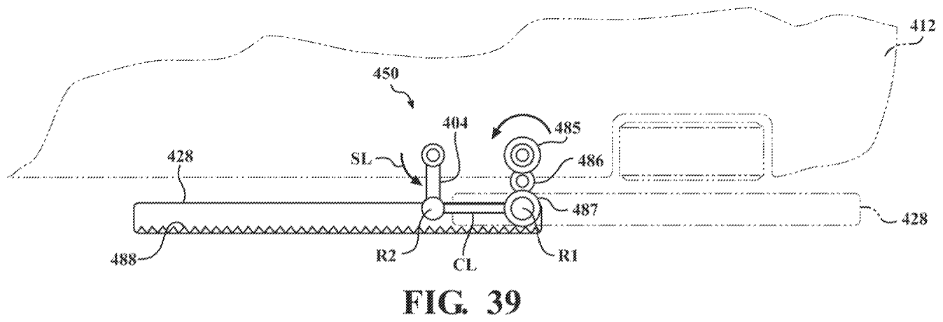

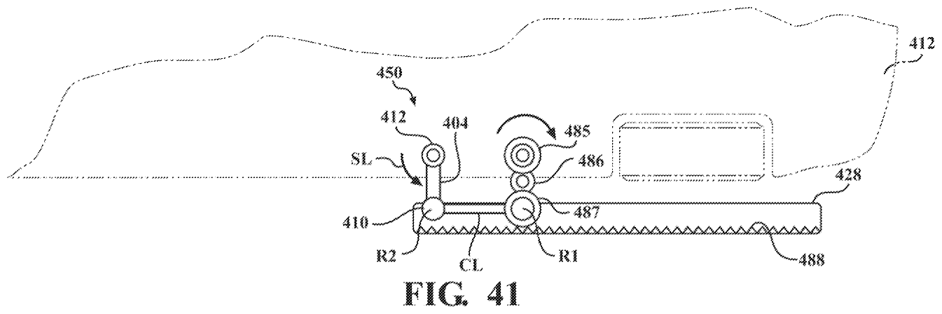

In FIGS. 38-40, a power door opening sequence is illustrated, while in FIGS. 41-43, a power door closing sequence is illustrated. In the door opening sequence, a multi bar linkage 452 of door linkage system 450 is driven via a motor 414 (FIG. 39A), which rotatably drives a drive member 484, such as a pinion gear, with drive member 484 being in meshed or otherwise driving engagement with a driven member 485, such as a driven gear. Driven member 485 is shown as being configured in operable driving communication with a drive pinion 487 of a rack-and-pinion type arrangement, wherein an idler member or gear 486 is shown in driven engagement with driven member 485 and in driving engagement with drive pinion 487. Drive pinion 487 is configured for driving engagement with a rack, such as a toothed rack 488, fixed to rear door 428, of rack-and-pinion type arrangement. Driven member 485, idler member 486 and pinion drive 487 can be rotatably supported by a first hinge arm 402 (FIG. 39A), wherein first hinge arm 402 has a first proximal end 406 pivotably coupled to vehicle body 412 and a first distal end 408 coupled to rear door 428. First hinge arm 402 is operably coupled to a second proximal end 410 of a second hinge arm 404 via an intermittent coupling link CL, wherein second proximal end 410 is pivotably coupled to rear door 428, and a second distal end 412′ of second hinge arm 404 is pivotably coupled to vehicle body 412. Drive pinion 487 and driven member 485 may be controlled in tandem to move the front of the door initially substantially (mostly) in the lengthwise vehicle direction LVD towards the rear of the vehicle. For example, drive pinion 487 may be initially controlled at a rate greater than driven member 485 such that door is initially driven having an X-direction component greater than a Y-direction component.

In an opening operation, motor 414 can be selectively energized, as discussed above for prior embodiments, whereupon drive member 484 rotatably drives driven member 485, which in turn rotatably drives idler member or gear 486, thereby rotatably driving drive pinion 487, thus causing rack 488, fixed to rear door 428, to be driven rearwardly and slightly outward in a cross-vehicle direction via being extended outwardly by the pivoting first and second hinge arms 402, 404. To facilitate smooth, low friction movement of rear door 428 between the closed and open position, rollers R1, R2 can be fixed for rotation adjacent first distal end 408 of first hinge arm 402 and second proximal end 410 of second hinge arm 404, wherein rollers R1, R2 can be configured to rolling receipt with a roller guide or track RT (FIG. 39A) of rear door 428. To further facilitate opening of rear door, a spring load SL can be applied via linkage system 450, shown as being applied on second hinge arm 404, by way of example and without limitation. Spring load SL, aside from assisting with the load from motor 414 to open rear door 428, further facilitates holding the rear door 428 in its open position until desired to return rear door 428 to the closed position, wherein spring load SL helps keep second hinge arm 104 out in an extended position against a stop.

In a closing operation (FIGS. 41-43), motor 414 can be selectively energized in a reversed direction, whereupon first and second hinge arms 402, 404 are driven against the spring load SL to their folded configuration, as will be readily understood by one possessing ordinary skill in the art upon viewing the disclosure herein.

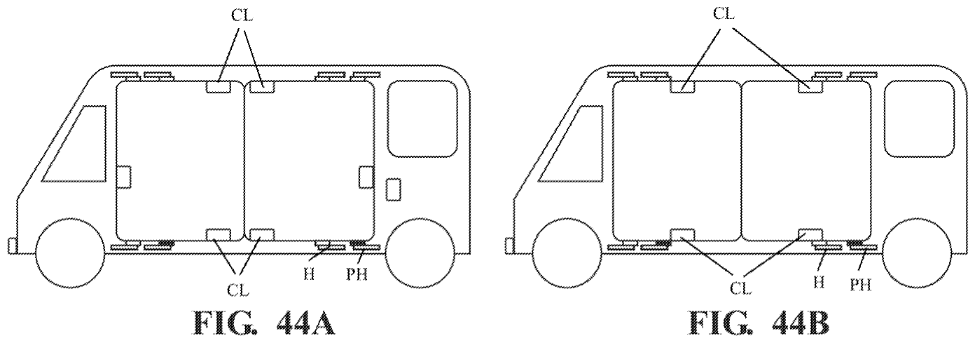

In FIGS. 44A and 44B, various latch, cinch, and hinge arrangements are illustrated, as desired for the intended application. The various arrangements illustrate latches, such as for example cinching latches (CL), hinges (H), and powered hinges (PH) that can be incorporated separately or in combination with one another, as will be readily understood by one possessing ordinary skill in the art upon viewing the disclosure herein. Illustrative power latch and power cinch arrangements are shown in US Patent Application Publication No. US2022/0120117A1 titled “Dual Function Latch Assembly and Retractable Striker and/or Retractable Ratchet Assembly for Dual Door Pillarless Door System and Method of Operation Thereof”, the entire contents of which are incorporated herein by reference.

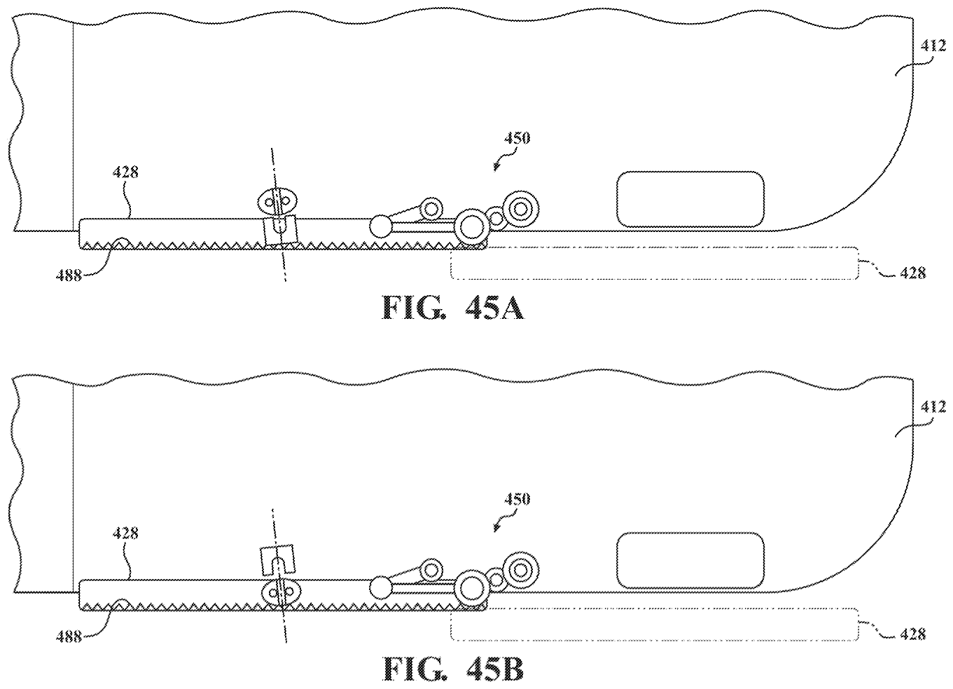

In FIGS. 45A and 45B, various latch and striker arrangements are illustrated, as desired for the intended application. The various arrangements illustrate power latch and power cinch arrangements that can be incorporated separately or in combination with one another, as will be readily understood by one possessing ordinary skill in the art upon viewing the disclosure herein.

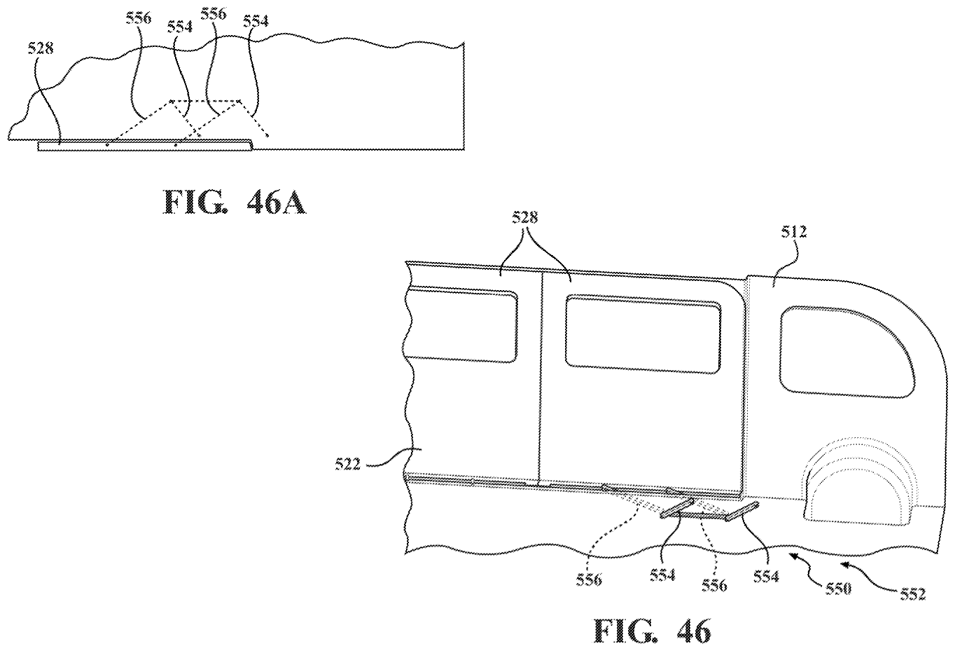

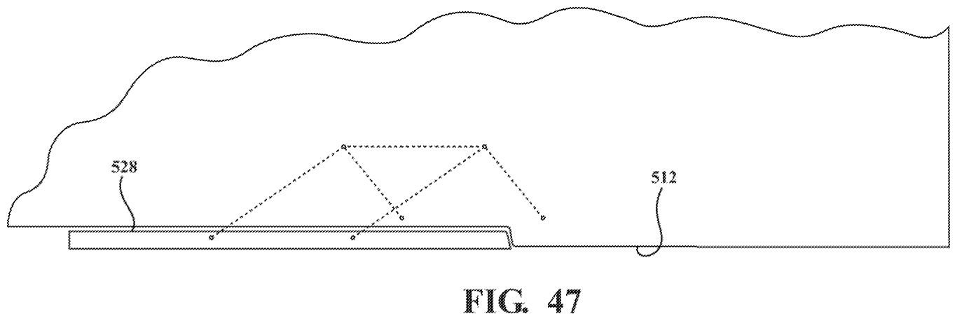

In FIG. 46, an example embodiment of another configuration of a door linkage system 550 for guiding a front and/or rear door 522, 528 (FIG. 30) of motor vehicle 511 between an open position (FIG. 46) and a closed position (FIG. 46A) relative to vehicle body 512 is illustrated, wherein the same reference numerals as used above, offset by a factor of 500, are used to identify like features.

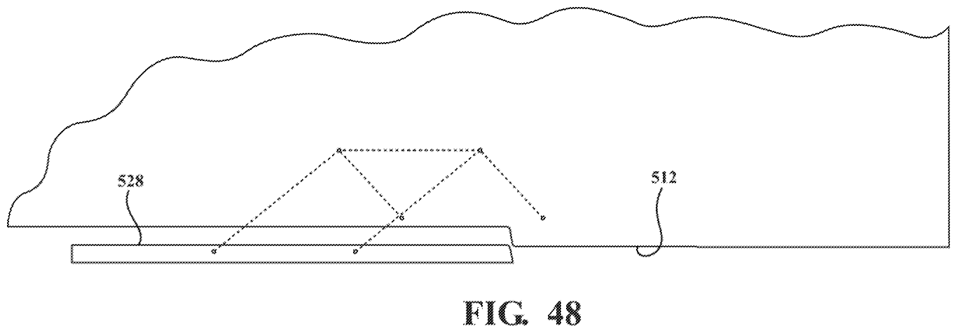

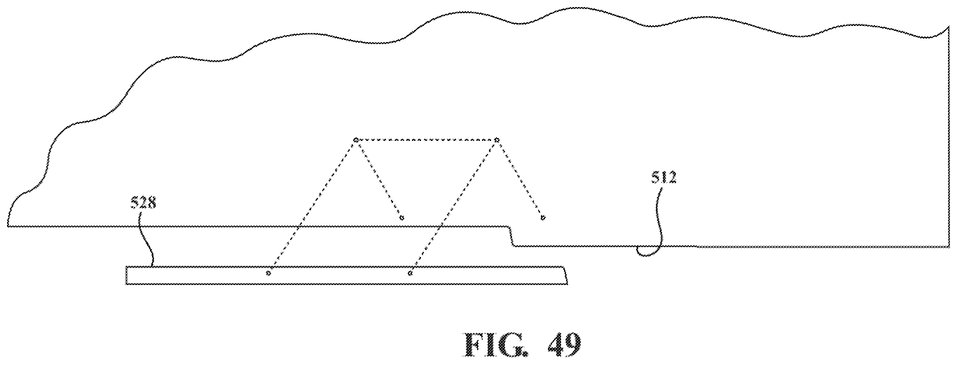

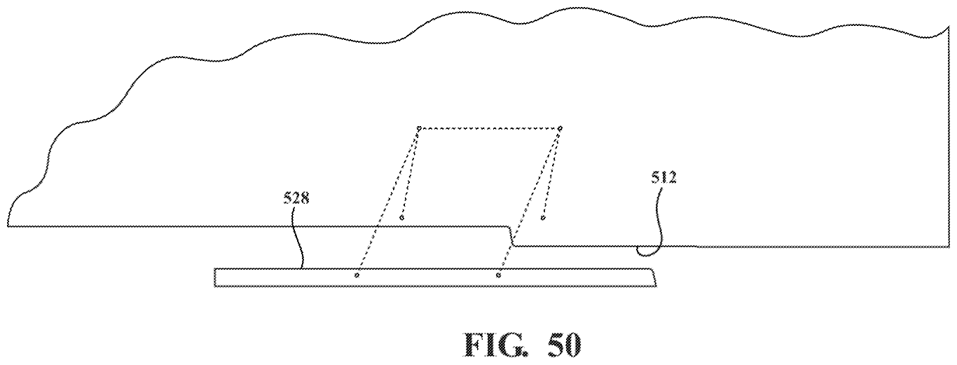

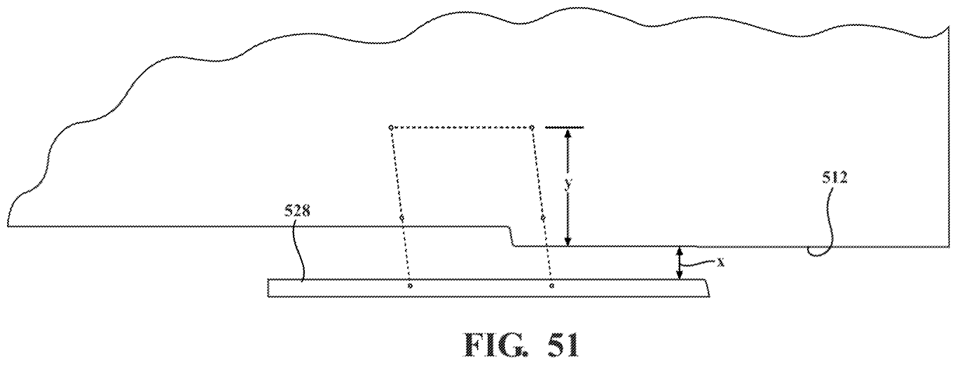

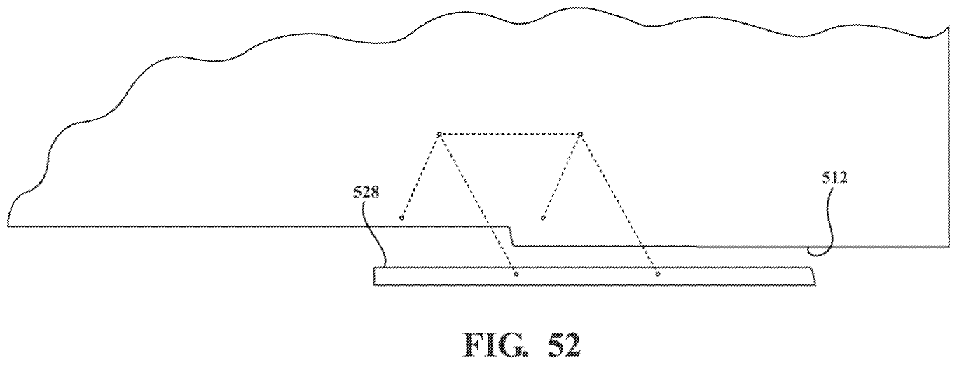

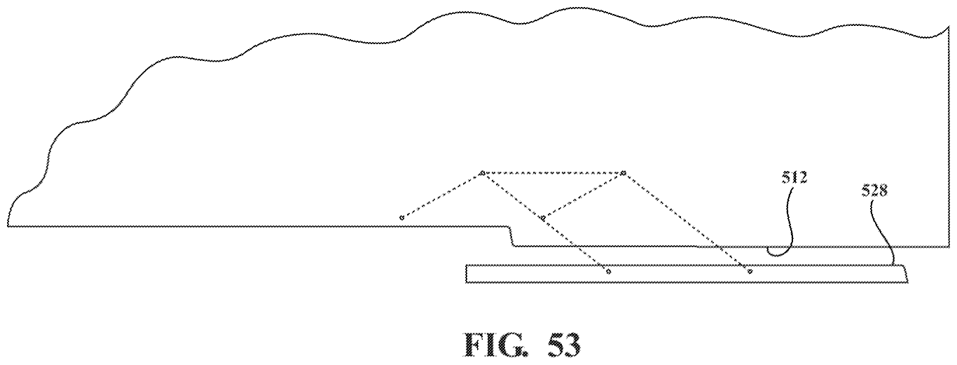

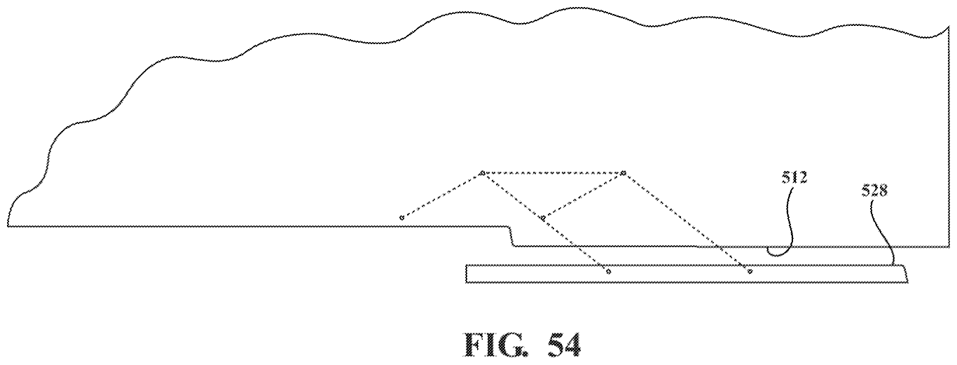

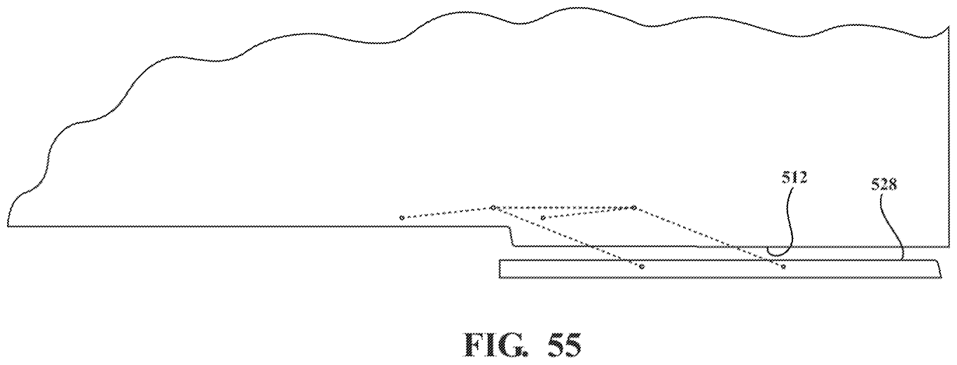

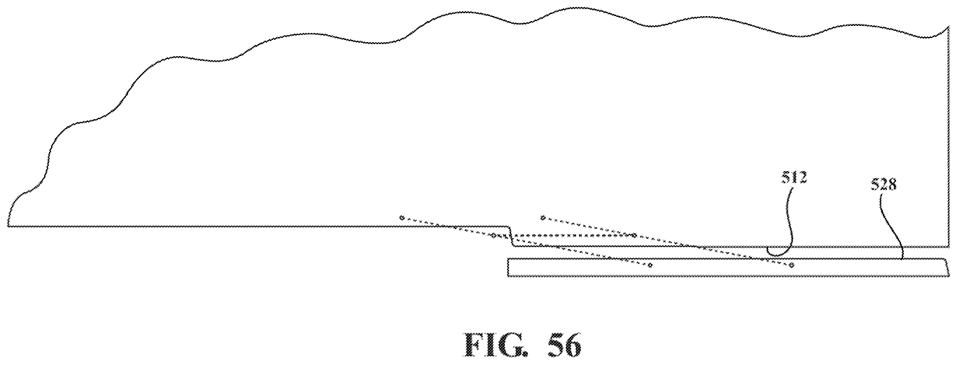

The door linkage system 550 includes a multi bar linkage 552 having a pair of first link arms 554 and a pair of second link arms 556. First link arms 554 are shown as being generally parallel with one another and second link arms 556 are shown as being generally parallel with one another, with first link arms 554 and second link arms 556 extending in non-parallel relation with one another (best seen in FIG. 46). During actuation of movement of rear door 528 between the open and closed position, such as via a motor (not shown) as discussed above, the first and second link arms 554, 556 are configured to unfold relative to one another during movement of rear door 528 toward the open position and to fold relative to one another while rear door 528 if moving toward the closed position. Arms 554, 556 are shown to swing within the vehicle body. Arm 554 is illustratively shown to swings inwardly towards the center of the vehicle as shown when moving between positions shown in FIG. 48 to FIG. 49. As shown in FIGS. 50 and 51, the link 556 and link 554 overlap each other as the door moves between the open position and the closed position. To facilitate maintaining the rear door 528 in close proximity to vehicle body 512 as the rear door is moving toward and to it open position, first and second link arms 554, 556 unfold inwardly toward a central portion of the vehicle body 512, thereby preventing the first and second link arms 554, 556 from extending laterally outwardly from the vehicle body 512 any more than necessary to allow the rear door 528 to translate along the vehicle body 512 in close, clearance relation therewith. As such, the distance that rear door 528 extends outwardly in a cross-vehicle direction from vehicle body 512 is minimized, where the maximum distance “X” is shown in FIG. 51, whereat first and second link arms 554, 556 are in generally parallel relation with one another and extend a maximum distance “Y” toward the center of vehicle body 512. It is to be recognized that the distance “X” can be precisely controlled, as desired in manufacture, thereby providing optimal and minimal clearance between rear door 528 and vehicle body 512 over the entirety of a door open sequence.

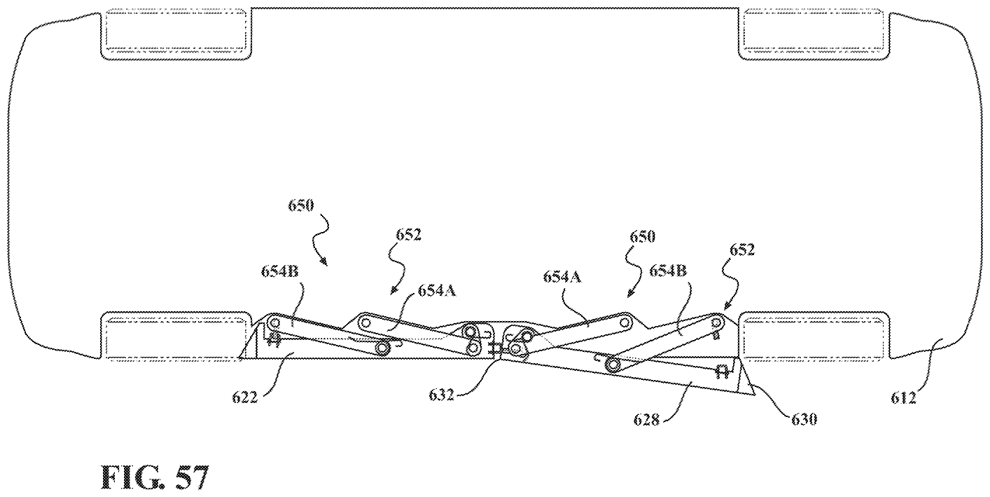

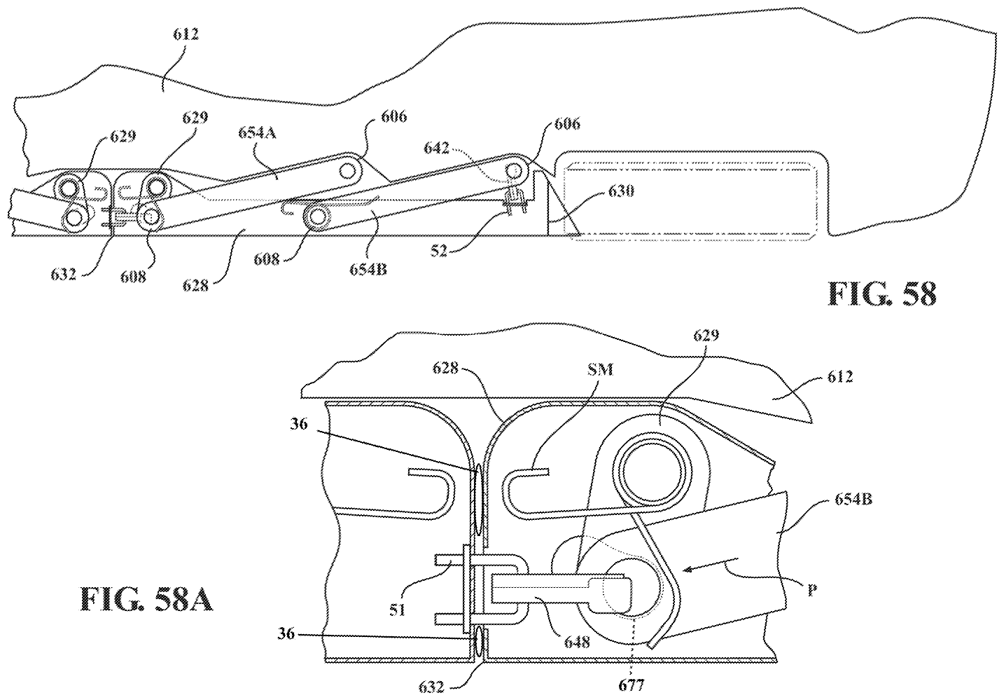

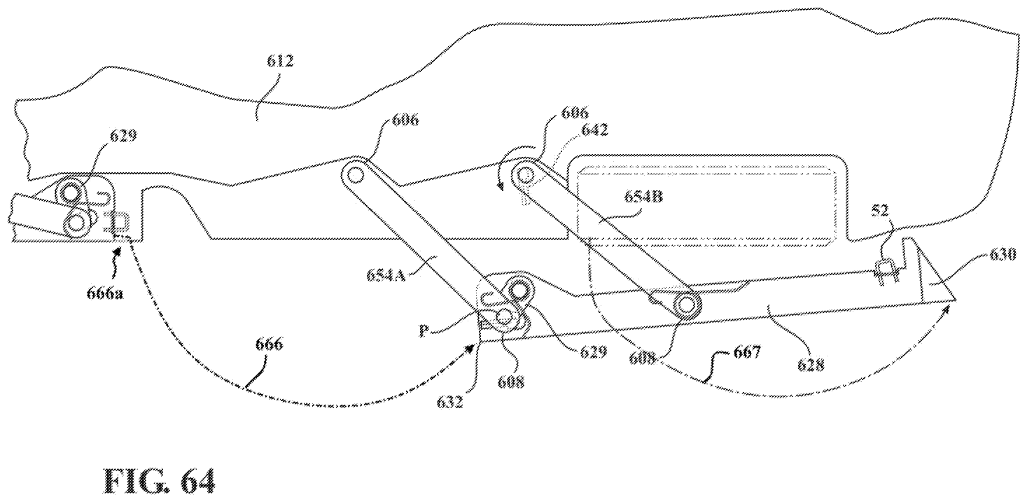

In FIG. 57, an example embodiment of another configuration of a door linkage system 650 for guiding a front and/or rear door 622, 628 (FIG. 30) of motor vehicle 611 between an open position (FIG. 64) and a closed position (FIG. 58) relative to vehicle body 612 is illustrated, wherein the same reference numerals as used above, offset by a factor of 600, are used to identify like features.

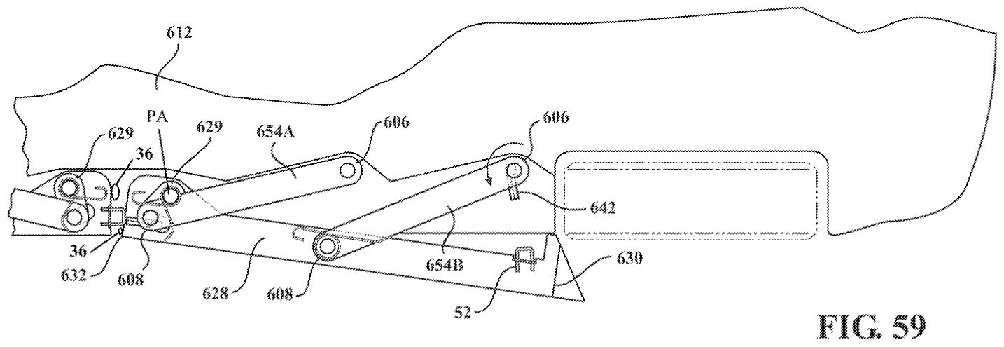

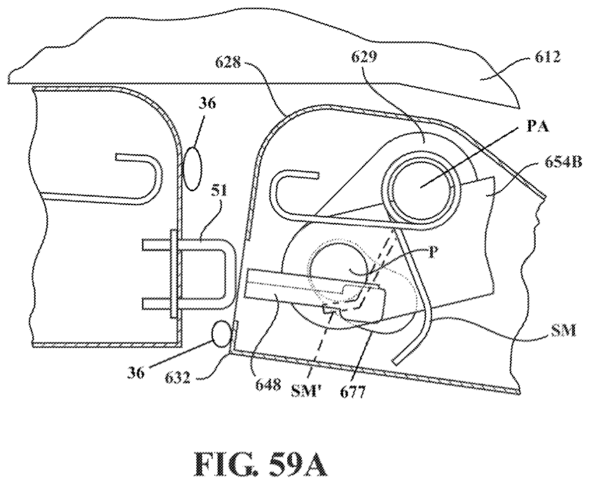

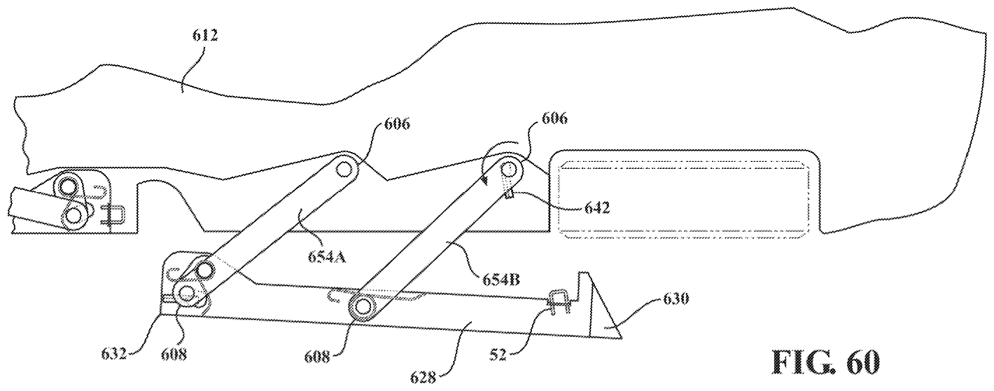

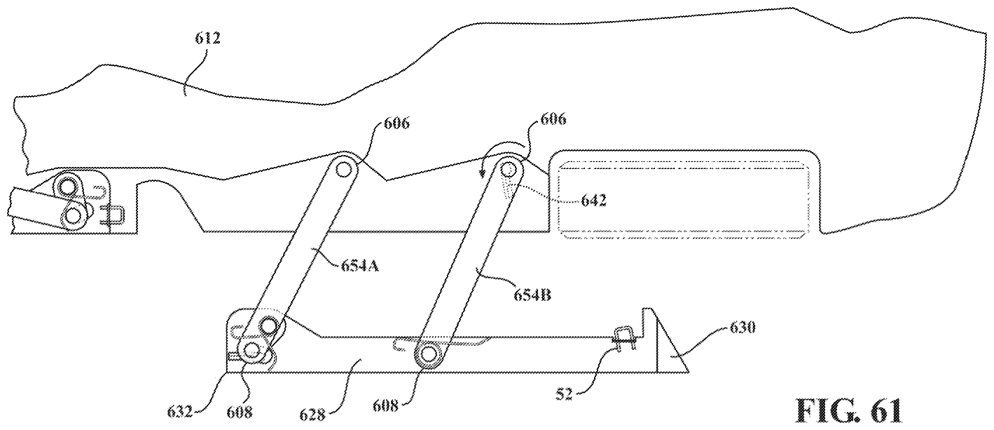

Each door linkage system 650 includes a multi bar linkage 652 having a pair of link arms 654A, 654B shown as being generally parallel with one another. Link arms 654A, 654B have proximal ends 606 pivotably connected to vehicle body 612 and distal ends 608 operably connected to rear door 628. Distal end 608 of link arm 654A is shown operably connected immediately adjacent a forward portion 632 of rear door 628 via a translation lever 629, also referred to as X-direction lever (due the propensity of translation lever 629 to cause the initial opening and closing movement of rear door 628 to be in the lengthwise, X-direction of motor vehicle, and minimally in a cross-vehicle direction), while distal end 608 of link arm 654B is shown connected generally midway between forward portion 632 and a rearward portion 630 of rear door 628. Distal end 608 of link arm 654A is pivotably connected to one end of translation lever 629 via a pin P, wherein pin P extends into receipt with an elongate slot S, referenced using numeral 677 having opposite slot ends acting as end stops for translation lever 629 when pin P engages either to limit the translation of the translation lever 629, in rear door 628, such that slot S allows for translation of pin P therein between opposite ends of slot S, thereby producing the substantial X-direction movement of rear door 628 during initial opening and closing, as discussed above. Translation lever 629 is pivotally coupled to rear door 628 at pivot axis “PA”. As best shown in FIG. 58, pin P is positioned adjacent one end of slot S, 677 against a bias of a spring member SM, also referred to as X-direction spring, wherein the bias imparted by spring member SM is overcome by the arrangement of link arm 654A pulling against the bias of spring member SM via the pinned connection to translation lever 629 while rear door 628 is in the closed position. As shown in FIG. 59A, spring SM will act on the pin P as it decompresses to a position shown as SM′ in phantom outline to cause the door to be initially driven in an X-direction facilitated by the slot 677, while translation lever 629 is shown as pivoting about the pin P axis until the front end of the slot 677 contacts the pin P. Translation lever 629 together with link arm 654A form a front linkage assembly. As shown in FIG. 64, door linkage system 650 is configured to guide the front of the door along a path 666, and along a portion of the path 666a during an initial opening or final closing position of the door having substantially an X-direction component. Rear part of door 628 is shown in a possible configuration to be guided to move along a path 667 and in comparison may be configured to having a combination of X-direction and Y-direction motions during an initial opening or final closing stage of the door.

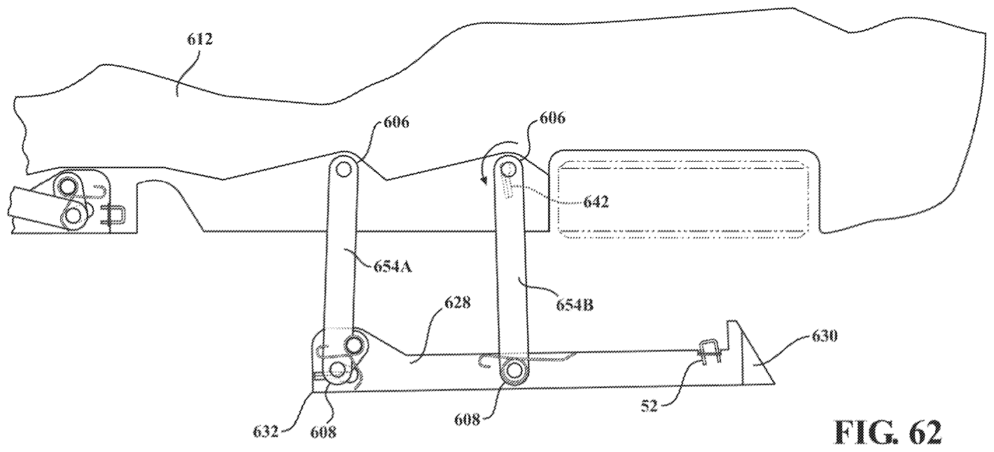

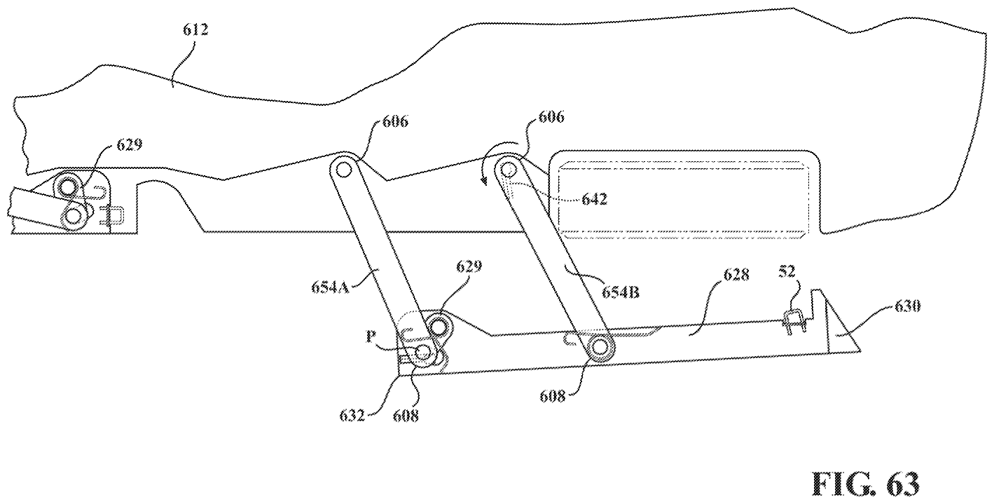

Prior to actuation of movement of rear door 628 between the open and closed position, a door-to-door latch D2D 648 on rear door 628 is released from a first striker 51 on front door 622, and a door latch 642 on vehicle body 612 is released from a second striker S2 on rear door 628. Then, with latches 648, 642 released, a motor driven actuator 614 mounted in the vehicle body 612 is actuated, as discussed above, to drive one of the link arms, and shown as link arm 654B in a counterclockwise CCW direction. As link arm 654B, shown illustratively as a single link forming a rear linkage assembly connecting the closure panel 628 to the vehicle body 612 is driven CCW, spring member SM imparts its bias on pin P to drive pin P to an opposite end of slot S, thereby resulting in substantially lengthwise, X-direction movement of rear door 628 during its initial opening movement. Link arms 654A, 654B continue to pivot in a CCW direction, rear door 628 is move to its open position, with the largest cross-vehicle movement being shown in FIG. 62, whereat link arms 654A, 654B are perpendicular to vehicle body 612. FIG. 64 illustrates rear door 628 in its fully open position, whereat link arms 654A, 654B reach an end of travel, and motor 614 stops rotating. As shown in FIG. 58 and FIG. 59, the front of the door 628 has a controlled motion substantially in an X-direction during an initial opening phase (or final closing) stage of the door 628. As shown in FIG. 59 the slower rate of rotation of first, frontal link 654A, compared to second, rear link 654B can be shown by an angle change or distance change between a first longitudinal axis AA of the first, frontal link 654A, and a second longitudinal axis BB of the second, rear link 654A. For example, the angle between the intersection 299 as seen in FIG. 59 of the first longitudinal axis AA and second longitudinal axis BB may change as the door 628 is opened (or closed). Thus the first, frontal link 654 Thus the first, frontal link 654A, and to second, rear link 654B A, and to second, rear link 654B may adopt non-parallel and changing orientations from one another during door motion to control the motion of the front portion of the door 28 differently than the motion of the rear portion of the door 28. For example, the first, frontal link 654A, and to second, rear link 654B may have parallel orientations when the door 628 is fully closed, then during an initial opening stage adopt non-parallel and changing orientations as the door 628 is initially opened with the front of the door 628 having a substantially X-direction motion, and then adopt parallel orientations during an intermediate door opening stage.

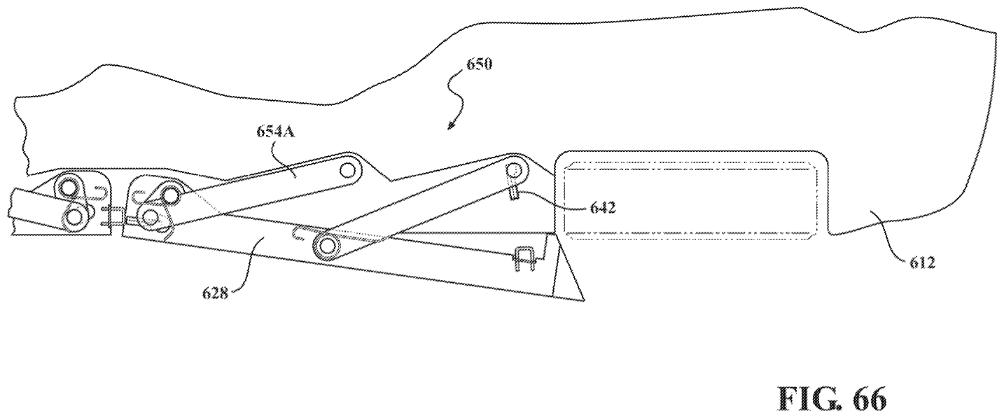

In FIGS. 65A, 65B, and 66, various latch and striker arrangements are illustrated, as desired for the intended application. The various arrangements illustrate power latch and power cinch arrangements that can be incorporated separately or in combination with one another, as will be readily understood by one possessing ordinary skill in the art upon viewing the disclosure herein.

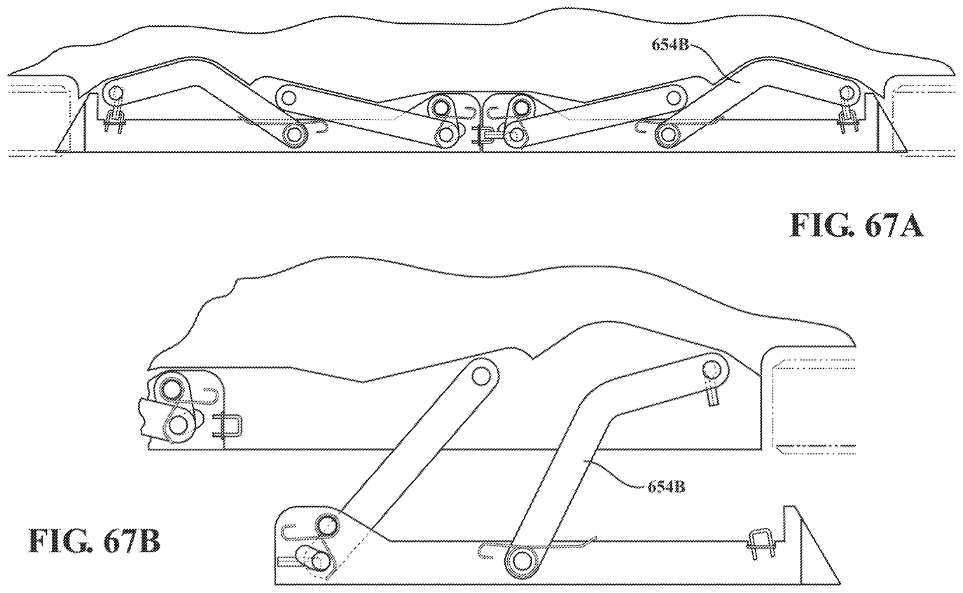

In FIGS. 67A and 67B, an alternate embodiment of link arm 654B is shown, wherein link arm 654B can be provided being generally L-shaped to enhance the torque applied by link arm 654B upon being driven by motor driven actuator 614.

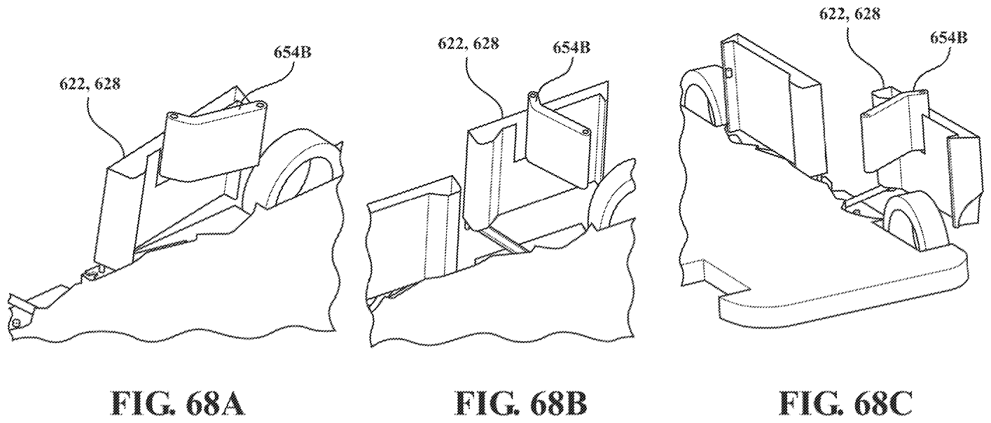

In FIGS. 68A, 68B and 68C, an alternate embodiment of link arm 654B is shown, wherein link arm 654B can be provided being generally L-shaped and having an increased width to enhance the torque and support applied by link arm 654B to front and rear doors 622, 628. Further yet, with the increased stiffness provided by the increased width, the link arm 654 can be connected to an approximate mid-region of the front and rear doors 622, 628 while being able to support the full weight of the front and rear doors 622, 628.

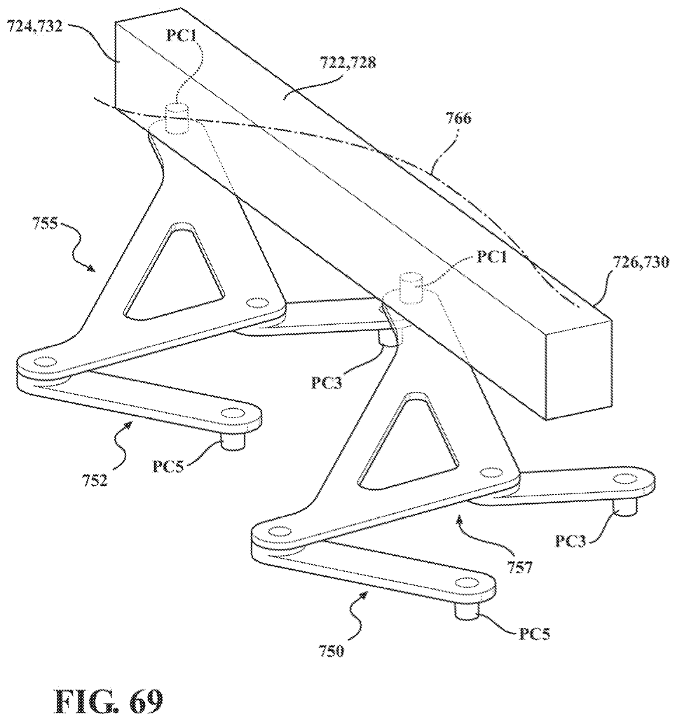

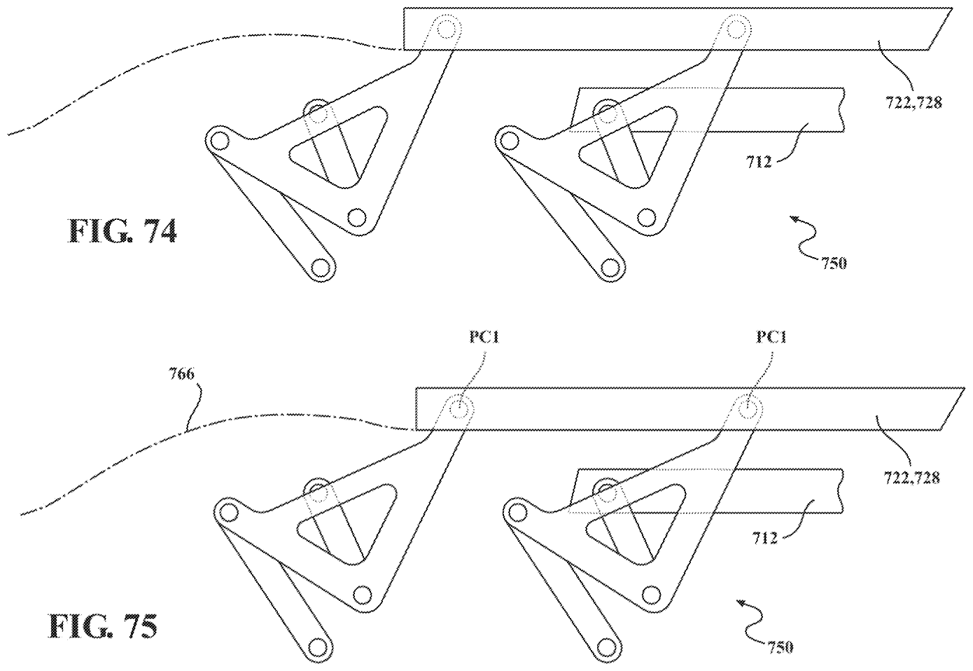

In FIGS. 69-75, an example embodiment of another configuration of a door linkage system 750 for guiding a front and/or rear door 722, 728 (FIG. 30) of motor vehicle 711 between an open position (FIG. 75) and a closed position (FIG. 69) relative to vehicle body 712 is illustrated, wherein the same reference numerals as used above, offset by a factor of 700, are used to identify like features.

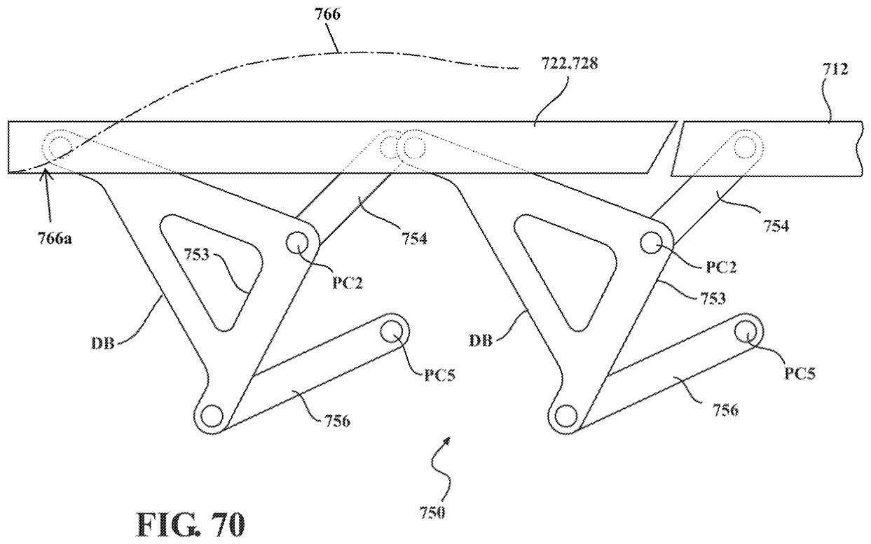

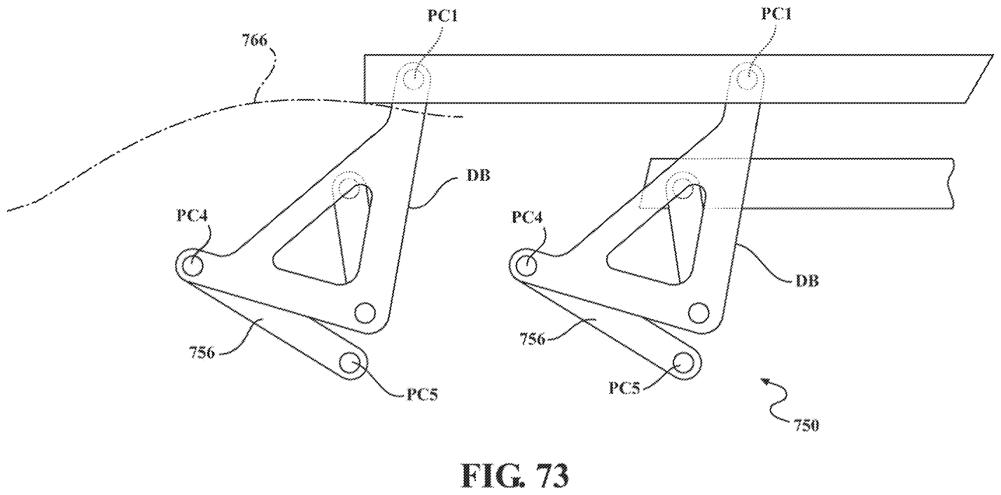

The door linkage system 750 functions without having to have guide paths or tracks in vehicle body 712. Door linkage system 750 includes a multi bar linkage 752 having a pair of door brackets DB pivotably coupled to door 722, 728 via pivot connections PC1 (FIG. 73) and to one end of first links 754 at pivot connections PC2 (FIG. 70), with an opposite end of first links 754 being pivotably connected to vehicle body 712 at pivot connections PC3 (FIG. 69). Door brackets DB are further pivotably to one end of second links 756 at pivot connections PC4 (FIG. 73), with an opposite end of second links 756 being pivotably connected to vehicle body 712 at pivot connections PC5 (FIG. 73). Accordingly, pivot connections PC1 remain fixed relative to door 722, 728; pivot connections PC2 and PC4 remain fixed relative to door brackets DB; and pivot connections PC3 and PC5 remain fixed relative to vehicle body 712.

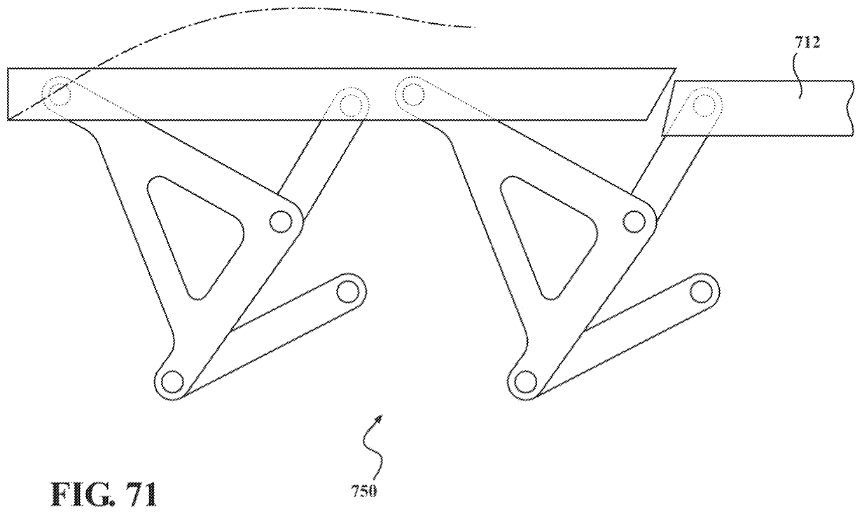

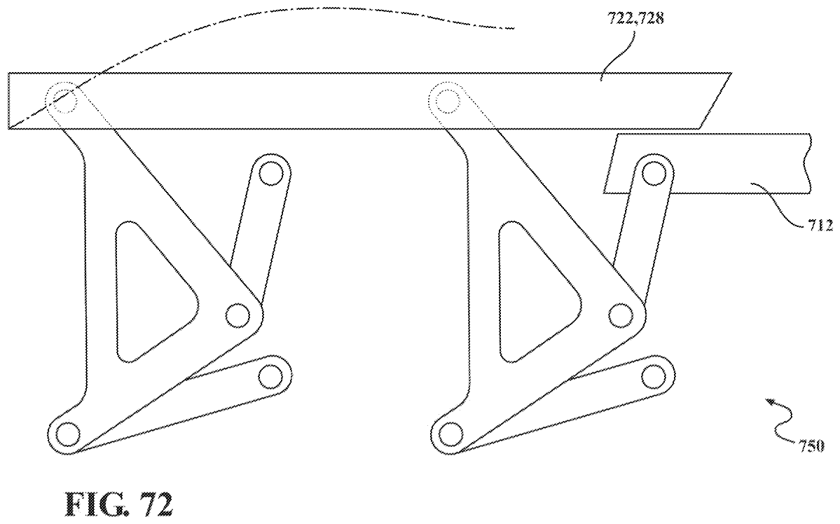

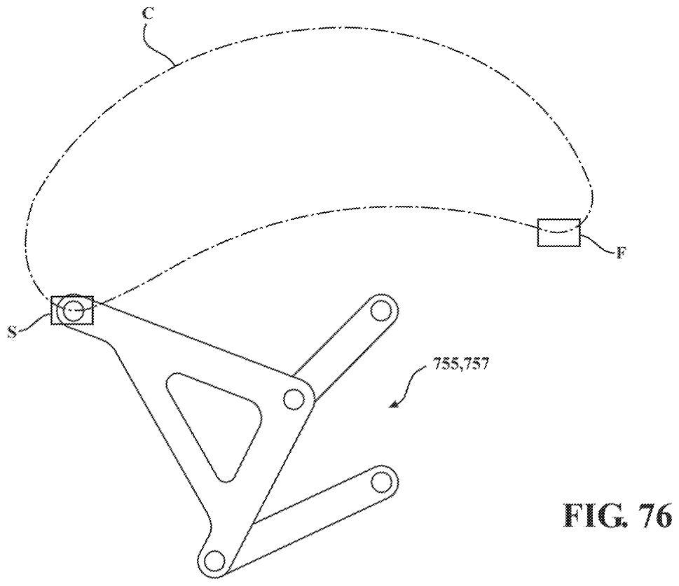

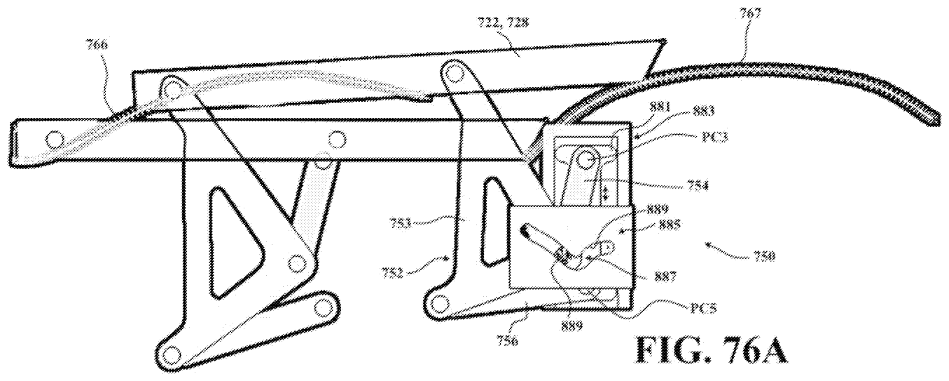

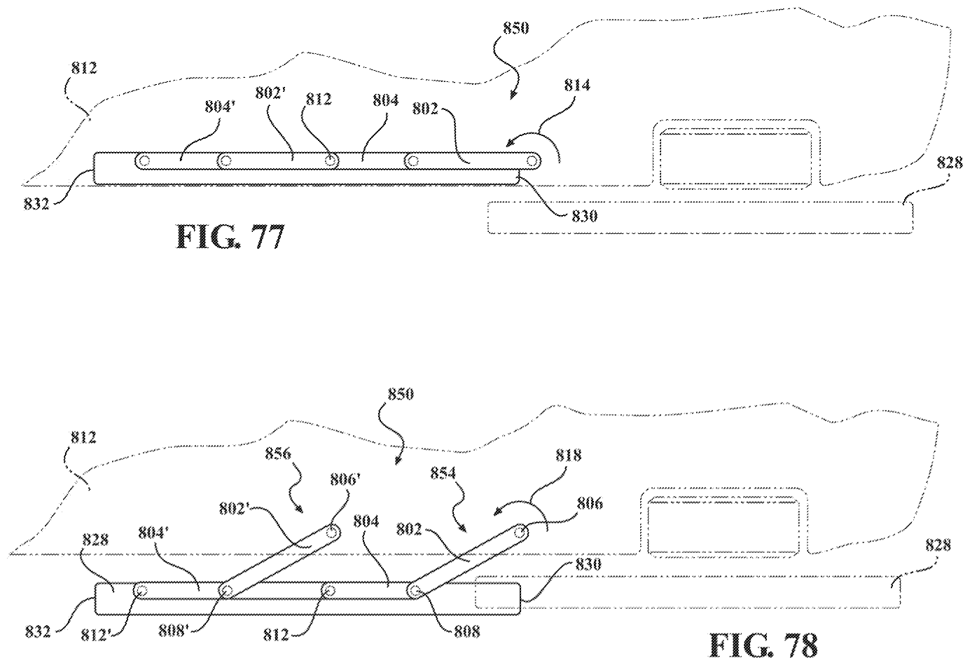

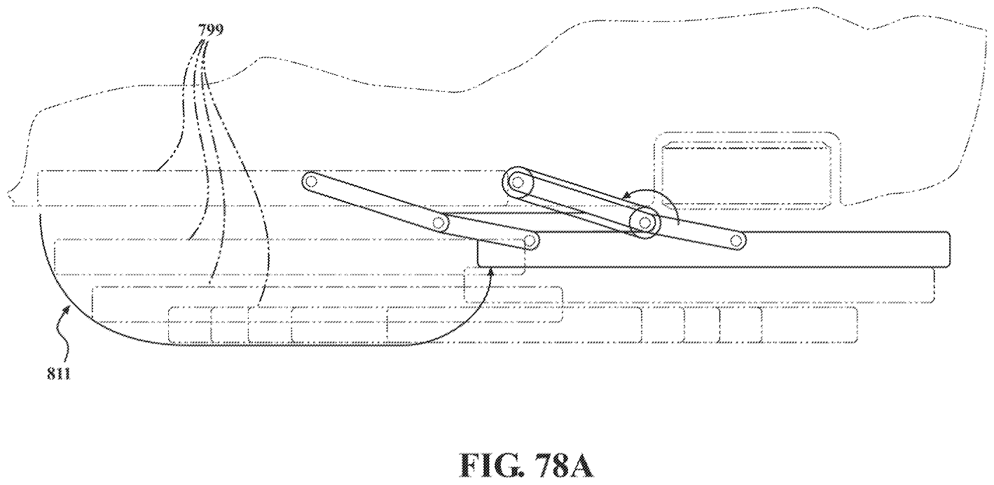

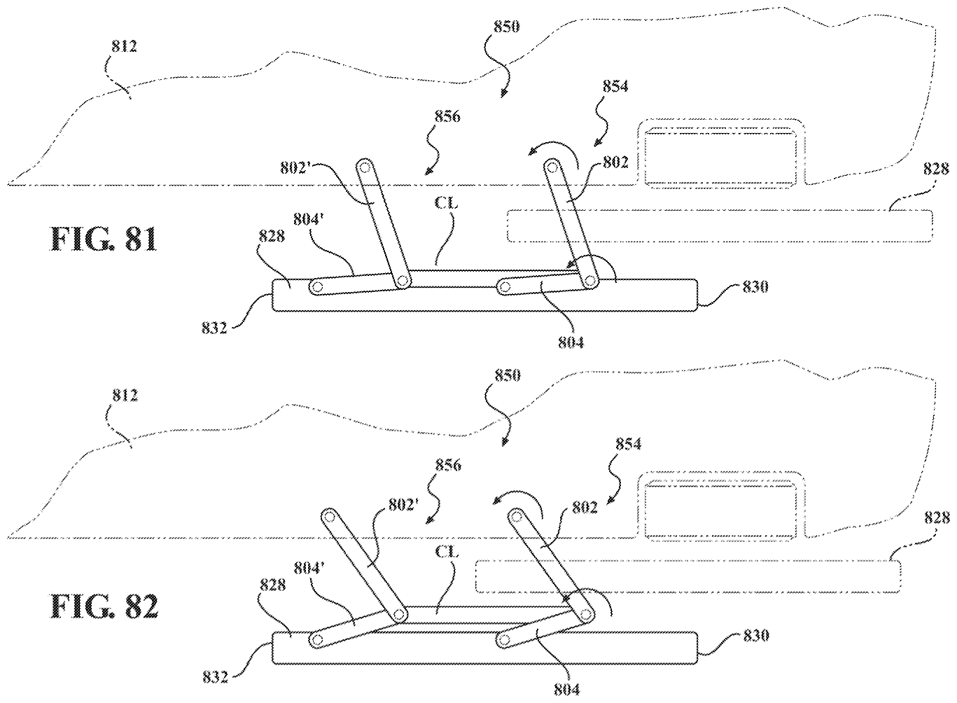

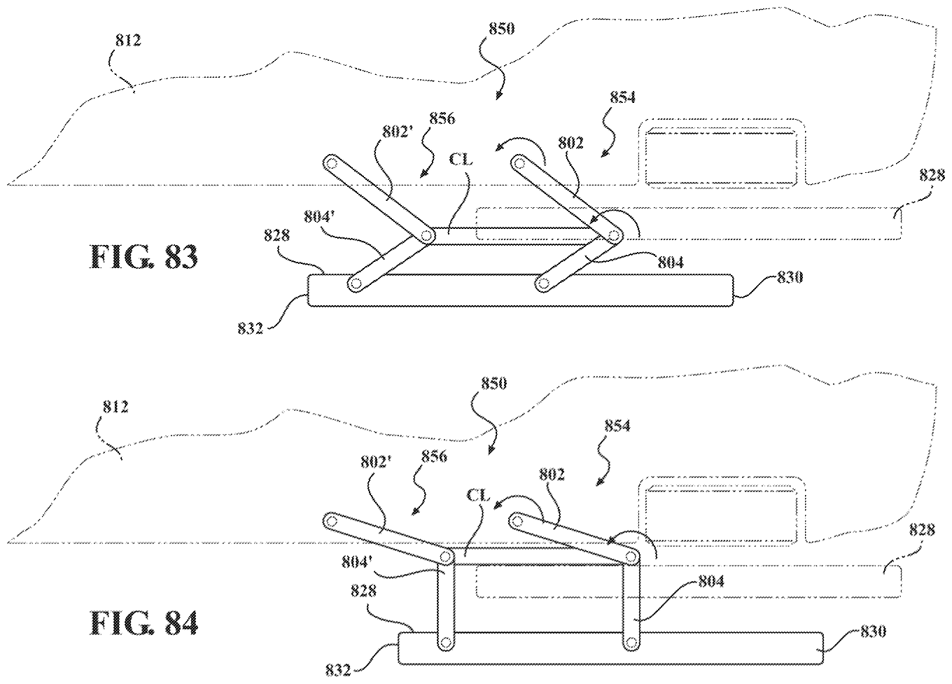

In operation, a motor driven actuator 714 (FIG. 69) provided on the vehicle body 712 is actuated, as discussed above, to drive one of the first links, and shown by way of example and without limitation as the rearward first link 754, in a counterclockwise CCW direction about pivot connections PC3. As first link 754 is driven CCW, as shown in FIG. 70, the initial movement of door 722, 728 is in a substantially rearward X-direction along the lengthwise direction of motor vehicle 711, illustrated as initial portion 766a of path 766. As CCW movement of first links 754 continues about pivot connections PC3, second links 756 are caused to rotate clockwise CW about respective pivot connections PC5, thereby causing door brackets DB to pivot clockwise CW about pivot connections PC1 and move outwardly from vehicle body 712 in a cross-vehicle direction (FIG. 72), whereat a rearward portion 726, 730 and a forward portion 724, 732 of respective door 722, 728 are caused to move in the cross-vehicle direction to provide a slight clearance between the door 722, 728 and the vehicle body 712 as the door 722, 728 moves toward its fully open position. As CCW movement of first links 754 continues about pivot connections PC3 in FIG. 73, the first and second links 754, 756 can overlap door bracket DB via being laterally offset therefrom, thus, allowing door bracket DB to continue free, unobstructed rotation in the CW direction as forward portion 724, 732 of door 722, 728 moves along path 766 until door 722, 728 reaches the fully open position (FIG. 75). The linkage 755, 757 allows door 722, 728 to travel at a reduced speed as it approaches the fully open position, thereby improving cinching and seal compression, while also reducing the potential of pinching by prolonging a period for pinch detection. Each link 754 of the front linkage assembly 755 and the rear linkage assembly 757 are shown to swing within the vehicle body. Links 754 are illustratively shown to swing inwardly towards the center of the vehicle, as shown, when moving between positions shown in FIG. 70 to FIG. 72. As shown in FIGS. 72 to 75, the link 753 and link 754 overlap each other as the door moves between the open position and the closed position. Now referring to FIG. 76, there is illustrated a linkage 755, 757 that is configured to guide the door, such as the front or the rear of the door along a path “C”. Illustratively the path that the linkage 755, 757 may be configured to guide the door is a closed loop path, however the linkage 755, 757 is configured to drive the door along a portion of the path C, which is illustratively shown as a complex curve. The linkage 755, 757 may be configured to drive the door from a start position corresponding to a portion of the path C having a relatively flat portion of the curve C, such as to provide the door with only or mostly an initial X-direction for example where the linkage 755 drives the front of the door as described herein above. The linkage 755, 757 may be configured to continue to further drive the door from away from start position corresponding to a portion of the path C having a curved portion of the curve C, such as to provide the door with a combination X and Y-direction motion for example where the linkage 755 drives the front of the door rearwards and outwards as described herein above. The linkage 755, 757 may be configured to continue to further drive the door from away from start position corresponding to a portion of the path C having a curved portion of the curve, such as to provide the door with a combination X and Y-direction motion to return the door towards the vehicle body for example where the linkage 755 drives the front of the door rearwards and inwards as described herein above. The linkage 755, 757 may be configured to continue to further drive the door from away towards a portion of the curve shown as “F” portion of the path C corresponding to a substantially flat portion of the curve as the door reaches its final opened position, such as to provide the door with a substantially Y motion. By configuring the linkage 755, 757 to drive the door along the path at various starting and ending points along the curve C, the door motion can be defined accordingly. As one result the door can be driving in a substantially X-direction without a sliding configuration provided by a track and roller configuration, as one example. Door 722, 728 may be controlled by door linkage system 750 to be moved having the same parallel orientation along the path or opening or closing. In another possible configuration, door linkage system 750 may control the door 722, 728 be moved having a changing orientation along the path or opening or closing. Front portion of door 722, 728 may be controlled to move along a first path 766, and rear portion of door 722, 728 may controlled to follow a different path 767. For example, and as shown in FIG. 76A, the pivots PC3 and PC5 of rear multi bar linkage 752 may be moveable, such as by providing pivots PC3 and PC5 moveable mounted to the vehicle body such as for example via a slider assembly 883 having a sliding bracket 881 slideably retained in a slot 885 formed in the vehicle body or in a separate bracket assembly mounted to the vehicle body as one example. Sliding bracket 881 may be slidable in the Y-direction to allow the pivots PC3 and PC5 to move in the Y-direction. Further configuration of door linkage system 750 may provide for the rotation of the link 753 to be controlled, for example by providing a guide assembly 885 having a track 887 defining a control surface 889 for engaging and guiding rotation of the link 753, such as an upwards projection 889 extending from the link 753 in one possible configuration. Upwards projection 889 is shown as a pin extending co-axial with pivot point PC2 In FIGS. 77-86, an example embodiment of another configuration of a door linkage system 850 for guiding a front and/or rear door 822, 828 (FIG. 30) of motor vehicle 811 between an open position and a closed position relative to vehicle body 812 is illustrated, wherein the same reference numerals as used above, offset by a factor of 800, are used to identify like features.

Door linkage system 850 includes a multi bar linkage 852 including a first link assembly, also referred to as first link 854, and a second link assembly, also referred to as second link 856, each pivotably connecting front and/or rear door 822, 828 to vehicle body 812. First link 854 includes a first link first hinge arm, also referred to as first link first arm 802, and a first link second hinge arm, also referred to as first link second arm 804. First link first arm 802 has first link proximal end 806 pivotably connected to vehicle body 812, and a first link distal end 808 pivotably connected to first link second arm 804. First link second arm 804 has a second link proximal end 810 pivotably connected to first link distal end 808 of first link first arm 802 and a second link distal end 812′ pivotably connected to front and/or rear door 822, 828, shown as rear door 828. Second link 856 includes a second link first hinge arm, also referred to as second link first arm 802′, and a second link second hinge arm, also referred to as second link second arm 804′. Second link first arm 802′ has first proximal end 806′ pivotably connected to vehicle body 812, and a first distal end 808′ pivotably connected to second link second arm 804′. Second link second arm 804′ has a second proximal end 810′ pivotably connected to first distal end 808′ of second link first arm 802′ and a second distal end 812′ pivotably connected to front and/or rear door 822, 828, shown as rear door 828. To facilitate movement of rear door 828 between the open and closed positions, a first motor 814 is disposed in the vehicle body 812 for operable driving communication with first link first arm 802, and a second motor 816 is disposed in the vehicle body 812 for operable driving communication with first link second arm 804, such as via a gear train or belt drive, referred to as drive system DS. First motor 814 and second motor 816 are actuatable independently from one another to provide the desired movement of rear door 828, as desired. To facilitate maintaining synchronized movement of the first link first arm 802 and first link second arm 804 of first link 854 relative to one another, a connecting link CL and/or sensors S may be provided for detection of their respective locations, with feedback provided to ECU and ultimately to motors 814, 816, thereby allowing motors 814, 816 to be energized and de-energized, when desired, whether concurrently with one another or separately. If actuated at separate times, the movement of the non-energized actuator can be prevented by non-back-drivable gearing, or the like, thereby assuring the associated link(s) move as desired.

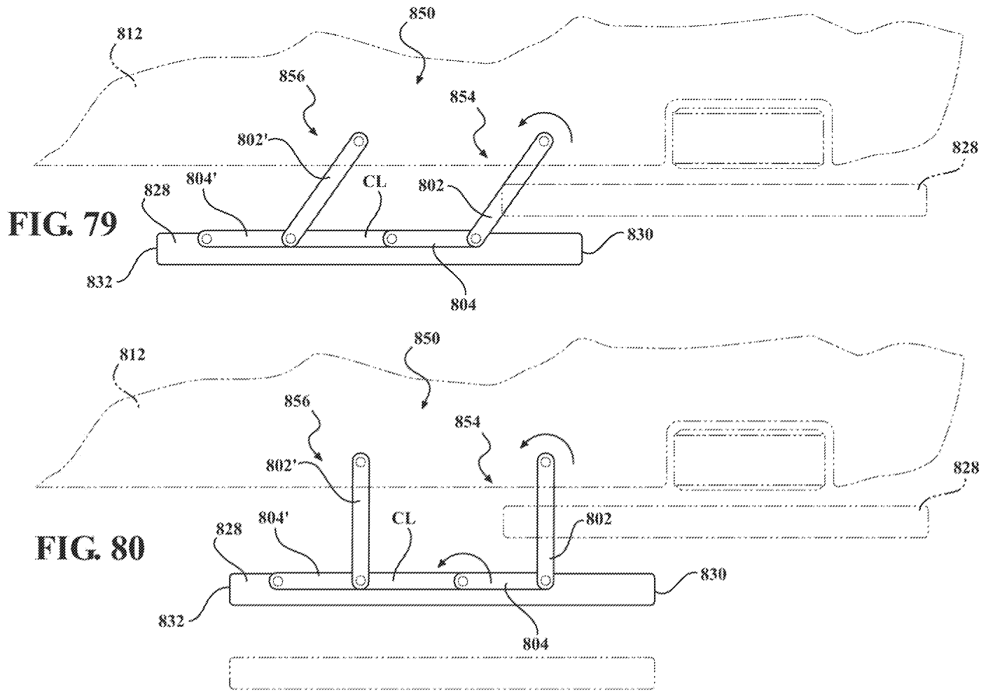

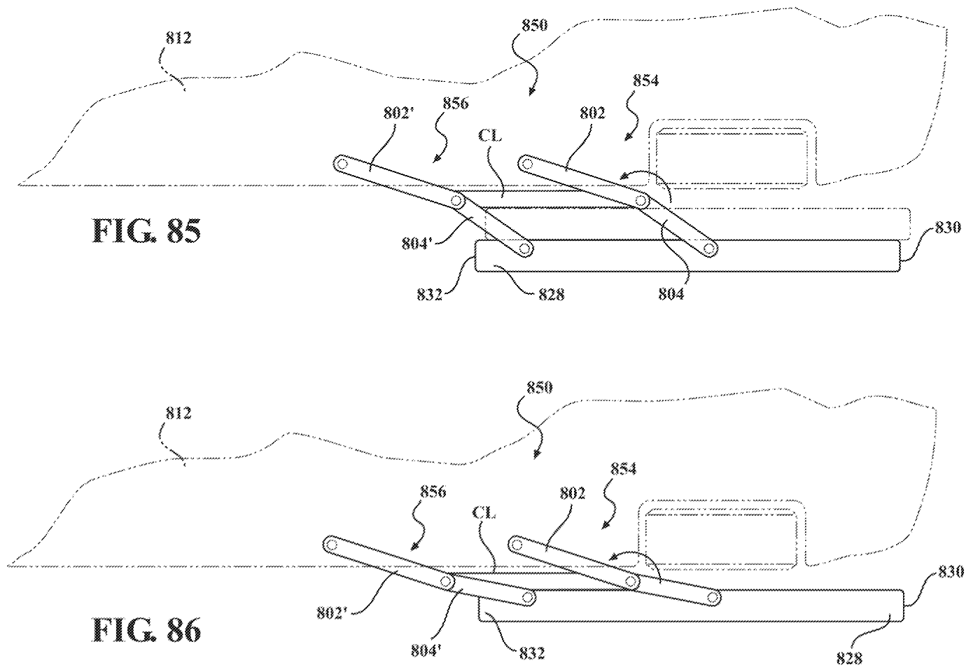

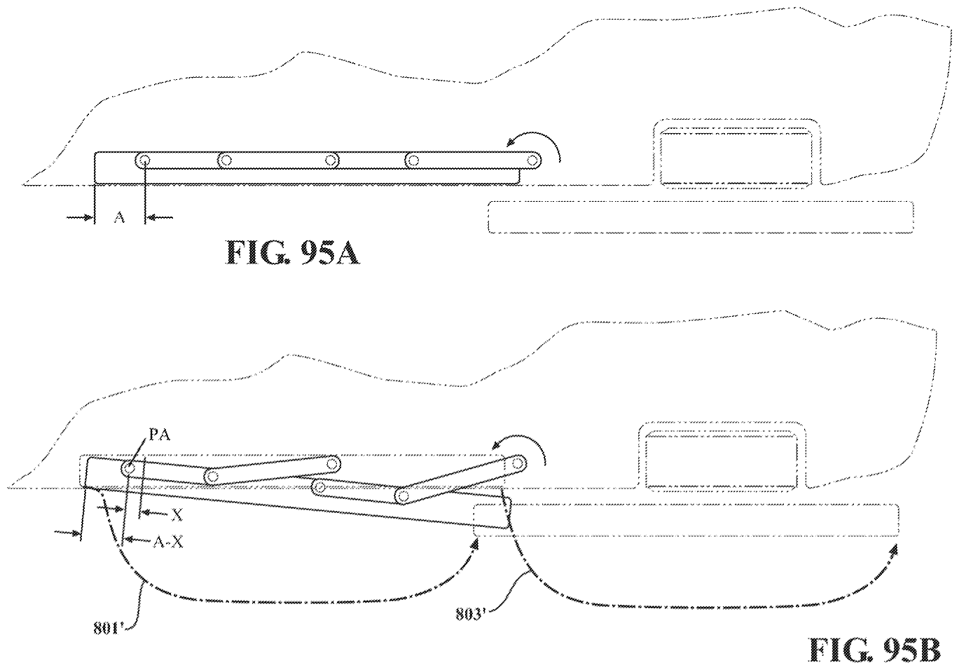

In operation, when desired to move rear door 828 (it is to be recognized that the same applies to any closure panel, including front door 822, if desired) from the closed position to the open position, first motor 814 is energized (FIG. 77), such as via any operable signal device, including a key fob, activation button, door handle, or otherwise, thereby causing first motor 814 to drive first link first arm 802 in an opening direction 818, shown as being counterclockwise (CCW) in FIGS. 77-84. As first motor 814 operably drives first link first arm 802, wherein the operable driving can be via a direct or indirect driving communication between a drive gear connected to an output shaft of first motor 814 and a driven surface or member fixed to first link first arm 802, by way of example and without limitation, first link first arm 802 is caused to rotate CCW about a pivot axis adjacent first proximal end 806 of first link first arm 802. With first link first arm 802 being rotatably driven CCW, first distal end 808 of first link first arm 802, pivotably connected to second proximal end 810 of second arm 304, pulls first link second arm 804 rearwardly toward a rear end of motor vehicle 811. During this initial stage of opening movement of rear door 828, a rearward portion 830 and forward portion 832 of rear door 828 is caused to move outwardly from vehicle body 812 in a cross-vehicle direction and rearwardly along a lengthwise direction of motor vehicle 811. First motor 814 continues driving first link first arm 802 and rear door 828 until rear door 828 reaches a position of generally maximum outward cross-vehicle spaced relation from vehicle body 812 (FIG. 80), whereat first link first arm 802 and first link second arm 804 are perpendicular or substantially perpendicular to one another. Then, second motor 816 is actuated (energized, such as can be controlled by a control unit of motor vehicle 811), with first motor 814 remaining energized, to begin driving first link second arm 804 in a counterclockwise direction (CCW) (FIGS. 80-86). As first link second arm 804 is driven CCW, first link second arm 804 eventually begins to unfold relative to first link first arm 802 (FIG. 84), whereat first link first arm 802 reaches its fully deployed position, whereat first motor 814 stops and second motor 816 continues driving and unfolding first link second arm 804 in the CCW direction (FIGS. 85-86) until first link second arm 804 reaches its end of travel and first link first arm 802 and first link second arm 804 become collinear or substantially collinear with one another (FIG. 86), whereat second motor 816 is de-energized. Of course, it is to be recognized that to move the rear door 828 to the closed positon, the process can simply be reversed, as will be understood by one possessing ordinary skill in the art upon viewing the disclosure herein. FIG. 79A shows different door positions during operation, shown in a sequence of phantom outlines indicated by reference numeral 799. FIG. 79A also shows a path of motion of the front of the door represented by a solid line indicated by reference number 801. Accordingly, the maximum door position away from the vehicle body can be minimized due to a dual stage operation since the second arms 804, 804′ are configured to swing when the first arms 802, 802′ are not in a position less than their maximum outward distance from the vehicle body, such as would be when the arms 802, 802′ are at a right angle with the vehicle body. FIG. 80 illustrates the maximum door out position of each link having a single arm in comparison to each link having the dual (multi) arm 802, 804, configuration. Other door motion paths may be provided, such as for example shown in FIG. 95B of a door configuration shown in FIG. 95A whereby the second link consists of at least one of the arms 904, 904′ which may be shorter than the first arms 902, 902′. As a result the path of travel of motion can be changed, for example the front of the door 12 may have a path of travel 801′ having an initially substantially longitudinal vehicle direction (LVD). The rear of the door can have an initially substantially cross-vehicle direction path of travel 803′.

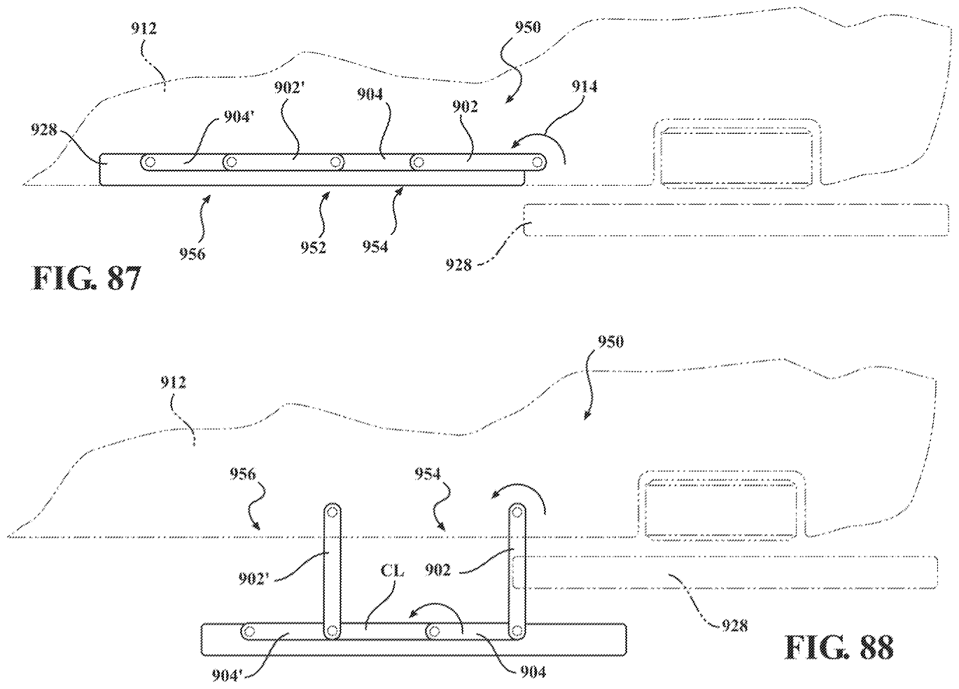

In FIGS. 87-91, an example embodiment of another configuration of a door linkage system 950 for guiding a front and/or rear door 922, 928 (FIG. 30) of motor vehicle 911 between an open position and a closed position relative to vehicle body 912 is illustrated, wherein the same reference numerals as used above, offset by a factor of 900, are used to identify like features.

Door linkage system 950 includes a multi bar linkage 952 including a first link assembly, also referred to as first link 954, and a second link assembly, also referred to as second link 956, each pivotably connecting front and/or rear door 922, 928 to vehicle body 912. First link 954 includes a first link first hinge arm, also referred to as first link first arm 902, and a first link second hinge arm, also referred to as first link second arm 904. First link first arm 902 has first link proximal end 906 pivotably connected to vehicle body 912, and a first link distal end 908 pivotably connected to first link second arm 904. First link second arm 904 has a second link proximal end 910 pivotably connected to first link distal end 908 of first link first arm 902 and a second link distal end 912 pivotably connected to front and/or rear door 922, 928, shown as rear door 928. Second link 956 includes a second link first hinge arm, also referred to as second link first arm 902′, and a second link second hinge arm, also referred to as second link second arm 904′. Second link first arm 902′ has first proximal end 906′ pivotably connected to vehicle body 912, and a first distal end 908′ pivotably connected to second link second arm 904′. Second link second arm 904′ has a second proximal end 910′ pivotably connected to first distal end 908′ of second link first arm 902′ and a second distal end 912′ pivotably connected to front and/or rear door 922, 928, shown as rear door 928. To facilitate movement of rear door 928 between the open and closed positions, a first motor 914 is disposed in the vehicle body 912 for operable driving communication with first link first arm 902, and a second motor 916 is disposed in the rear door 928 for operable driving communication with first link second arm 904. To facilitate maintaining synchronized movement of the first link 954 and first link 956 relative to one another, a connecting link CL may be provided therebetween, shown as extending between their respective pivot joints between first and second arms 902, 904; 902′, 904′.

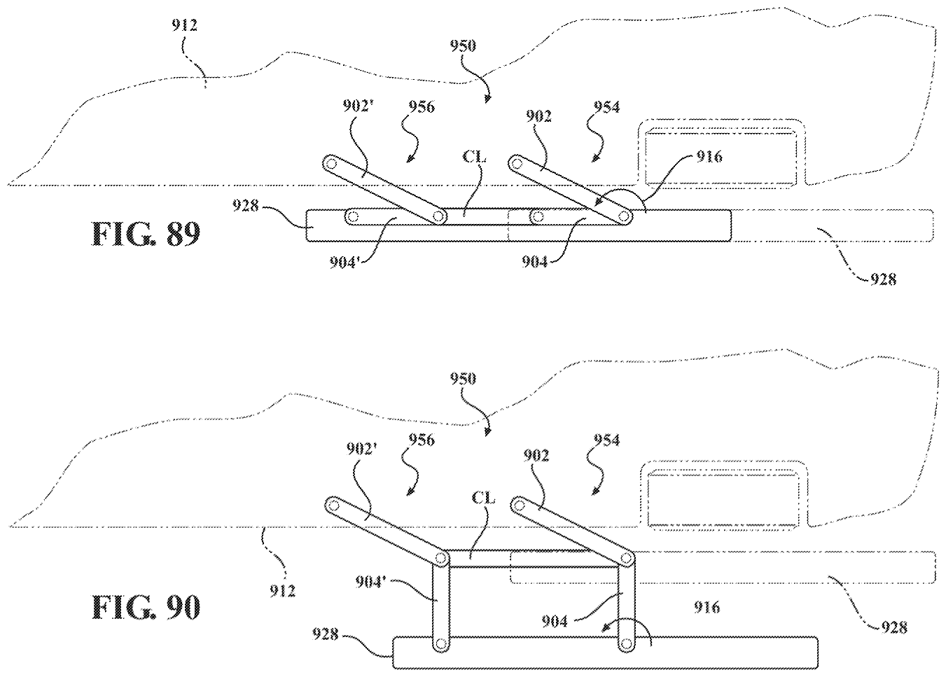

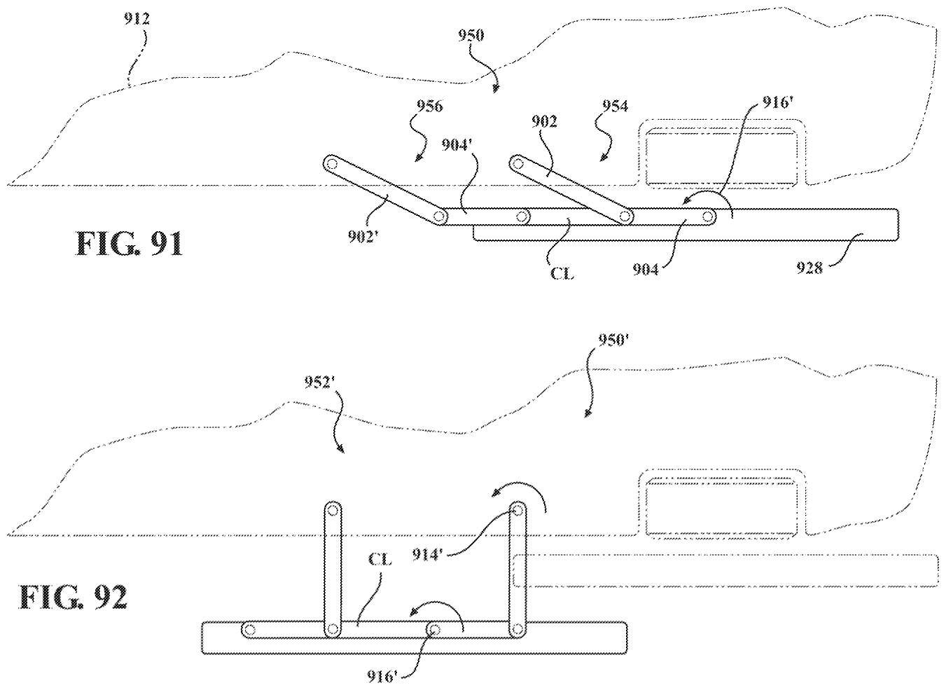

In operation, when desired to move rear door 928 (it is to be recognized that the same applies to any closure panel, including front door 922, if desired) from the closed position to the open position, first motor 914 is energized (FIG. 87) as discussed above for first motor 814, whereupon first motor 914 operably drives first link first arm 902, also as discussed above for first link first arm 802. First motor 914 continues driving first link first arm 902 and rear door 928 until rear door 928 reaches a position of generally maximum outward cross-vehicle spaced relation from vehicle body 912 (FIG. 88), whereat first link first arm 902 and first link second arm 904 are perpendicular or substantially perpendicular to one another. First motor 914 remains energized to drive first link first arm 902 to a fully rotated position (FIG. 89), whereat first motor 914 is de-energized, and then, second motor 916 becomes actuated (energized, such as can be controlled by a control unit of motor vehicle 911) in a counterclockwise direction (CCW) (FIGS. 89-91). As first link second arm 904 is driven CCW, first link second arm 904 unfolds relative to fully deployed first link first arm 902 (FIG. 84), whereat second motor 916 continues driving and unfolding first link second arm 904 in the CCW direction until first link second arm 904 reaches its end of travel (FIG. 91), whereat second motor 916 is de-energized. During actuation of second motor 916, rear door 928 is caused to move in both an outwardly and inwardly cross-vehicle direction, in addition to moving rearwardly, and thus, the path of movement of rear door 928 from the closed position to the open positon is wave pattern, having 2 peaks (FIGS. 88 and 90) of outward movement from vehicle body (912). Of course, it is to be recognized that to move the rear door 828 to the closed positon, the process can simply be reversed, as will be understood by one possessing ordinary skill in the art upon viewing the disclosure herein.

In FIG. 92, an example embodiment of another configuration of a door linkage system 950′ for guiding a front and/or rear door 922, 928 (FIG. 30) of motor vehicle 911 between an open position and a closed position relative to vehicle body 912 is illustrated, wherein the same reference numerals as used above, offset by a factor of 900′, are used to identify like features.

The door linkage system 950′ is similar to that discussed above for door linkage system 950, having a multibar linkage 952′ with a first motor 914′ disposed in vehicle body 912 and as second motor 916′ disposed in rear door 928; however, rather than sequencing actuation of first and second motors 914′, 916′ in non-overlapping energization relation with one another, second motor 916′ is actuated in combination (concurrently) with first motor 914′ during corresponding FIGS. 88 and 89 of door linkage system 950, thereby smoothing out the wave motion of rear door 928.

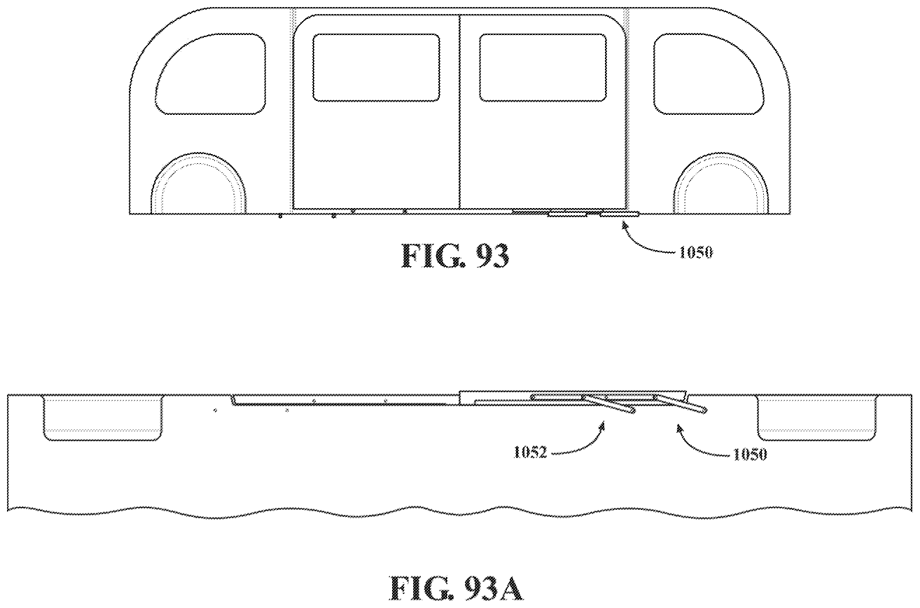

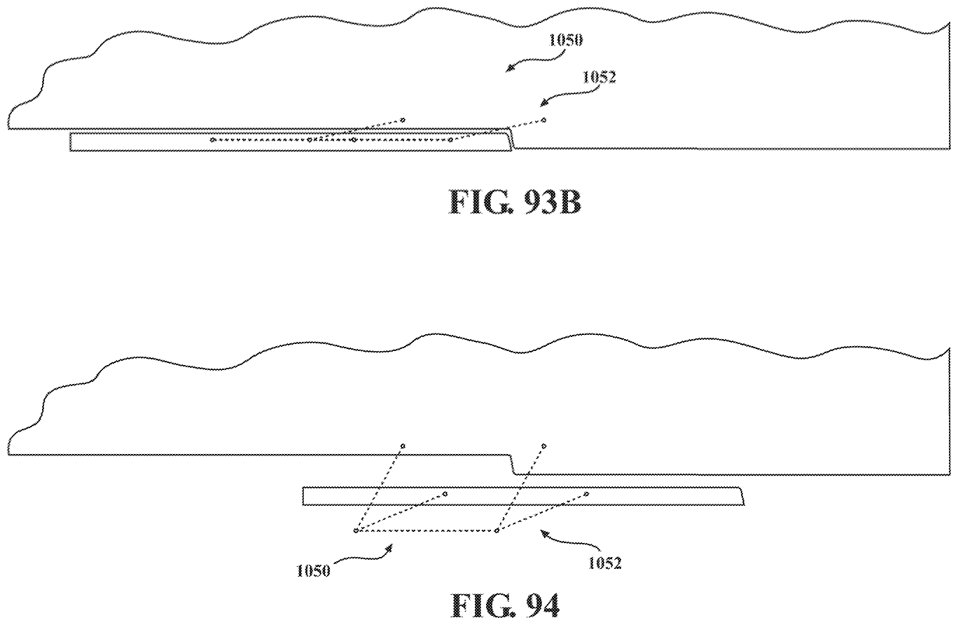

In FIGS. 93 and 93A, an example embodiment of another configuration of a door linkage system 1050 for guiding a front and/or rear door 1022, 1028 (FIG. 30) of motor vehicle 1011 between an open position and a closed position relative to vehicle body 1012 is illustrated, wherein the same reference numerals as used above, offset by a factor of 1000, are used to identify like features. FIG. 93 illustrates a schematic side view of motor vehicle 1011 with the dual-door B-pillarless closure system 1050, while FIGS. 93A and 93B are schematic top plan views illustrating a multibar linkage 1052 of the dual-door B-pillarless closure system of FIG. 93.

FIG. 94 illustrates the door 1028 of FIGS. 93A-93B during an intermediate stage of movement from the initial stage toward the open position via actuation of the dual-door B-pillarless closure system 1050, with a rearward and forward portion of the door being moved substantially in a rearward lengthwise vehicle direction.

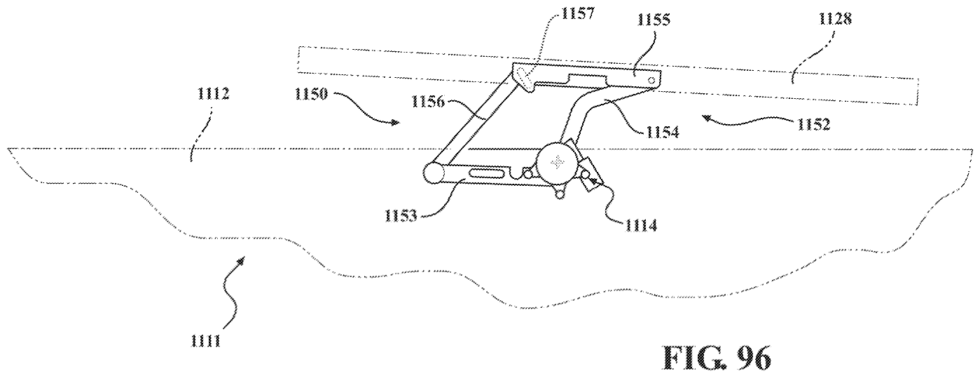

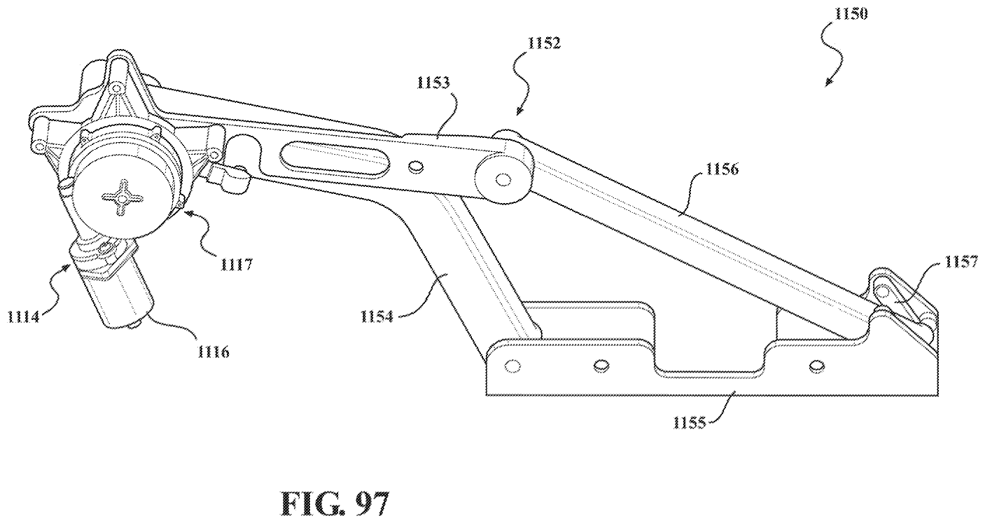

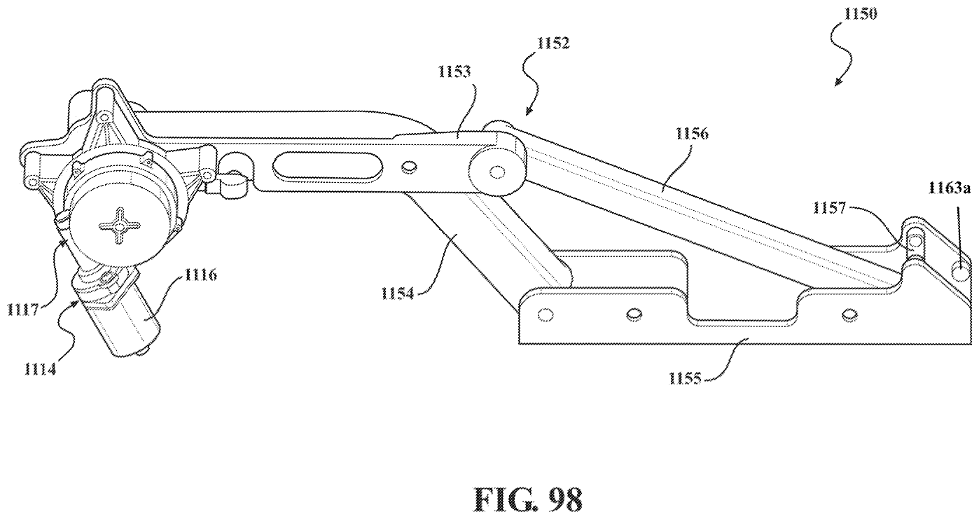

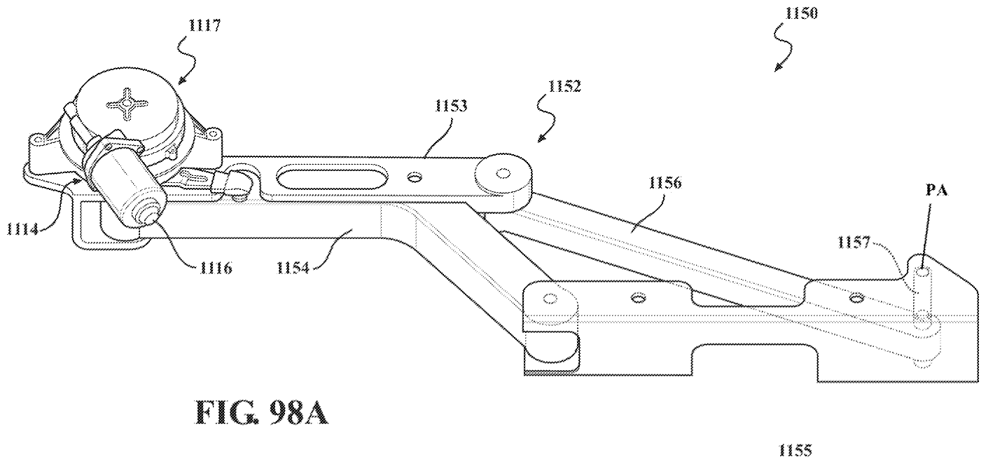

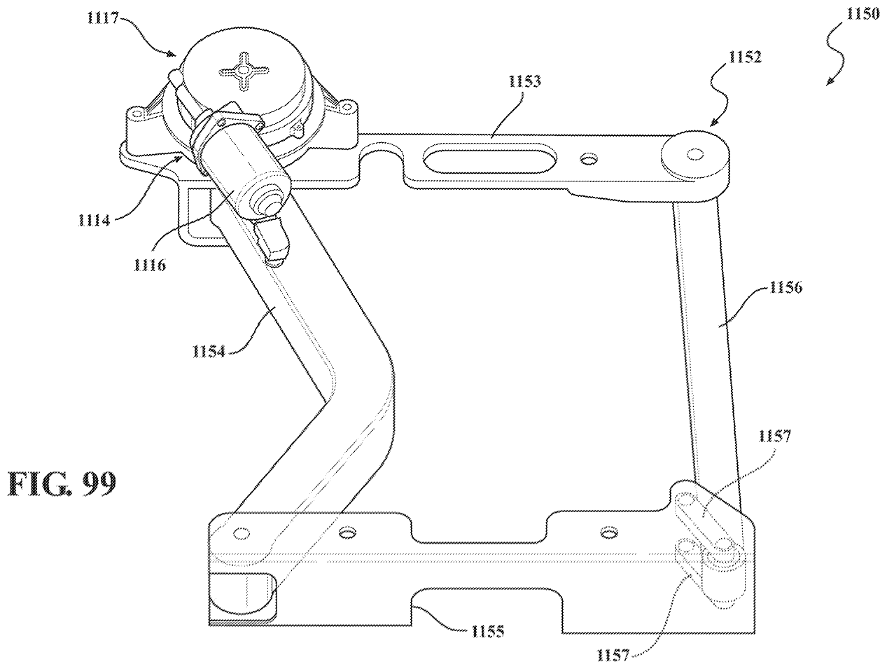

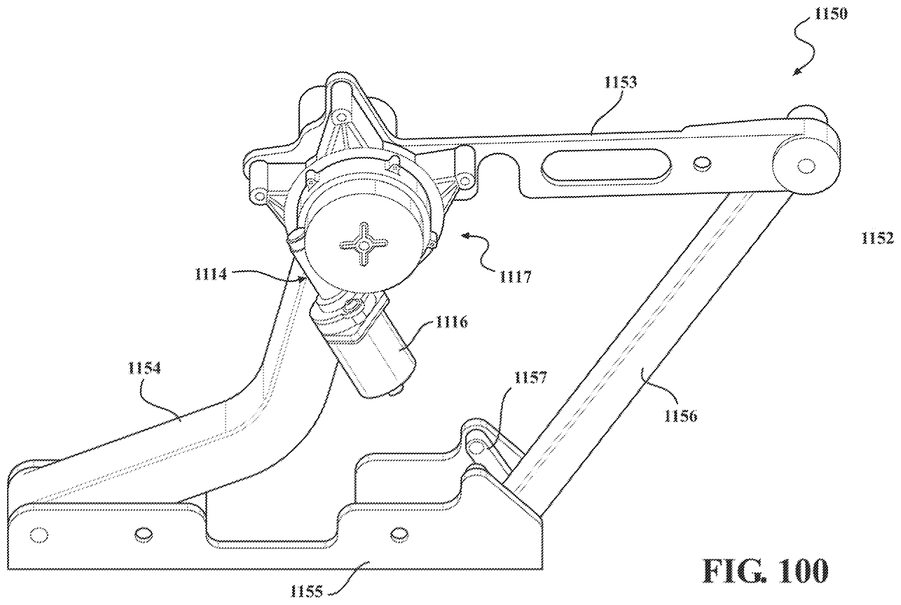

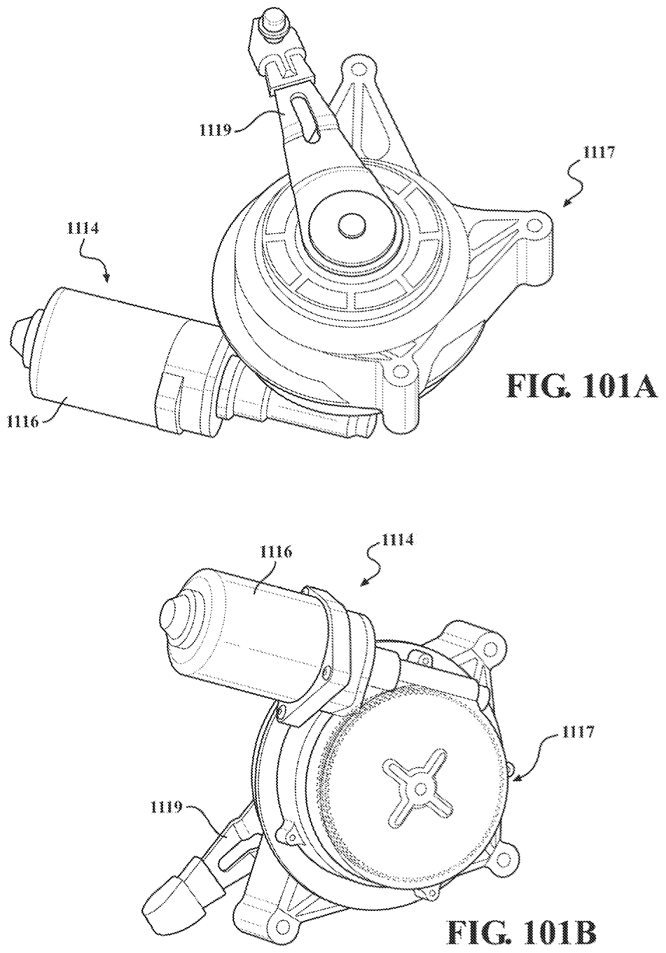

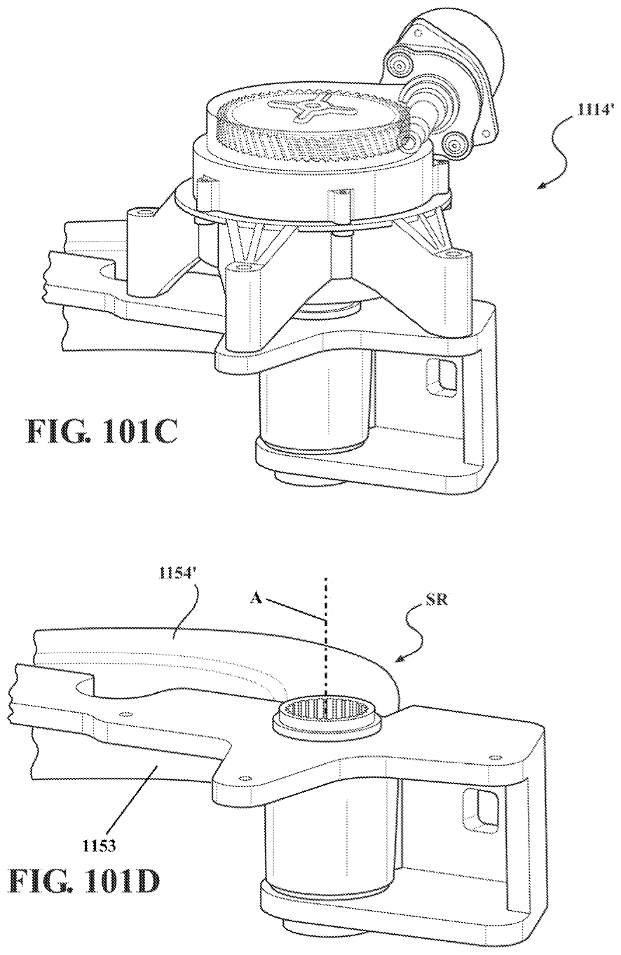

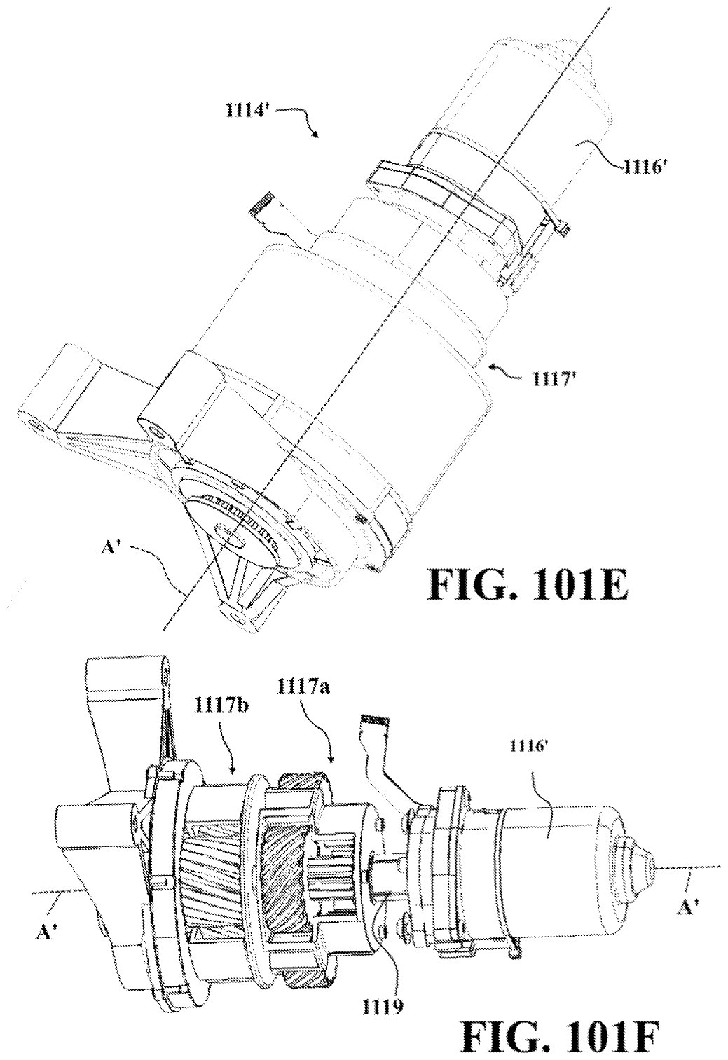

In FIG. 96, a schematic top plan view of a motor vehicle 1111 illustrates movement of a door 1128 of a dual-door B-pillarless closure system of the motor vehicle 1111 having a linkage system 1150 in accordance with another aspect of the disclosure. The linkage system 1150 includes a multi bar linkage, also referred to as linkage assembly 1152, connecting the door 1128 to a vehicle body 1112 of motor vehicle 1111, and an actuator assembly, also referred to as motor assembly 1114. Motor assembly 1114 includes a motor 1116 and a geartrain assembly, also referred to as geartrain 1117. Motor 1116 may be configured as having its motor shaft or longitudinal axis extending parallel with the pivot axis A of first link 1154′ with the vehicle body bracket 1153 as shown in FIG. 101D. Referring to FIGS. 101E and 101F, motor assembly 1114′ may be configured to include a motor 1116′ coupled to a geartrain assembly, also referred to as geartrain 1117′ having two a planetary geartrains 1117a, 1117b coupled to one another, where one of the planetary geartrains replaces the worm 1123 and spur gear 1125 configuration of motor assembly 1114. Motor 1116′ may be configured as having its motor shaft 1119′ or longitudinal axis extending parallel with the pivot axis A′ of first link 1154′ for coupling to a first planetary geartrain 1117a of the geartrain 1117′. Motor assembly 1114′ may therefore be package to extend in a Z-direction alongside or within the A-pillar and C-pillars of an electric type vehicle, as opposed to having to extend into the vehicle body which may be occupied by a batter cell of the electric type vehicle. FIG. 97 illustrates the linkage system 1150 of door 1128 of FIG. 96 while in a closed position; FIGS. 98 and 98A illustrate the linkage system 1150 of door 1128 during an initial stage of opening the door 1128 from the closed position, or during a final stage of closing the door 1128 from an open position; FIG. 99 illustrate the linkage system 1150 of door 1128 during an intermediate stage of opening or closing the door 1128; and FIG. 100 illustrates the linkage system 1150 of door 1128 while in the open position.

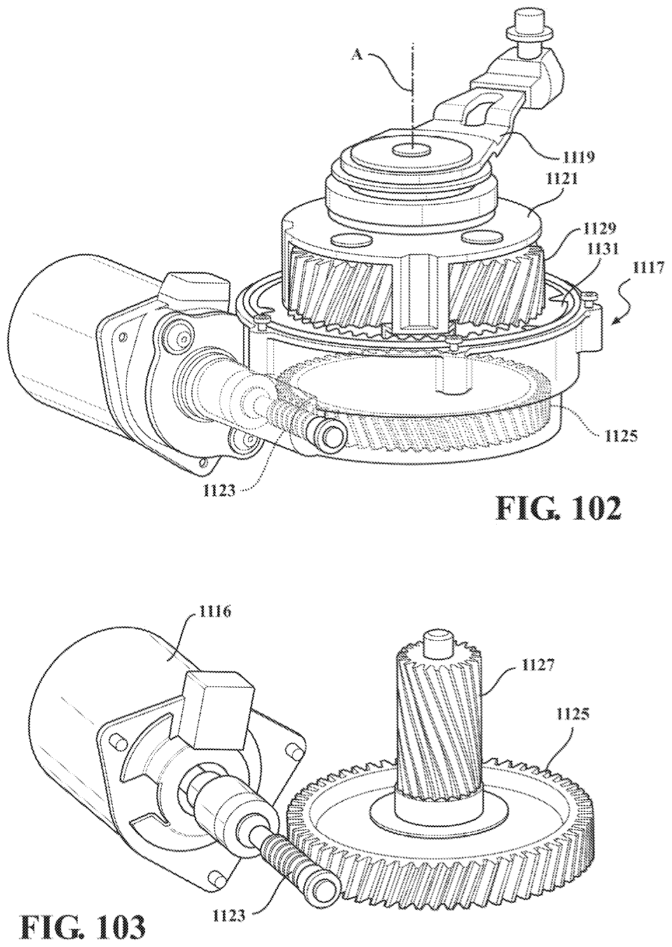

The linkage assembly 1152 includes a first link 1154 and a second link 1156 extending in generally parallel relation with one another. First and second links 1154, 1156 are shown pivotably coupled to a vehicle body link, also referred to as vehicle body bracket 1153, and a door link, also referred to as door bracket 1155. In the non-limiting embodiment illustrated, first link 1154 is shown as a rear link that is larger and stronger than second link 1156, wherein first link 1154 is pivotably coupled to door 1128 generally near, proximate or below a center-of-gravity of the door 1128, thereby supporting the vast majority of the load of door 1128 in comparison to the load supported by second link 1156. Second link 1156 functions primarily to assist with guiding the door 1128, though it does support some weight of door 1128, but significantly less than first link 1154. Actuator assembly 1114 is coupled to first link 1154, wherein a driving force of motor 1116 is transferred to first link 1154 via geartrain 1117 (FIGS. 101A through 102) and in one presently preferred embodiment, to an output member, referred to here as output arm 1119, fixed to a carrier 1121 (FIGS. 102, 104, and 105) of geartrain 1117 and first link 1154 of geartrain 1117. First link 1154 is shown as being non-linear (non-straight) and generally L-shaped, V-shaped or boomerang-shaped, thereby enhancing the torque force applied by output arm 1119 to door 1128. Second link 1156 is shown as being generally straight. Link assembly 1152 is further shown having a tie link, also referred to as supplemental link or secondary link, and shown as a pair of secondary links 1157 arranged on opposite sides of second link 1156 and coupling an end of secondary link 1156 to door bracket 1155. Secondary link 1156 functions to initiate cross-vehicle direction movement of a front portion of door 1128 as door 1128 is initially being opened, and further causes cross-vehicle movement of door 1128 in the final motion of door 1128 as door 1128 is moving to its fully closed position, thereby enhancing the closing force against a seal to effect a reliable seal between door 1128 and vehicle body 1112.

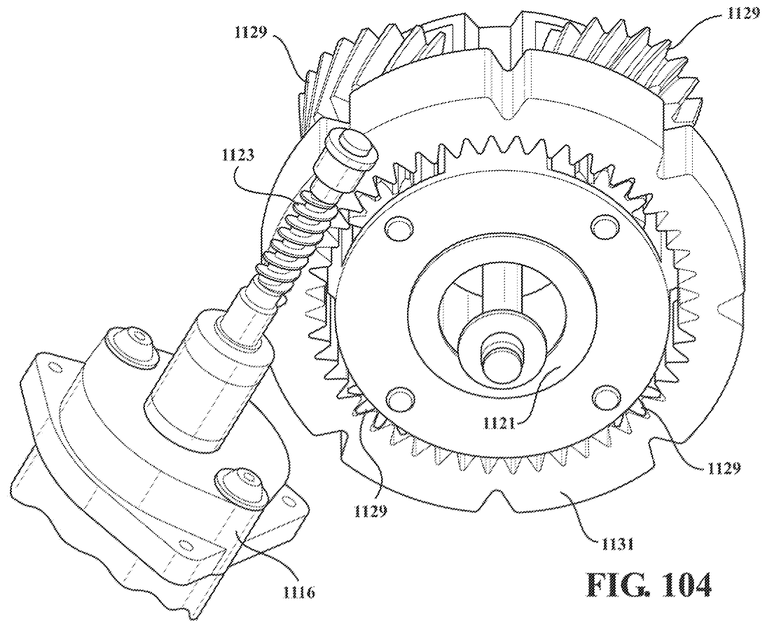

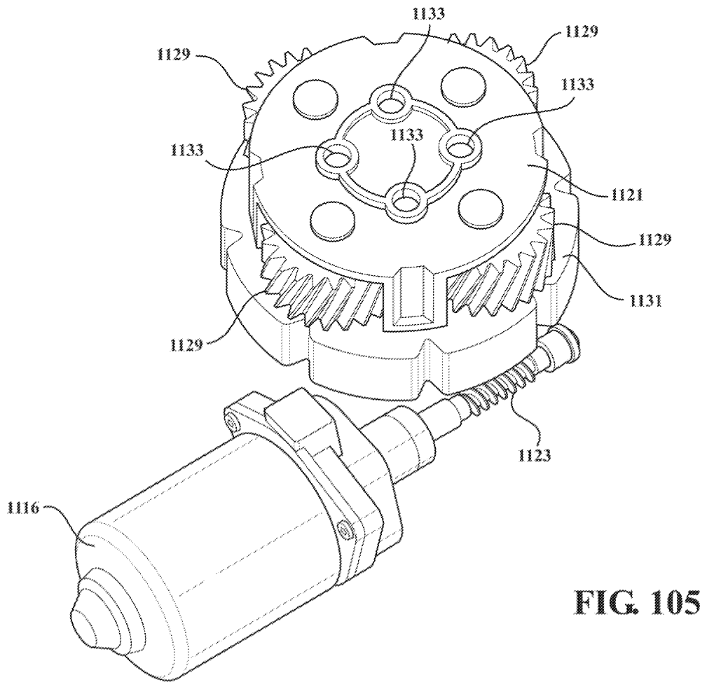

Geartrain assembly 1117 is driven by a motor output gear, shown as a worm gear 1123 (FIGS. 102 through 105), by way of example and without limitation, with worm gear 1123 being in meshed, driving engagement with a drive gear 1125 of the geartrain 1117. A sun gear 1127 is shown fixed to drive gear 1125 for conjoint coaxial rotation with the drive gear 1125 about a central geartrain axis A (FIG. 102). Accordingly, as drive gear 1125 is driven by motor 1116 via worm gear 1123, rotation of drive gear 1125 causes concurrent rotation of sun gear 1127. Sun gear 1127 extends through a bore of carrier 1121 into meshed engagement with a plurality of planetary gears 1129 (FIGS. 104 and 105), with planetary gears 1129 being configured in meshed engagement with an outer ring gear 1131. Accordingly, as sun gear 1127 is rotatably driven about central geartrain axis A, planetary gears 1129 are rotated in meshed engagement with ring gear 1131 for rotation about the fixed ring gear 1131, such that the carrier 1121 is rotatably driven conjointly with planetary gears 1129 about axis A, all in response to rotation of the motor output gear 1123. Carrier 1121, in a non-limiting preferred embodiment of the disclosure, has a plurality of attachment openings 1133 (FIG. 105), to which output arm 1119 is fixedly attached for conjoint rotation with the carrier 1121. Accordingly, as carrier 1121 is rotated via rotation of planetary gears 1129, output arm 1119 oscillates about axis A in response to motor rotating and oscillating worm gear 1123 in opposite rotational directions, with the direction of rotation of worm gear 1123 depending on whether a command is sent to open or close door 1128.

In accordance with another aspect of the disclosure, carrier of motor assembly 1114′ (FIG. 101C), rather than being attached to output arm 1119, has a splined male output member for conjoint rotation about axis A with the carrier. Accordingly, as carrier is rotated via rotation of planetary gears 1129, output member oscillates about axis A as motor rotates worm gear 1123 in opposite directions, depending on whether a command is sent to open or close door 1128. Output member is coupled in meshed relation to a female splined receptacle SR (FIG. 101D) of first link 1154′, thereby driving first link 1154′ conjointly with rotation of carrier 1121′.

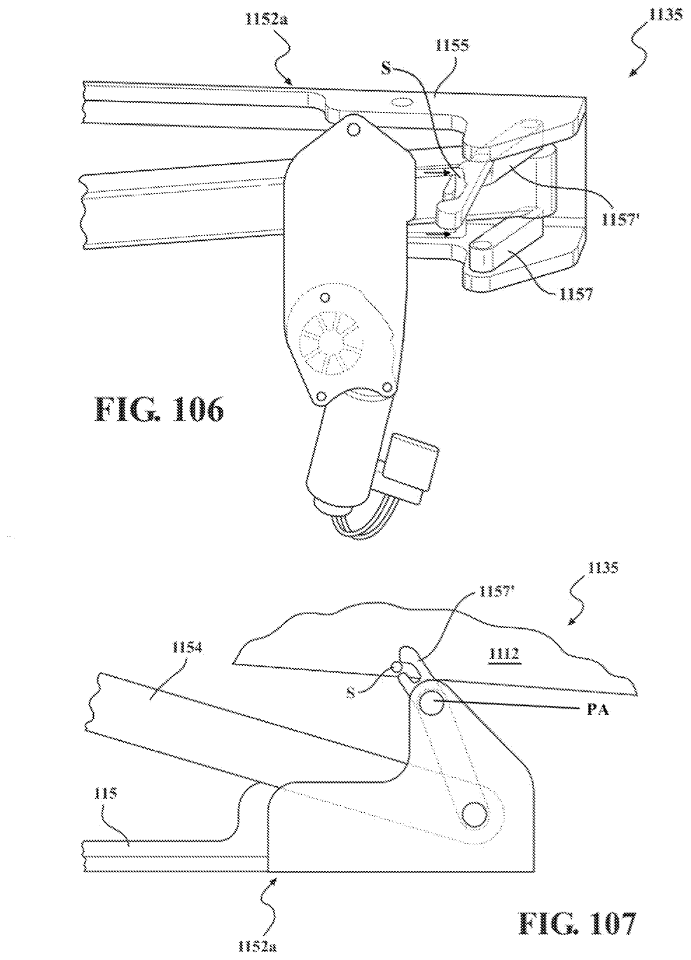

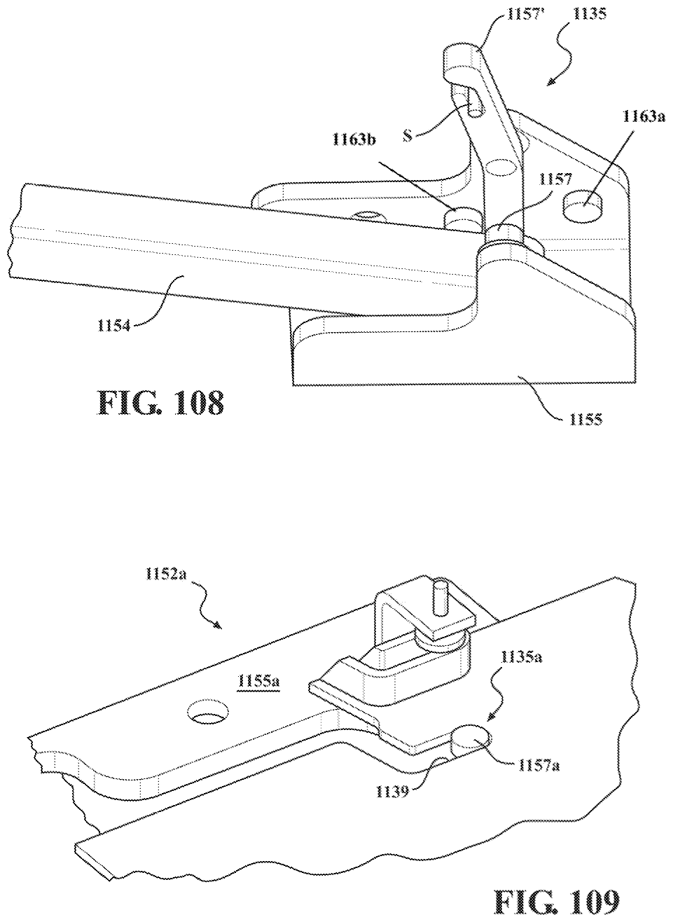

In FIGS. 106 through 108, a cinch mechanism 1135 of a linkage assembly 1152a constructed in accordance with another aspect of the disclosure is shown. Cinch mechanism 1135 includes a cinch lever 1157′ configured for cinching engagement with a striker S fixed the vehicle body 1112 of motor vehicle 1111. As first link 1154 is driven toward its closed position, striker S of cinch mechanism 1135 is received in a cinch slot 1137 of cinch link 1157′, whereupon a torque on cinch link 1157′ acts to drive door link 1155 to a cinched, fully closed position, thereby bringing door 1128 to a reliably sealed engagement position with vehicle body 1112. Cinch link 1157′ is shown replacing one of the secondary links 1157, though two cinch links 1157′ could be used to replace both secondary links 1157, if desired. Door link 1155 may slide against a surface 1161, such as may be part of vehicle body 1112 as one example, or another portion of a bracket assembly. Pivoting of cinch link 1157′ about pivot axis PA may be limited by hard stops 1163a, 1163b projecting from door link 1155. A spring, such as for example spring 1152d may be provided to bias the cinch link 1157′ towards the hard stop 1163a, and thus bias the door away from the fully closed position, and for example to provide a motion of the door initially away from the fully closed position having a substantially X-direction component using the energy of the spring such as 1152d released during decompression, the spring having been previously compressed during the door moving towards the fully closed position. Powered movement of striker S, illustratively shown using arrows in FIG. 106, may act to compress such a spring as the door is urged in the x-direction towards the fully closed position. Spring may be provided to ensure proper positioning of cinch link 1157′ and may as well assist with overcoming initial seal loads when opening the door to compensate for the kinematics and loss of leverage by the linkage when the door is near the door fully closed position, and thus a smaller actuator 114 may be provided.

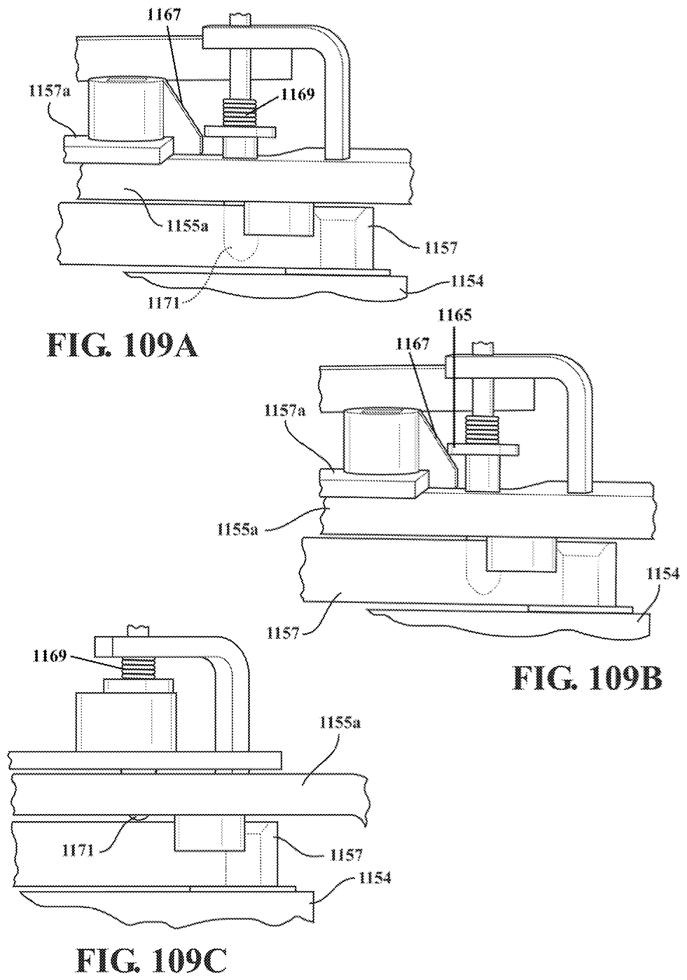

In FIG. 109, another non-limiting embodiment of a cinch mechanism 1135a is shown, where a cinch pin 1157a, also referred to as cinch striker, of door link 1155a of a linkage assembly 1152a is configured for cinching engagement with a cinch slot 1139 in a frame member of vehicle body 1112 of motor vehicle 1111. As door link 1155a is driven toward its closed position, cinch pin 1157a enters and follows cinch slot 1139 to a cinched, fully closed position, thereby bringing door 1128 to a reliably sealed engagement position with vehicle body 1112. With reference to FIG. 109A to 109C, as the door is being closed, initially the door link 1155a and the link 1157 are coupled together for joint movement, where the movement of the bracket 1155a is controlled by the rotation of the link 1154. At a certain point in door closing motion, whereby the motion of the bracket 1155a is desired to shift to having a predominately X-direction motion towards the final door closed position, door link 1155a and the link 1157 are decoupled when a biased plunger 1171 is moved from a coupling position shown in FIG. 109A to a decoupling position shown in FIG. 109C where the plunger 1171 may move out of an aperture provided in the link 1157. Link 1157 therefore may be free to move allowing the continued motion of the bracket 1155a to adopt a predominantly X-direction motion. A retention mechanism 1173 to hold the plunger 1171 in the decoupled position during the final predominantly X-direction motion may consist of a cam surface 1167 for engaging a flange 1165 of the plunger in order to guide the plunger 1171 upwards and out of the aperture provided in the link 1157 against the bias of a spring 1169. In a possible configuration, no spring such as spring 1152d may be provided as discussed with reference to FIG. 106 through 108 hereinabove. Cinch pin 1157a is shown as being guided in a Y-direction by slot 1139 for providing a cinching function, however cinch pin 1157a and slot 1139 could be modified or replaced to provide a locking mechanism to prevent door movement in the Y-direction when the door is fully closed. For example slot 1139 could be provided as a catch having no or less inwards sloping portion compared to cinch slot 1139 while cinch pin 1157 be provided as a retaining pin with an enlarged head to prevent the pin from be extracted through the slot during a crash. Final closing motion or initial opening motion of the door 1128 may drive the retaining pin through the slot in a substantially X-direction as described herein above. During the initial/final substantially X-direction motion of the door 1128 retaining pin as guided by the catch (having an inward sloping slot for example) may provide some optional motion in the Y-direction for compressing a door seal between the door 1128 and the vehicle body for example.

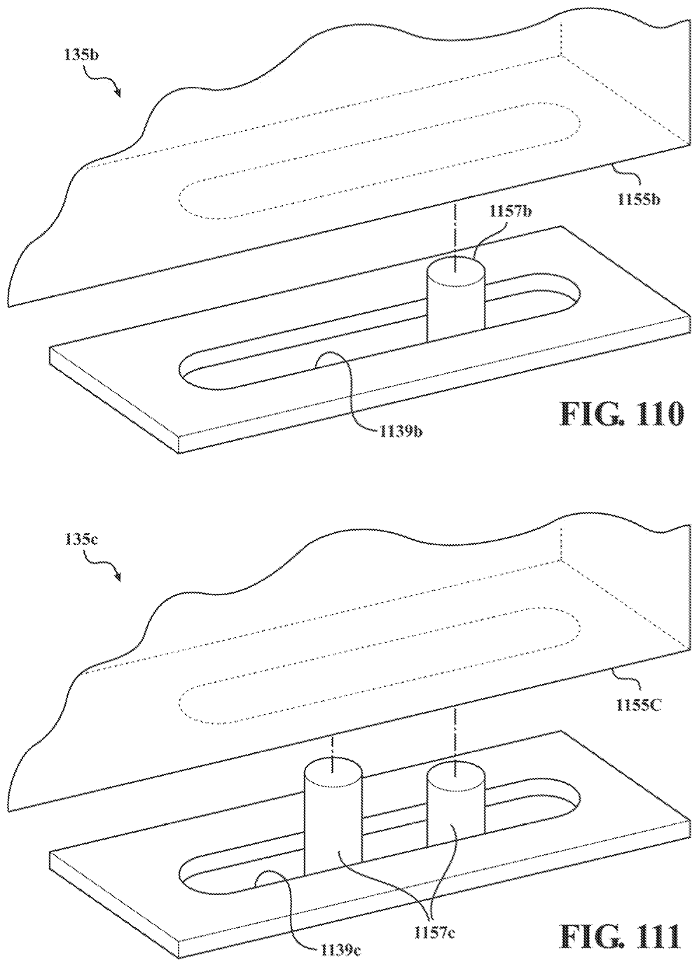

In FIG. 110, another non-limiting embodiment of a cinch mechanism 1135b is shown, wherein rather than a cinch pin, a cinch roller 1157b, also referred to as cinch striker, of door link 1155b is configured for cinching engagement with a cinch slot 1139b in a frame member of vehicle body 1112 of motor vehicle 1111. As door link 1155b is driven toward its closed position, cinch roller 1157b enters and follows and rolls along cinch slot 1139b to a cinched, fully closed position, thereby bringing door 1128 to a reliably sealed engagement position with vehicle body 1112.

In FIG. 111, another non-limiting embodiment of a cinch mechanism 1135c is shown, wherein rather than a cinch pin, a pair of cinch rollers 1157c, also referred to as cinch striker, of door link 1155c are configured for cinching engagement with a cinch slot 1139c in a frame member of vehicle body 1112 of motor vehicle 1111. As door link 1155c is driven toward its closed position, cinch rollers 1157c enter and follow respective surfaces, as desired, along cinch slot 1139c to a cinched, fully closed position, thereby bringing door 1128 to a reliably sealed engagement position with vehicle body 1112.

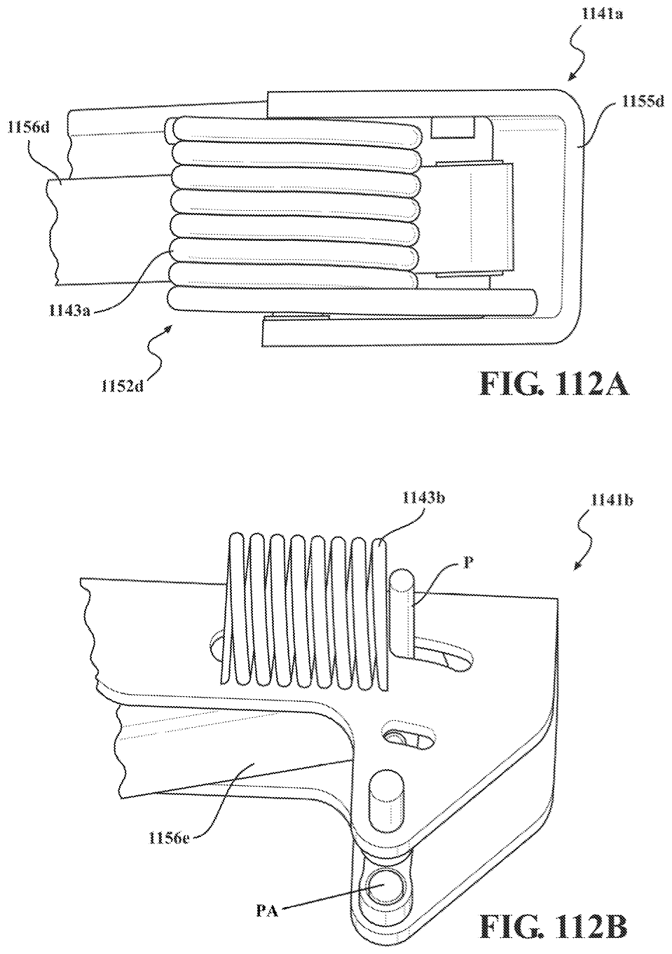

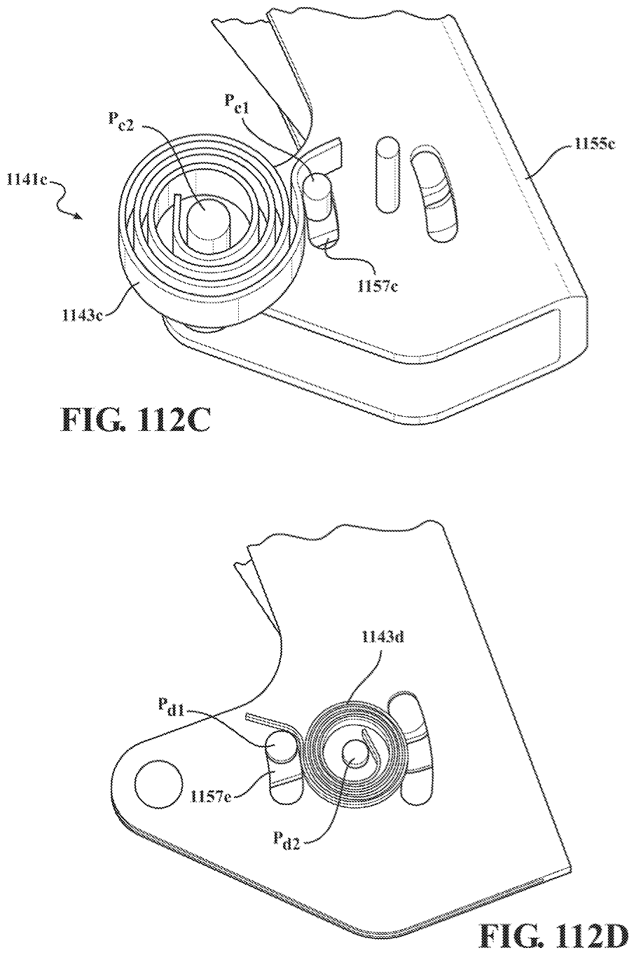

In FIG. 112A, an opening assist mechanism 1141a of a linkage assembly 1152d constructed in accordance with another aspect of the disclosure is shown. Opening assist mechanism 1141a includes a biasing member 1143a, shown as a coil torsion spring (biased in torsion over the coil), configured for biased engagement with a link 1156d of the linkage assembly 1152d to suddenly move the linkage assembly 1152d, and door 1128 fixed thereto, toward an open position from a closed position. In FIG. 12B, an opening assist mechanism 1141b in accordance with another non-limiting embodiment is provided as a coil spring 1143b biased in compression against a pin P extending from second link 1156e, as opposed to torsion shown in FIG. 12A. In FIG. 12C, an opening assist mechanism 1141c in accordance with another non-limiting embodiment is provided as a torsion spring, also referred to as clock spring 1143c, having a first end biased in torsion against a first pin Pc1 extending from secondary link 1157e and a second end engaged with a second pin Pc2 extending from door link 1155c. In FIG. 12D, an opening assist mechanism 1141d in accordance with another non-limiting embodiment is provided as a torsion spring, also referred to as clock spring 1143d, having a first end biased in torsion against a first pin Pd1 extending from secondary link 1157e and a second end engaged with a second pin Pd2 extending from door link 1155c.

Characteristics of the door linkage system embodiments described herein can include for example, and without limitation: simplified structure and improved reliability due to use of pivoting linkages about fixed pivot points of rotation; distribution of door loads to the vehicle body by mounting of multiple linkages to the vehicle body at distributed connection points to the vehicle body structure; improved assembly by mounting to a lower horizontal structure of the vehicle body, such as the horizontal rocker panel area, as compared to known localized mountings to a vertical structure or pillar of the vehicle; stability of the door during door motion due to support provided by multiple linkages supporting the door at a bottom portion of the vehicle door at spaced apart connection points; reduction or elimination of door sag through supporting the door at a bottom portion as compared to known mounting locations on one side of the door one vertical mounting surface of the door; use of a single motor for moving the door through a multi-curved path of motion; reduction in risk of obstacle crashes of the door during door opening/closing through minimizing the distance the door moves and/or swings away from the vehicle body; elimination of complex motor control, or synchronized control of multiple motors due to door motion kinematics being defined by the door linkage assembly; improvement in door motion appearance through maintaining the door in substantially parallel orientation to the vehicle body during door opening and closing; improvement in look and appearance by moving the door closer to the vehicle body in the door fully opened position; improvement in door sealing and use of various types latches and latch functions facilitated through control of the door motion by the linkage assembly about the fully closed position to be substantially X-direction motion; reduction in latch count required to maintain the door in the fully closed position; and improvements in packaging within the vehicle body to reduce or eliminate ingress of components into the vehicle body.

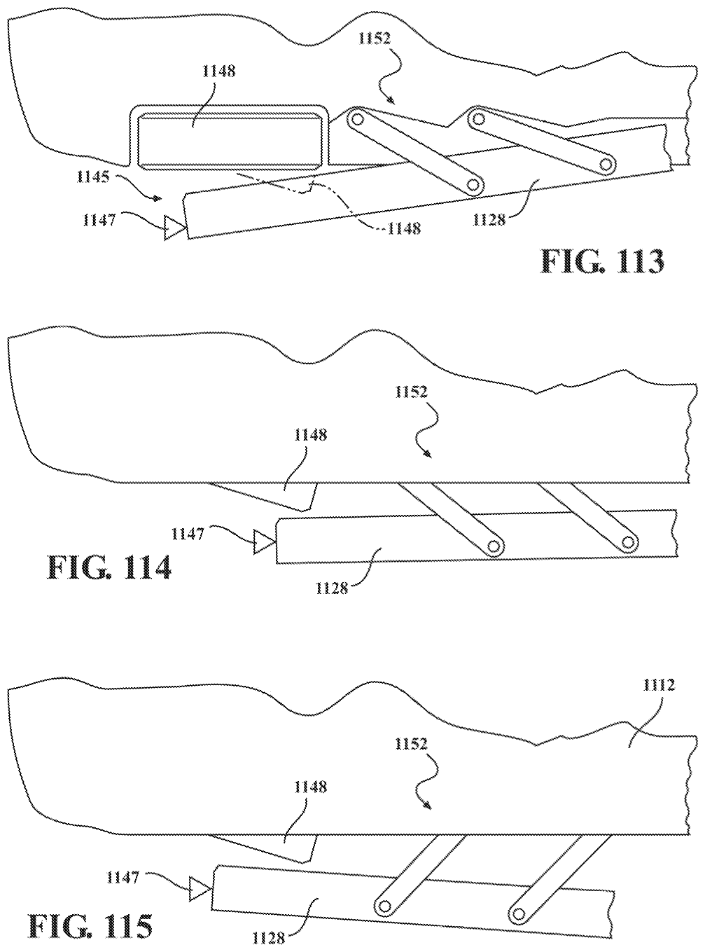

In FIG. 113 through 115, an obstacle detection system 1145 including an obstacle detection sensor 1147 to prevent inadvertent contact of a closure panel, such as door 1128, with an obstacle, shown a motor vehicle wheel 1148 (in solid and phantom), in accordance with another aspect of the disclosure is shown. With the door 1128 in a closed position, obstacle detection sensor 1147 can detect whether wheel 1148 is in an obstruction position that would interfere with opening of door 1128 or not. If obstacle detection sensor 1147 detects the wheel 1148 is not in a position to obstruct movement of door 1128, actuator assembly 1114 is energized to move door 1128 to it fully open position via driven movement of linkage assembly 1152. If obstacle detection sensor 1147 detects wheel 1148 is turned into an obstruction position, actuator assembly 1114 is commanded to move door 1128 to a maximum open position without contacting wheel 1128.

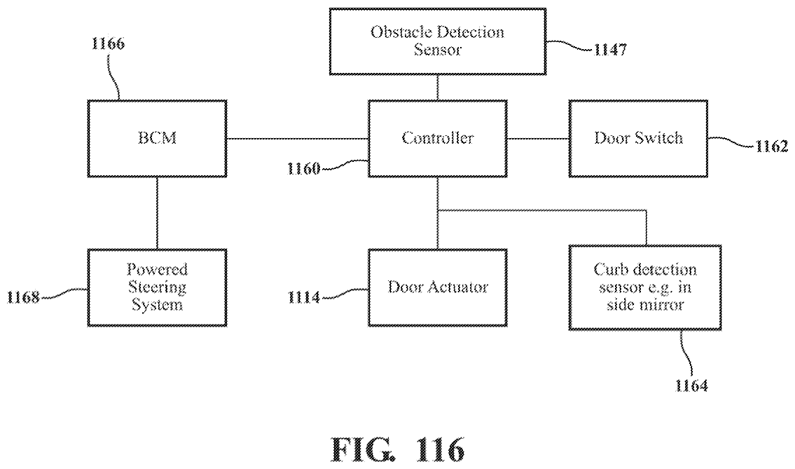

In FIG. 116, obstacle detection system 1145 is diagrammatically illustrated. Obstacle detection system 1145 includes a controller 1160 configured in operable communication with actuator assembly 1114, obstacle detection sensor 1147, a door switch 1162, a curb detection sensor 1164, such as can be located in a side mirror, by way of example and without limitation, and a body control module (BCM) 1166, wherein BCM 1166 is configured in operable communication with wheel 1148 via a power steering system 1168.

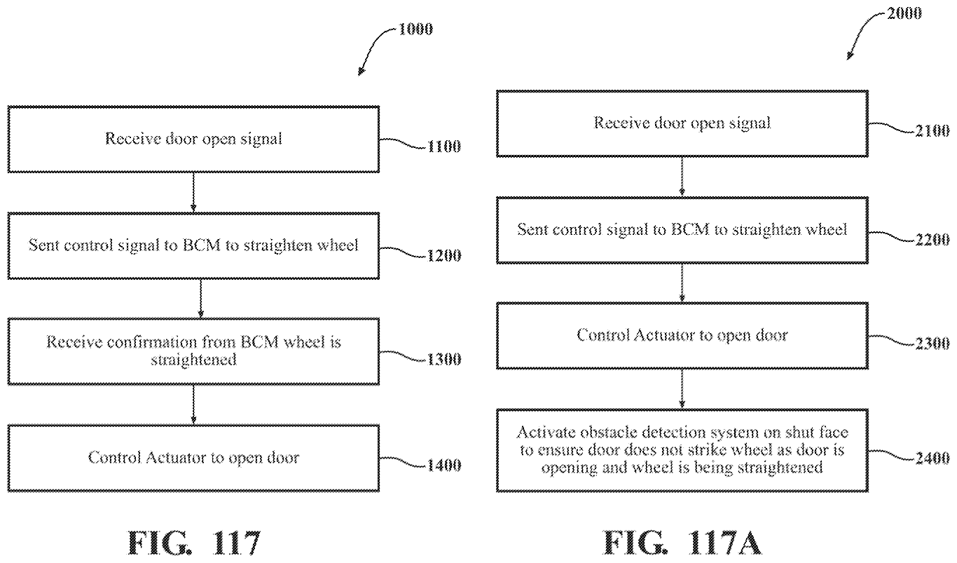

As shown in FIG. 117, in accordance with one method 1000 of operation, in a first step 1100, door switch 1162 can receive a door open signal, such as from a door handle or key fob, by way of example and without limitation. Door switch 1162 then sends a signal to BCM 1166 via controller 1160 at step 1200, whereat BCM 1166 commands power steering system 1168 to straighten wheel 1148 if wheel 1148 is turned. In step 1300, BCM 1166 communicates with controller 1160 to indicate wheel 1148 has been straightened, whereupon controller 1160 signals actuator assembly, also referred to as door actuator 1114, at step 1400 to move linkage assembly 1152 to move door 1148 to its open position.

As shown in FIG. 117A, in accordance with another method 2000 of operation, in a first step 2100, door switch 1162 can receive a door open signal, such as from a door handle or key fob, by way of example and without limitation. Door switch 1162 then sends a signal to BCM 1166 via controller 1160 at step 2200, whereat BCM 1166 commands power steering system 1168 to straighten wheel 1148 if wheel 1148 is turned. In step 2300, controller 1160 signals actuator assembly, also referred to as door actuator 1114, at step 1400 to move linkage assembly 1152 to move door 1148 to its open position. Then, at step 2400, obstacle detection system 1145 is activated, such as on a shut face of door 1128 or on mirror, by way of example and without limitation, whereupon obstacle detection system 1145 signals controller 1160 to ensure door 1128 does not contact wheel 1148, such as while wheel 1148 is being straightened. Accordingly, controller 1160 can control the rate at which actuator assembly 1114 opens door 1128, or it can signal actuator assembly 1114 to stop movement of door 1128 prior to contacting wheel 1148.

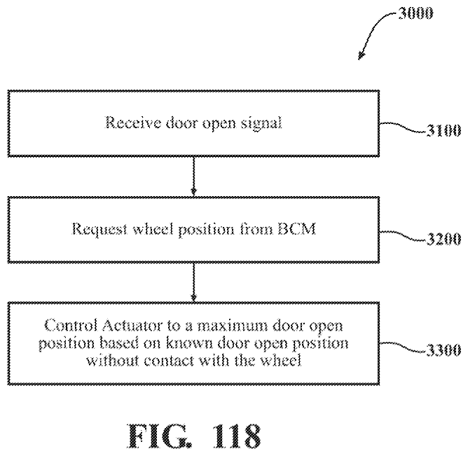

As shown in FIG. 118, in accordance with another method 3000 of operation, in a first step 3100, door switch 1162 can receive a door open signal, such as from a door handle or key fob, by way of example and without limitation. In step 3200, controller 1160 requests a wheel position from BCM 1166, whereupon at step 3300 controller 1160 commands door actuator 1114 to move linkage assembly 1152 to move door 1148 to a maximum open position without contacting wheel 1148.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A door linkage system for guiding a door of a motor vehicle between an open position and a closed position relative to a vehicle body, the door linkage system comprising:
a multi bar linkage connecting the door to the vehicle body, the multi bar linkage being configured to move a forward portion of the door from the closed position initially in a substantially lengthwise direction along the motor vehicle and a rearward portion of the door initially substantially in a cross-vehicle direction away from the vehicle body, and then during an intermediate stage of movement, move the forward portion in the cross-vehicle direction away from the vehicle body and in the lengthwise direction and move the rearward portion substantially in the lengthwise direction toward the open position.

2. The door linkage system of claim 1, wherein a final stage of movement of the door to the fully open position includes moving at least one of the forward portion and the rearward portion in the cross-vehicle direction toward the vehicle body.

3. The door linkage system of claim 1, wherein the multi bar linkage includes a first link and a second link, said first link being larger than said second link and being attached to the door proximate the center of the door.

4. The door linkage system of claim 3, wherein the first link is generally L-shaped.

5. The door linkage system of claim 4, wherein the second link is generally straight.

6. The door linkage system of claim 3, further including a secondary link coupling the second link to the door.

7. The door linkage system of claim 3, further including a cinch lever coupled to the second link, the cinch lever being configured for cinching engagement with a striker.

8. The door linkage system of claim 3, further including an actuator assembly coupled to the first link to drive the first link between a closed position corresponding to the closed position of the door and an open position corresponding to the open position of the door.

9. The door linkage system of claim 1, wherein the multi bar linkage includes a rear link assembly coupled between the rearward portion of the door and the vehicle body and a front link assembly coupled between the forward portion of the door and the vehicle body, wherein the rear link assembly comprises a single link and the front link assembly comprises two links.

10. The door linkage system of claim 9, wherein the two links comprises a link arm coupled to the vehicle body and to a translation lever, the translation lever is coupled to the door about a pivot axis.

11. The door linkage system of claim 10, wherein the translation lever is configured to pivot during the door moving initially in the substantially lengthwise direction.

12. The door linkage system of claim 1, further including an obstacle detection system configured to prevent the door from contacting an obstacle while moving between the closed and open positions.

13. The door linkage system of claim 12, wherein the obstacle detection system is configured to straighten the wheel prior to moving the door between the open and closed positions.

14. A door linkage system for guiding a door of a motor vehicle between an open position and a closed position relative to a vehicle body, the door linkage system comprising:
at least two linkages connecting the door to the vehicle body, the at least two linkages being configured to swing differently from one another while the door is moving during a final closing stage substantially in a longitudinal vehicle direction towards the closed position.

15. The door linkage system of claim 14, wherein the at least two linkages comprises a forward link and a rearward link, wherein the forward linkage and the rearward link are configured to move similarly to each other during an intermediate closing stage prior to the final closing stage.

16. The door linkage system of claim 14, wherein the at least one linkage has a link configured to overlap another link as the door moves between the closed position and the open position.

17. A door linkage system for guiding a door of a motor vehicle between an open position and a closed position relative to a vehicle body, the door linkage system comprising:
a first linkage connecting the front of the door to the vehicle body and for controlling the motion of the front of the door; and
a second linkage connecting the rear of the door to the vehicle body and for controlling the motion of the rear of the door.

18. The door linkage of claim 17, wherein as the door moves between a closed position and an open position, the first linkage controls the motion of the front of the door along a first path and the second linkage controls the motion of the rear of the door along a second path, wherein the first path is different from the second path.

19. The door linkage of claim 18, wherein during a portion of the movement of the door between the closed position and the open position, the first path moves the front of the door generally along a length direction of the vehicle while the second path concurrently moves the rear of the door generally along a cross-vehicle direction of the vehicle.

20. The door linkage of claim 17, wherein the first linkage and the second linkage are configured to pivot at different angles relative to one another as the door moves between a closed position and an open position.
